(19) United States
(12) Patent Application Publication
(10) Pub. No.: US 2004/0229671 A1
(43) Pub. Date: Nov. 18, 2004

(54) Wagering system with automated entry system

(76) Inventors: Andrew Stronach, Aurora (CA); John Jay Richard O'Neal, Welland (CA); Mark A. Litman, Edina, MN (US)

Correspondence Address: Mark A. Litman & Associates, P.A., York Business Center, Suite 205, 3209 West 76th St., Edina, MN, 55435, US

(21) Appl. No.: 10/786,606

(22) Filed: Feb. 25, 2004

Related U.S. Application Data
(63) Continuation-in-part of application No. 09/997,288, filed on Nov. 30, 2001, now Pat. No. 6,722,980.
(63) Continuation-in-part of application No. PCT/CA00/00443, filed on May 1, 2000.
(60) Provisional application No. 60/450,230, filed on Feb. 25, 2003.
(60) Provisional application No. 60/131,806, filed on Apr. 30, 1999.

(51) Int. Cl. G06F 17/00; G06F 19/00

(52) U.S. Cl. 463/6; 463/25

(57) ABSTRACT

A wagering system includes a race providing system facilitating wagering on race events and providing information regarding the race events, and at least one wagering terminal in communication with the race providing system. In an embodiment, a wagering account set-up location (e.g., kiosk) is provided to set-up a wagering account and/or card. Further, the at least one wagering terminal may offer one or more bonus picks in addition to a wager placed by a user of the at least one wagering terminal. Further, a single account wagering card system may be provided to facilitate, among other things, promotion of the at least one wagering terminal. The at least one wagering terminal may also be configured to provide wagering customized to a user risk profile. A system and method may also be provided to display wagering results. A concentrator may also be provided to facilitate services in association with the at least one wagering terminal.

### RELATED APPLICATIONS

This application claims priority of U.S. Provisional Patent Application No. 60/450,230, filed Feb. 25, 2003, which is a continuation-in-part of U.S. application Ser. No. 09/997,288, filed Nov. 30, 2001, now U.S. Pat. No. ______, the entire disclosure of which is hereby incorporated by reference into this application as if set forth fully herein. U.S. application Ser. No. 09/997,288, filed Nov. 30, 2001, is a continuation-in-part of PCT Application No. PCT/CA 00/00443 filed May 1, 2000, which claims the benefit of U.S. Provisional App. No. 60/131,806 filed Apr. 30, 1999.

### BACKGROUND OF THE INVENTION

1. Field of the Invention

The present invention relates to gaming. In particular, the present invention relates to facilitating wagering on race events and the use of apparatus such as terminals or on-line connections to connect to racing information sources and which apparatus use that information for automated wagering and even for automatic wager placing.

2. Background of the Art

Wagering on race events, such as horse races and dog races, typically takes the form of either fixed odds wagering or the more common parimutuel wagering. Fixed odds wagering is a system by which the return for a particular wager is determined in accordance with the payout odds assigned to the associated bet. Fixed odds wagering is popular from the perspective of wager recipients (e.g., betting parlors) since it places a limit on the magnitude of the payout in the event of a win. Fixed odds wagering is also popular from the perspective of wagerers since it provides a measure of certainty on the possible payout.

Parimutuel wagering is a system by which a wagering pool is established for the receipt of bets, and the proceeds of the pool are divided amongst holders of winning wagers in accordance with the number and types of winning wagers and the magnitude of each wager. Parimutuel wagering is popular from the perspective of the wager recipients (e.g., race track owners), since the recipient typically receives a fixed percentage of the pool prior to the payout to the winning wager holders. Also, parimutuel wagering is popular from the perspective of the wagerer since the return on a particular wager is proportional to the size of the wagering pool and, therefore, can exceed the fixed odds return of the bet. However, parimutuel wagering also suffers from a number of disadvantages.

Firstly, parimutuel wagering often requires detailed knowledge of betting terminology (e.g., win, place, show, exacta, triacta, etc. wager types). Secondly, parimutuel wagering often requires the wagerer to be conversant with betting forms, and to have knowledge of race contestant handicapping. For example, for horse racing, successful handicapping requires a consideration of several factors, including track conditions, horse record, and jockey record for each contestant horse. Consequently, parimutuel wagering may not provide wager recipients with a significant return since novices may be intimidated by the knowledge required and either make only minimal wagers or no wagers at all.

Therefore, attempts have been made to improve on the conventional parimutuel wagering systems to encourage wagering. For instance, AmTote International, Inc. markets video terminals which remove the need for a wagerer to interact with a human wager recipient. The video terminal consists of a touch-sensitive CRT display, a card reader, and a central processing unit in communication with the CRT display, the card reader and a remote wagering computer for processing desired wagers. To place a wager, the wagerer purchases a wager card, inserts the wager card into the card reader, and then selects the desired track, the desired horse(s), the wager type (e.g., win, place, show, exacta, triacta, etc.), and the amount of the wager. Although the video terminal allows the novice to conceal to a very limited extent his/her lack of familiarity with betting terminology and handicapping, it does little to encourage the novice to make wagers.

U.S. Pat. Nos. 5,830,068; 6,004,211; 6,089,981; and 6,099,409 describe terminals and systems for placing wagers on racing events, particularly through the internet or other on-line connections. These patents do not appear to disclose any novel hardware or software, but provide a system that provides direct connection to a source of racing data and other racing information, live video of the race on which you a player is wagering, and enables the player to place wagers at many different tracks throughout the world. The system of these patents fundamentally sets up a networked system that allows a player to do essentially everything at a terminal that one could do at a race track betting booth (except possibly look at the horse up close). The system provides ways of accessing horse data (e.g., past race results, handicap weight, etc.), totalisator information, odds, jockey information, weather conditions, etc.). After collecting and reviewing that information, the player then places a wager which is added to the wagering pool. This is a relatively convenient concept that enables only distal wagering. The racing industry requires greater player-friendly access that enables newer players to enter the racing system, without requiring years of study or learning the complex nuances of handicapping and form reading and use.

Therefore, it would be advantageous to provide a wagering system and method which encourages wagering on race events, This can be accomplished by using software that interacts with the totalisator and other racing data feeds and which software that lets the terminal automatically handle complex tasks for the user, including selection of wagers on races for the user (player).

### BRIEF DESCRIPTION OF THE DRAWINGS

Embodiments of the invention will now be described, by way of example only, with reference to the drawings, in which:

FIG. 1 is a schematic view of the wagering network, according to an embodiment of the present invention;

FIG. 2 is a schematic diagram of the race providing system, according to an embodiment of the present invention, shown in FIG. 1;

FIG. 3 is a schematic diagram of the at least one wagering terminal, according to an embodiment of the present invention, shown in FIG. 1;

FIG. 4 is a perspective view of the stand-up type at least one wagering terminal, according to an embodiment of the present invention, shown in FIGS. 1 and 3;

FIG. 5 is a perspective view of the tabletop type at least one wagering terminal, according to another embodiment of the present invention, shown in FIGS. 1 and 3;

FIG. 6 is an example screenshot of the information presented on a display of the stand-up type at least one wagering terminal, according to an embodiment of the present invention, shown in FIGS. 1, 3 and 4;

FIG. 7 is an example screenshot of the information presented on a display of the tabletop type at least one wagering terminal, according to an embodiment of the present invention, shown in FIGS. 1, 3 and 5;

FIG. 8 is a payout table for a “Win” wager type of an at least one wagering terminal, according to an embodiment of the present invention;

FIGS. 9(a), 9(b), 97(c) and 9(d) comprise a flow chart of the wagering facilitated by the wagering system, according to an embodiment of the present invention;

FIG. 10 is another example screenshot of the information presented on a display of the tabletop type at least one wagering terminal, according to an embodiment of the present invention, shown in FIGS. 1, 3 and 5;

FIG. 11 is a schematic diagram of an account wagering clearing service according to an embodiment of the present invention in relation to other aspects of a wagering system, including a VPN concentrator, wagering terminals, other race providing systems, and other account wagering suppliers;

FIG. 12 is an example payout table of a win wager including a single bonus pick according to at least one embodiment of the present invention;

FIG. 13 is an example payout table of a win wager including two bonus picks according to at least one embodiment of the present invention;

FIG. 14 is an example payout table of a win wager including three bonus picks according to at least one embodiment of the present invention;

FIG. 15 is an example payout table of a win wager including four bonus picks according to at least one embodiment of the present invention;

FIG. 16 is an example payout table of an exacta wager including two bonus picks according to at least one embodiment of the present invention;

FIG. 17 is an example payout table of a trifecta wager including two bonus picks according to at least one embodiment of the present invention;

FIG. 18 is an example payout table of a superfecta wager including four bonus picks according to at least one embodiment of the present invention;

FIG. 19 is an example ticket showing a code name according to an embodiment of the present invention;

FIG. 20 is an example results board scrolling and flashing code names of winners and amounts won according to an embodiment of the present invention;

FIG. 21 is a schematic diagram of a wagering account/card set-up kiosk according to an embodiment of the present invention; and

FIG. 22 is a schematic diagram of a VPN concentrator according to an embodiment of the present invention.

FIG. 23 is an example payout table for a multi-wager type machine where by the wager processor selects the Race, Bet type and wager type with a Bonus Game representing 6 levels with variable prizes for each level according to at least one embodiment of the present invention.

FIG. 24 is an example screenshot of the Show Machine embodiment of the present invention where by the Race Selector and Wager Processor determines the Race, and Wager type

FIG. 25 is an example screenshot of at least one embodiment of the present invention where by the player can select the bet type by using the Change Game button.

FIG. 26 is an example screenshot of at least one embodiment of the present invention where by the player can select the Race and Bet Type.

FIG. 27 is an example screenshot of at least one embodiment of the present invention where by the player can select the Race and Bet type similar to FIG. 26 but does not contain extra themed icons and has an expanded Change game feature to go directly to the Bet type instead of scrolling.

FIG. 28 is an example screenshot of at least one embodiment of the current invention where by all betting terminology is removed from the user interface and the Race Selector and Wager Processor are configured to select the Race, Wager, and runners for any given race.

FIG. 29 is an example ticket layout related to FIG. 28 embodiment of the current invention which describes the wager in common English with minimal wagering terminology.

FIG. 30 is an example results layout which relates to FIG. 28 embodiment of the current invention where by the results are displayed in a simplistic manner.

### DETAILED DESCRIPTION OF THE INVENTION

A terminal (which may be a fixed terminal or a personal computer that accesses the system described herein) is used to engage in the practice of the invention. The system contains hardware and software that enables player to enter a race wagering system and place a wager easily and with minimum of required skill, while still providing the excitement of race wagering. The system allows players to either select their choices for races based on the information provided, or more importantly, allow the software to select a wager based on handicapping parameters and/or tote odds or wager odds. There are unique attributes of the system that provide unique capabilities that enhance the player's enjoyment and the game performance. These benefits are discussed below.

The system provides a function wherein the gaming system selects races at least on the basis of time availability of the race. Because the limitations at a track for wagering are primarily limited by the times between races, and because wandering across the list of tracks and races is time consuming, the number of potential wagers that can be placed from a distal source such as is envisioned and enabled in the practice of the present invention is potentially reduced by significant amounts. This reduces the number of wagers and thereby reduces the take by the tracks and intermediates. By providing automatic race selection of the reasonably soonest to be run or soon to be run races, and by enabling automated wagering (with automatic wagering including a) at a track, b) in a particular race, and optionally automatically c) in a particular pool, d) at a particular wager amount, and e) what runners to select), the speed of placing a wager is dramatically increased, the number of wagers/hour are multiplied, and the take by the track and/or intermediaries is significantly increased.

Specific machines for specific entry into the wagering system from a personal computer (PC) or off-track betting (OTB) system enabled to practice in the system of the invention may be designed or established to even further reduce time or player input/consideration required. That is, individual systems/machines may be enabled for specific pools, such as for only win pools, place pools, show pools, exactas, perfectas, trifectas, etc. as a preferred method, as explained in greater detail herein is the use of automatic selection of the wager, with as much of the wager components and wagering activity being automatically selected. By the wager components are included at least components selected from the group of track, race, pool (e.g., win, place, show, exacta, trifecta, superfecta, combination wagers, daily doubles, etc.), wager mount, runner(s), and the like. The wagering system may also enable the partial selection of a wager (e.g., track race and pool) and enable the system software to automatically complete the wager. Any number of the many wager elements may be selected (least preferably even 0 of the total wager components), and the system will automatically complete the wager, either by truly random selection or pseudo random selection, or by enabling actual handicapping software to select the remaining elements of the wager, or by partial random selection and partial handicapping selection. This could be effected, for example, by the player selecting the track and race from among choices provided by the wagering data source in the race wagering system, the software/hardware system randomly selecting the wager amount (within guidelines and limits for example) and pool, and then the system software handicapping the runner selection. The handicapping may also be influenced by information, software, algorithm or events beyond normal handicapping data, such as pool leveling, selection wagering style (conservative wagering, long-shot wagering, variable wagering, etc.). The handicapping may also be influenced by user input such as player desired tendencies, player instructions, player history, player entered profile, etc. For example, the player may limit wagers by limiting the range of wagers that may be placed on his/her behalf by instructions that wagers may be placed on individual racers with odds only inside the range of 1:1>odds>15:1, or any other player identified range of minimum odds and maximum odds on an individual racer. Combination wagers (e.g., exactas) may be similarly limited by player defined limiting ranges of odds on the total wager, the odds on the first (winning racer), the odds on the second racer (Place horse), or the odds on any individual racers in the combination wager. This player profile may be used in the software program to weight, influence or modify the automated selection process.

Because the is a complete system, additional style and function features may be added into the system. Some unique performance characteristics that have already been designed include, for example:

a) automatic arrangement and optionally display of odds and picks (e.g., a vertical or horizontal list from highest odds to lowest odds or lowest odds to highest odds {favorites to long shots]),

b) color-coding the odds, especially when arranged and displayed, so that players can see the odds in a color scheme both on the odds board and/or on images of the runners used to assist in or enable runner election. For example, the odds board may show the odds on rows that are, in order, red, white, blue, orange, pink, purple, green, etc. The odds would, by way of non-limiting example, be on the display red 5-7, white 2-1, blue 4-1, orange 6-1, pink 7-1, purple 9-1, green 12-1. Whatever the odds on a particular race, the same order of color would be used to display the order of the odds. As the odds shift during wagering, the colors on the odds of a particular runner may shift, but the order of the odds on the racers remain the same, from highest to lowest or lowest to highest. This enables players to select runners (e.g., horses, dogs, etc.) by their colors based on a player' inclination to select horses according to their odds or even by color preferences.

c) similarly to b), payouts can be simultaneously or later displayed in the reverse order of color scheme as the odds, as the potential payouts are relatively inverse in order to the odds, so the color scale will be reversed from the odds scale. This allows the players to maintain a semblance of cognizance about wagers.

d) the runner being wagered on may be shown in a series of rows and columns with representative images (not actual pictures or images of the horses, but symbolic representations of the racers, although the actual names of the runners may be present with the symbolic images to simplify user reading of the displayed material) of the runners, with the odds or payout colors shown associated with the images of the runners (e.g., the ‘color’ on the runner image re the colors of the odds arrangement, not the actual colors of the runner on the track). The original display of the images my be by runner number or randomly on the display, or alphabetically (by runner name or jockey name or stable name) or by any arrangement that is designed into the system. When the wagers are placed by the player or automatically selected or automatically completed by the software, the columns and rows spin (giving the appearance of reels on a reel-type video slot machine), the spinning stopping, and the selection(s) are positioned on a predefined position on the final display of the reels. For example, the winner wagered upon may be shown in column 1, row 1, or column 1, row 2 as a predetermined selection. If a trifecta were wagered upon, the three runners in the selection may be displayed as column 1, rows 1, 2 and 3; columns 1, 2 and 3 row 1; columns 2, 3 and 4 in row 1 or row 2, etc. The final display of the runners wagered upon may also and preferably highlight the runners wagered on, as by screen highlights, overlay of numbers on the runners (e.g., an image saying 1^{st}, 2^{nd} and 3^{rd} overlaying each of the runners wagered on in a trifecta, and any other visual indication of the actual runners that a wager has been placed. When an automatic select function has been made or elected, the ‘reels’ may spin until the decision is displayed. Also, the wheels or reels spin while the system is having its wager entered into a parimutuel pool to provide marginal entertainment time or indication or machine operation. Similarly, the winning runners or horses may be displayed on the same or separate ‘reels’ for comparison with the wager display or to follow the wager display.

e) It is important to be able to provide a workable system in the practice of the invention. To have a workable system, at least some of software, hardware, algorithms, displays, etc. must be provided to enable handicapping. The preferred system uses handicapping techniques that incorporate tote odds, pool odds, HCW, odds dropping, standard handicapping functions and parameters, singly or in combination. Alternative or additional; features, such as the player profiling indicated above, may also be used in the handicapping techniques. The preferred method combines tote odds and HCW information.

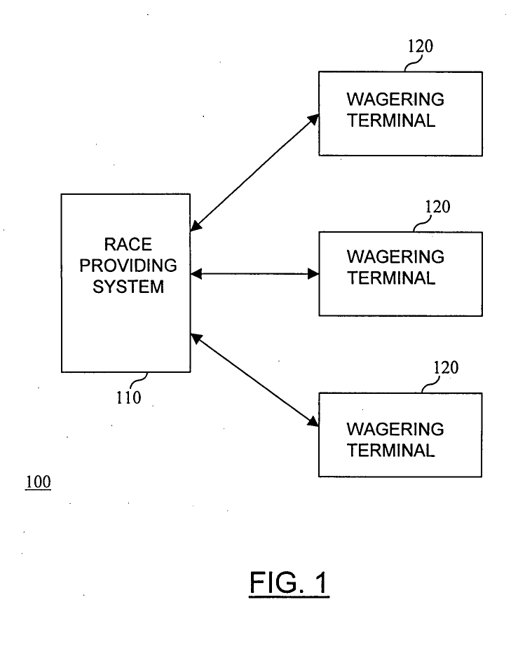

In an embodiment of the invention, referring to FIG. 1, a wagering network, denoted generally as 100, is shown comprising at least one wagering terminal 120 and a race providing system 110 in communication with the at least one wagering terminal. In an embodiment, the communications connection or network between the race providing system and the at least one wagering terminal comprises a closed connection or network. However, the communications connection or network may instead comprise an open connection or network, such as the Internet, if the open connection or network has sufficient bandwidth for adequately servicing the at least one wagering terminal. Additionally, security safeguards such as signatures, user identification requirements, encryption of signals and trails, hash values, pin numbers, passwords, and the like are desirable security attributes of various embodiments of the invention. Moreover, such a connection or network may be of any form including without limitation wire, cable or wireless or any further developed system. Each of these formats is merely a communication system for transmission of signals used in the practice of the invention.

A wagering account set-up facility, such as a booth, stand, kiosk, counter, tent, building or the like may be used [kiosk] to register and/or communicate with a wagering account holder. Non-limiting examples of the content of the facility include, but are not limited to:

a display identifying capability to accept one or more information requests to establish a wagering account (for example, a box with a question, an icon, voice stream, any image which conveys this information to a user);

an optical recognition character reader to read (including scanning and parsing) a wagering account application form;

a user interface and preferably a digitizing system to capture a signature of a holder of the wagering account and to capture input from the user in response to the one or more information requests on the display; and

a processor to process the wagering account holder's signature, the input and, where an application form has been submitted to the optical character recognition reader, information from the wagering account form and to set-up the wagering account. The account set-up facility is preferably a kiosk having a wagering card dispenser to issue a wagering card on the set-up wagering account.

A card reader may be provided to read a card that enables at least one interaction with the processor selected from the group consisting of identifying the wagering account holder and reading a card that can deposit value into the wagering account. The card reader may also or alternatively read a card that can deposit value into the wagering account. The system should provide a connection to a credit database to validate set-up of the wagering account. The processor should have hardware or software available that can instruct a wagering account set-up confirmation to be sent to the wagering account holder.

The invention also includes a wagering terminal in communication connection with a race providing system that facilitates wagering on race events and provides information regarding the race events. The wagering terminal may comprise, by way of non-limiting examples, a display to present information regarding selected race events; a user interface enabling a user to place a wager on an elected race event of selected race events displayed; a card reader to receive a card having information pertaining to a user account and to enable identification of available wager amounts for at least one or more wagers on the elected race event; at least one currency receiver or credit receiver to receive currency or credit, respectively, wherein currency or credit provided to the currency receiver or credit receiver may be deposited to the user account. There may also be a currency dispensing device to dispense currency and wherein currency dispensed is withdrawn from the user account. The wagering terminal may be in communication access to a race event selector to select race events, wherein the selected race events are next race events for wagering.

An alternative aspect of the present invention includes a wagering terminal in communication with a race providing system that facilitates wagering on race events and provides information regarding the race events. The terminal includes a race event selector to select next race events for wagering, the race event selector using an algorithm to select next race events by analyzing one or more factors from the group comprising estimated start of race event; estimated duration of race event; nature of the race event; actual start of the race event as affected by delays; spacing among other race events; and other attributes affecting the playability of particular races; a display to present information regarding the selected race events; a user interface by which a user may place a wager on an elected race event of the selected race events displayed; and a wagering value mechanism, such as a wagering value selector to provide a wager amount for the wager on the elected race event. The attributes of the wagering value selector are described in further detail herein, but may include random selection, handicapped selection, pool flattening selection (that is selection that attempts to minimize differences among the amounts of wagers and odds among each and all of the total possible selections), and combinations of these. The factors used in the selection of a particular race are weighted and can be adjusted automatically to configure selection of the next race event. The selector may be configured to enable either player selection of wagering amounts or automatic selection of wager amounts.

Another alternative aspect of the invention includes a wagering terminal in communication with a race providing system that facilitates wagering on race events and provides information regarding the race events. The terminal may comprise a display to present information regarding selected race events, the information including race contestant wagering information displayed according to a profile of a user of the wagering terminal; a user interface enabling placement of a wager on an elected race event of the selected race events displayed; and a wagering value selector to provide a wager amount for the wager on the elected race event. The profile may be a risk/reward profile and optionally the user can select the profile using a button/icon or other manual control on the wagering terminal through which a user may select a profile. Race contestant wagering information may be generated from matching handicapping data showing estimated probability of race contestants finishing in specific positions against current odds to find wagering opportunities. This is preferably accomplished according to at least one algorithm using the handicapping data and the current odds.

The user interface may display icons corresponding to race contestants in a race event and a color or other indicator of the icons represents the race contestant wagering information. This aspect has been further described according to other elements of the invention and will not be repeated here, except to note that colors may be uniform or in a uniform for all races or the colors may be rearranged for each race. The race contestant wagering information for a particular wager may comprise at least one of a specific wager, a race contestant selection and a wager amount selected in accordance with the user profile.

Another useful aspect of a wagering terminal in communication with one or more race providing systems that facilitates wagering on race events and provides information regarding the race events may comprise a display to present information regarding selected race events; a user interface to place a wager on an elected race event of the selected race events displayed; a wagering value mechanism to provide a wager amount for the wager on the elected race event; and a module, preferably a portable module providing a library of at least two protocols for accessing different API's for different tote-providers to support interoperability of the wagering terminal with more than one race providing systems. As is known in the art, each totalisator has at least one API (Application Program Interface) that is necessary to be communicated with or be bridged in order to interact with the programs and hardware of a host computer. Each totalisator system has its own API, and different functions within each totalisator (which may be a race information provider in the practice of this invention) may have separate API windows to traverse for communication. A module may be provided with the system of the invention that is embedded in a terminal or which may be connected (on line or physically) with a terminal or directly to the totalisator from a computer with terminal system functions according to the present invention which has the capability of communicating with different API's from different totalisators and different API windows within a single totalisator system to enable use of the practice of the invention. The system module may interrogate the distal API to determine which protocol or key to the API is needed for communication, or the user may select a specific protocol or key when the user is aware of the specific API to which communication is to be directed.

The module may define an application programming interface for the wagering that is facilitated by the wagering terminal and an application programming interface for the networking services of the race providing systems. The optionally portable module may be adapted to accept one or more plug-in modules, each defining the interoperability to a specific race providing system.

Another format of wagering terminal or another feature that can be incorporated into a wagering terminal in communication with a race providing system that facilitates wagering on race events and provides information regarding the race events may comprise a display to present information regarding selected race events; a processor in communication with the wagering terminal; a user interface to place a wager on an elected race event of the selected race events displayed; and a wagering value mechanism to provide a wager amount for the wager on the elected race event, wherein software executed by the processor requires a key phrase to be provided in association with the wager to limit access to wagering or credit accounts so as to protect the identity of a user that made the wager when winning wagers are disclosed. When the wager is a winning wager, a results board displays the key phrase associated with the wager or a results board displays a winning amount associated with the wager. Another alternative or additional feature would be where, if the wager was a winning wager, a bell or audio signal is activated at the end of a selected race event depending on at least one of a number of winning wagers played on the wagering terminal and an amount of money won on the wagering terminal.

A user interface for a wagering terminal for practice of certain aspects of the invention may comprise a spinning reel animation; selection system for selecting at least one race contestant in a race event; communicative connection to a race information provider that carries information of the at least one race contestant selected to the race information provider to enter a wager on the at least one selected contestant on a wager in the race event; and when the spinning reel animation is completed, a screen presenting the at least one race contestant in the race event selected for a wager. One or more race contestants may comprise one or more quick pick race contestants, as explained in greater detail elsewhere in the specification. For example, one or more race contestants may comprise one or more quick pick race contestants in which quick pick selection is based on handicap data, odds, pool leveling considerations, or literal even wager distribution. Pool leveling is a process that is used or occurs where wagering is heavily weighted towards a few or even one horse, and the odds on other horses are unreasonable. An automated program will distribute additional wagers on other horses (e.g., specially when including handicapping considerations of only the contestants with higher odds, thereby eliminating the wagering/odds/totalisator influence of an over-wagered contestant. This process may be automatically initiated when the distribution of odds in a pool or pools exceeds predefined conditions or ranges. For example, a look-up table or algorithm may be predefined where limits are established on the relative range of pool wagers, the range of odds, etc. It must be recalled that the automatic selection of wagers need not, and usually is not based solely upon selecting a winner in a race, but is aimed at creating a reasonable return on wagers and this may be performed by wagering on middle-odds and long-shot contestants.

Another aspect of the invention may be described as a wagering terminal in communication with a race providing system that facilitates wagering on race events and provides information regarding the race events, the terminal comprising a display to present information regarding selected race events; a user interface to place a wager on an elected race event of the selected race events displayed; a wagering value mechanism to provide a wager amount for the wager on the elected race event; and a wagering processor to provide one or more bonus picks in association with the wager. The wagering processor may provide bonus picks when a wager results in a predetermined event. For example, bonus payouts may be provided when any wager returns at least a 30:1, 40:1, or 50:1 payout. Any particular level (absolute amount, so as to stimulate higher dollar amount wagers) of return or rate of return on a wager may be used as the predetermined event. A preferred event is when the predetermined event comprises a payout equal to or in excess of a predetermined amount or predetermined rate.

The bonus pick is preferably an automatic selection of a race contestant from remaining race contestants in a race event not included in the wager or other bonus picks. Bonus picks may also initiate a progression (not progressive jackpot) of bonus events, wherein when a first bonus is won, a second bonus is then automatically entered (without risking previously won amounts). For example, each successive bonus presents higher odds for winning. The first bonus pick wager, for example might be a long-shot show wager, a second bonus may be a long-shot place wager, a third bonus may be a long-shot win wager, a fourth bonus may be an exacta or double, a fifth bonus may be a long-shot trifecta, etc., with the most difficult wager being the most difficult wager available from the races available in the order of play. Each bonus wager in the progression of events may be selected from successive events (e.g., different races), or to speed up the process, when the bonus round is entered, the selector system for the bonus will independently select all of the selections from a single race prior to the running of the race, and as each bonus is won, the next bonus is examined to see if the player has won. Preferably the selection of the race contestant for the bonus pick is random, although the randomness may be weighted, as by requiring all wagers to have in excess of certain odds for each wager type. For example, all show wagers to be selected must exceed 3:1, all place wagers must exceed 5:1, all win wagers must exceed 8:1, etc. Each wager in the progression must exceed the odds of the previous selection up to the final bonus selection. There may be a potential succession of at least 4 bonus events, at least 5 bonus events, at least 6 bonus events, at least 7 bonus events, and the like.

The wagering terminal may provide a pool out of which the bonus prize(s) for a winning bonus pick(s) is paid out may be funded by a one or more of: a set aside of a percentage of wagering handle; an additional contribution by one or more race event tracks and a wager surcharge. The pool for the bonus event may be underwritten by an insurance policy to ensure that a bonus prize can be paid. A payout of a bonus prize for a winning bonus pick may be determined by one or more of: a size of the entire bonus pool; straight odds of winning the bonus pick; an effective payout or odds of winning the wager; an actuarial determination of the bonus prize; and a parimutuel determination with a jackpot and reserve similar to a lottery system. Where ticket printing is used on the terminal, a separate ticket may be issued from a ticket for the wager, the separate ticket incorporating details of the wager and providing the one or more bonus picks. The separate ticket may be provided with a bar code to track and facilitate payout of a bonus prize for a winning bonus pick. One or more bonus picks may be provided on a same ticket of the wager in association with which the one or more bonus picks are provided. The Bonus Game in one embodiment may be configured to issue a bonus ticket if the player wins on a long shot wager i.e., 50:1. The player would then be issued a free ticket for the next available race and would then qualify for the next bonus level. If the player wins on that ticket, he/she moves up to the next bonus level (level 3) and will receive another ticket for an upcoming race. This process will continue as long as the player continues winning in the bonus event until the player reaches a maximum level, e.g., level 4, 5, 6 or 7 (or more or less), at which point the player qualifies to win a grand prize such as a car, vacation or cash. The above process can be described as a bonus game which adds an extra entertaining element to the game similar to Slot Machine bonus Games. Adding bonus features keeps the games fresh and exciting for the players. Casino industry publications such as IGWB (International Gaming and Wagering Business) have recently published articles on the movement by major Slot machines manufacturers to add Bonus Games to their traditional slot games. The goal is to award players for playing a particular game. The August 2002 edition of IGWB in “The Bonus Game” article contains testimony from industry experts on the effectiveness of bonus games and new ways to reward players. The horse racing industry is severely lacking in new ways to retain and reward players. The horse racing industry publication The Blood Horse Dec. 22, 2001 article “Improving the Experience of Racing” speaks to the issue of the horse racing industries inability to add new exciting elements for the players.

The wagering terminal may have both speakers and video monitors to display events and provide signals. A time for display of the audio or video of a next race event may be determined by estimating a run time of the next race event and adding extra time for delayed starts and slow race events.

The race providing system generally manages and processes various racing information, particularly wagering information associated with race events held at various race event tracks. An example race providing system is Amtote International, Inc.'s totalisator system which processes racing information from or related to not only race events at which Amtote provides wagering transaction services but also race events unassociated with Amtote but for which racing information is provided through the Amtote totalisator system (e.g., racing information from or related to simulcast race events, known as open events). The racing information that may be provided in accordance with the invention may include race event information, such as the names and start positions of the race contestants (e.g., horses, dogs) running (or competitors involved, Jai Lai, athletic events such as football, basketball, baseball, soccer, and the like) in each race event for which the race providing system has information, the distance of each such race event, the race event track name of each such race event, the start time of each such race event, etc. The racing information may also include odds information for each race contestant, betting pool information on the betting pool associated with each race event, handicapping information, such as the weather conditions, and the jockey name, race contestant age, win record, and number of days since the last race event for each race contestant, and/or race result information such as the race results at the end of each race event. The racing information may be any combination of the race event information, odds information, betting pool information, handicapping information, race result information and/or other information as needed for the effective operation of the at least one wagering terminal. Optionally, the racing information may also include audio and video data corresponding to some or all of the race events for which the race providing system has information. It is to be noted that even though this information may be available to the user by requested access to this information, the automatic selection system enabled in the present invention can access this information or parts of this information can be automatically accessed and used in the automatic handicapping function of the quick picking function of the invention. This use of actual handicapping data or information in the execution of an automatic pick or quick pick selection is significant. In existing off-track wagering systems, the selector for Quik Picks is believed to be only a random selection. The use of handicapping information in a quick-pick is itself an advance in the art. The quick picking function of the invention may also use pool balancing, pool equalization or pool smoothing functions and considerations in making quick pick selections. These balancing, equalization or smoothing function can influence the actual wager selected, even though the handicapping considerations are integral to certain selections.

The nature of handicapping is only minimally understood by the general public, and even by those presumed to be skilled in the art. The objective is more to balance the best statistical return on a wager, and not merely to select the runner (e.g., horse) that is most likely to win that particular wager. Rather an objective is to select runners that will, statistically, return the highest amount in the long-run based on the information available. For example, odds and probability of events must be considered at the same time. Even if there were a 60% chance (based on handicapping information) that a particular runner is likely to finish in the top three finishers, but the runner would pay only $2.10 to Show, it would be statistically preferred to make the wager on a runner that has only a 20% chance to finish in the top three finishers, if the pool presently shows a potential payout of $7.20 to Show. Given those values, the statistical return per wager would be $1.26 on the first runner and $1.44 on the second runner. Handicapping may also be influenced by player selection or program content to lean towards favorites, middle odds or long-shots wagers. This influence may be player selected or automatic, or varied automatically within the handicapping program.

Any race providing system is useful, with live feed or at least immediate feed (with minimal delay that does not compromise the wagering system) from the race providing system being preferred. In a typical race providing system, the racing information is generated internally within the race providing system and/or obtained from associated race event tracks and, if applicable, off-track betting locations/devices and other race providing systems (not shown in FIG. 1). Commercial information providing systems may be accessed, or a private information providing system constructed. A race providing system may also receive racing information from an information provider, unassociated with a particular race event track, supplying racing information (e.g., information services provided by Equibase Company LLC) (not shown in FIG. 1). Furthermore, the at least one wagering terminal provides racing information to the race providing system, particularly betting pool information. In an embodiment, the race providing system may include information related to a number of race events at one or more race event tracks so as to provide the at least one wagering terminal with information regarding a substantially continuous succession of race events. As will be apparent to those skilled in the art (but not shown in FIG. 1), each race event track or other information provider may instead of or in addition to providing their racing information to or through the intermediate race providing system, provide the racing information directly to the at least one wagering terminal over a connection or network. However, in at least one embodiment, a race providing system is used, and preferably a horse race system, a dog race system, or most preferably a combination of horse race and dog race access system is provided.

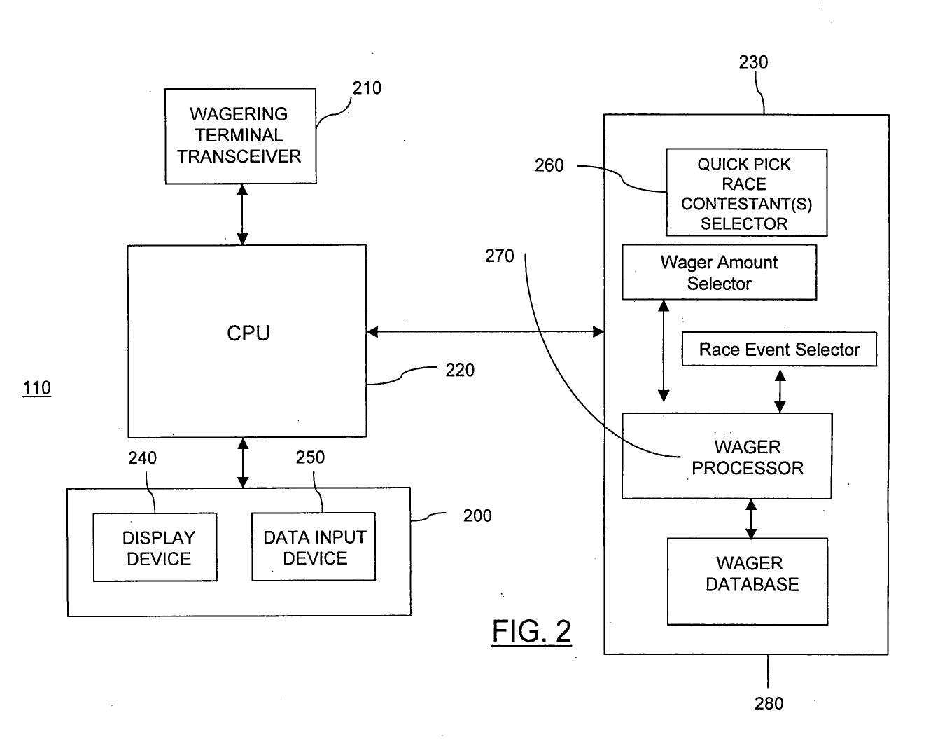

As shown in FIG. 2, in an embodiment, the race providing system 110 comprises a system operator interface 200, a wagering terminal transceiver 210 for communicating with the at least one wagering terminal 120, a central processing unit (CPU) 220 in communication with the system operator interface and the wagering terminal transceiver, and memory 230 in communication with the CPU.

The system operator interface comprises a data display device 240, typically comprising at least one CRT display (although any visual display, such as plasma screen, LED screen, liquid crystal screen, or the like), for allowing a system operator to view, among other things, the racing information. The system operator interface also includes a data input device 250, such as a keyboard and/or mouse, for allowing the system operator to enter control commands through the system operator interface. The control commands include commands for configuring racing information to be transmitted to the at least one wagering terminal, commands for configuring the wager processing of the race providing system, and where applicable, commands for configuring the wager type of the at least one wagering terminal. These will be discussed in greater detail in the further description of the invention.

The wagering terminal transceiver 210 for communicating with the at least one wagering terminal is one or more mechanisms to send all or some of the racing information to the at least one wagering terminal and, where applicable, to send any other information to the at least one wagering terminal. The wagering terminal transceiver 210 for communicating with the at least one wagering terminal is also configured to receive wagering information from the at least one wagering terminal for provision to the wagering processor. Such mechanisms may be typical communication interfaces. In an embodiment, the racing information is manipulated and formatted for sending to the at least one wagering terminal. Further, the other information sent to the at least one wagering terminal may include one or more sets of quick pick race contestant(s) and one or more least chosen race contestants for a wager type, particularly the one or more race contestants for a wager type that may yield a payout of the entire pool, both as described in more detail below. The wagering terminal may be specific to only a single wager type (e.g., only Win, only Place, or only Show) or may enable the user to select from among the different wagers or automatically select from among the different wagers.

The memory 230 may include processor instructions for the CPU 220 to define a quick pick race contestant(s) selector 260 and a wager processor 270. The memory 230 may also include a wager database 280 in communication with the wager processor 270. As will be apparent to those skilled in the art, the memory 230 may be non-volatile or volatile (e.g., RAM) memory or both. The wager database 280 may include one or more wagering records that identify the network address of the at least one wagering terminal from which a wager has been placed and information regarding the wager transmitted from that at least one wagering terminal. Any operating system (OS) may be used for the software as long as it is capable of executing the programs and accepting/converting the data from the race providing system/source. Such operating systems as Microsoft® Word, Word Perfect™, Linux, UNIX, MAC operating systems, specially designed operating systems, derivatives of these operating systems, and the like may be used.

The wager processor 270 may be configured to receive wager information from the at least one wagering terminal (typically via the wagering terminal transceiver), to maintain the wager database 280 with the received wager information and where applicable, to signal the appropriate at least one wagering terminal to initiate payout of winning wagers to the user of the at least one wagering terminal. Where the at least one wagering terminal is used to place parimutuel wagers, the wager processor is also configured to include the received wager information into the appropriate parimutuel pool and where applicable, obtain information on the size of the parimutuel pool for calculation of the relevant payout. Where, for example, the race providing system is connected to one or more other race providing systems, the wager processor transfers the received wager, where applicable, to the correct race providing system(s) so that the wager can be included in the appropriate parimutuel pool managed by that race providing system(s) and similarly, where applicable, obtain information on the size of the parimutuel pool from the relevant race providing system(s) for calculation of the relevant payout.

The quick pick race contestant(s) selector 260 may be used to generate one or more sets of quick pick race contestant(s) for each race event. Each set of quick pick race contestant(s) may comprise one or more race contestants of a race event according to a specific wager type and is determined by a race contestant selection algorithm. In an embodiment, the number of determined race contestants in a set of quick pick race contestant(s) primarily depends on the wager type. A set of quick pick race contestant(s) for a win, show or place wager type will comprise one race contestant. Similarly, a set of quick pick race contestant(s) for an exacta wager type will comprise two race contestants. The quick pick function may also uniquely select partial picks, completing a partial selection on a wager. For example, in an exacta, the player may select one of the two runners/horses (in either position) and by pressing quick pick, the system will automatically select the completing runners for that wager type. Similarly with a trifecta, the player selection may be for 0, 1 or 2 horses, and the quick pick selection would complete the selection of 1, 2 or 3 runners, respectively.

The race contestant selection algorithm may employ handicapping information and odds information to determine a set of race contestants for a particular race event according to a specific wager type. In an embodiment pertaining to horse racing, the algorithm may analyze for each race contestant of a particular race event the handicapping information including, without limitation, the race contestant's trainer statistics, race contestant's jockey statistics, the track condition of the race event, and the times between race events for the race contestant. Further, the algorithm may analyze for each race contestant of a particular race event the odds information, for example the difference between the “morning line” odds and current odds information for the race contestant. The quick pick value (according to the practice of the invention) of each race contestant may then simply be a weighted value of the handicapping information and odds information associated with each race contestant. The quick pick values for the race contestants of a race event may then be analyzed to determine a set of race contestants for a specific wager type for the particular race event, preferably an optimal set of race contestants to win the specific wager type for the particular race event. As will be apparent to those skilled in the art, any number of race contestant selection algorithms are possible employing handicapping information and odds information to determine a set of race contestants for a specific wager type for a particular race event. Any other handicapping information may also be included, such as without limitation, post position, wind conditions, temperature effects on the runner, travel history of the runner, performance on particular track types and soil types, and the like. Player preferences, player profiles, and other player specific information may also be added to the data analyzed in the handicapping, even preferences of pole positions (e.g., not wagering on certain odds on horses from certain pole positions, such as beyond the 8^{th} position, and the like) Today, there are no handicapping databases that interact with the totalisator by using the odds feed from at least two systems, such as the ITSP combined with Equibase feed for horse names and/or HDW for raw racing data. The combined feeds are fed through a data concentrator and the file containing only picks is sent to machines. This reduces network cost rather than sending through feeds to every machine. In modern day simulcasting there is no time to handicap if a player wants to bet every race or maximize the races that are wagered upon. Most tracks carry 400 simulcast races a day (8 races×50 tracks). Many of these races are only 1 minute apart, thereby not leaving enough time between races to be handicapped manually since there are too many handicapping variables. Thereby, customers will lose their money easier to other tracks that are only carrying 10 tracks a day since those bettors have more time between races. However, if there are fewer available races on the day, less money will be wagered and there will be less earnings for the track. Even though the track only takes an operating cut or takeout, the tracks and the terminal operators will still want players to win, since the more money they have to play with, the more the track can chum and earn its percentage. It is a general objective of the industry to want the other tracks sending money to tracks where wagers have been placed when the simulcast accounts are settled at the end of the month.

The quick pick race contestant(s) selector 260 may also be implemented on the at least one wagering terminal in addition to or substitute of the quick pick race contestant(s) selector provided at the race providing system. Further, the quick pick race contestant(s) selector 260 can determine the one or more sets of quick pick race contestant(s) automatically for each race event and/or determine the one or more sets of quick pick race contestant(s) for a race event upon request from or at the at least one wagering terminal.

In a variation, the quick pick race contestant(s) selector 260 may be configured to determine a number of sets of quick pick race contestant(s) using a number of different race contestant selection algorithms. For example, a different race contestant selection algorithm may simply be a version of a race contestant selection algorithm giving different weights to handicapping and odds information or may be a race contestant selection algorithm using different handicapping information and/or odds information to select one or more race contestant(s). The quick pick race contestant(s) selector 260 may be configured to use a different race contestant selection algorithm (from among various algorithms that can be provided within the system) whenever a reselection command is received from an at least one wagering terminal in order to provide one or more new sets of quick pick race contestant(s) to that wagering terminal.

In FIG. 2, the CPU 220 may communicate with the system operator interface 200, the wagering terminal transceiver 210 and the memory 230. The CPU 220 may facilitate the operation of the race providing system including executing processor instructions defining the quick pick race contestant(s) selector 260 and the wager processor 270. The CPU 220 may also facilitate, where applicable, the determination of one or more least chosen race contestants for a wager type, particularly the one or more race contestants for a wager type that will yield a payout of the entire pool, as described in more detail below. Additionally, with player input, the program may be able select less than all runners/contestants to complete a partial entry selection by the player/user.

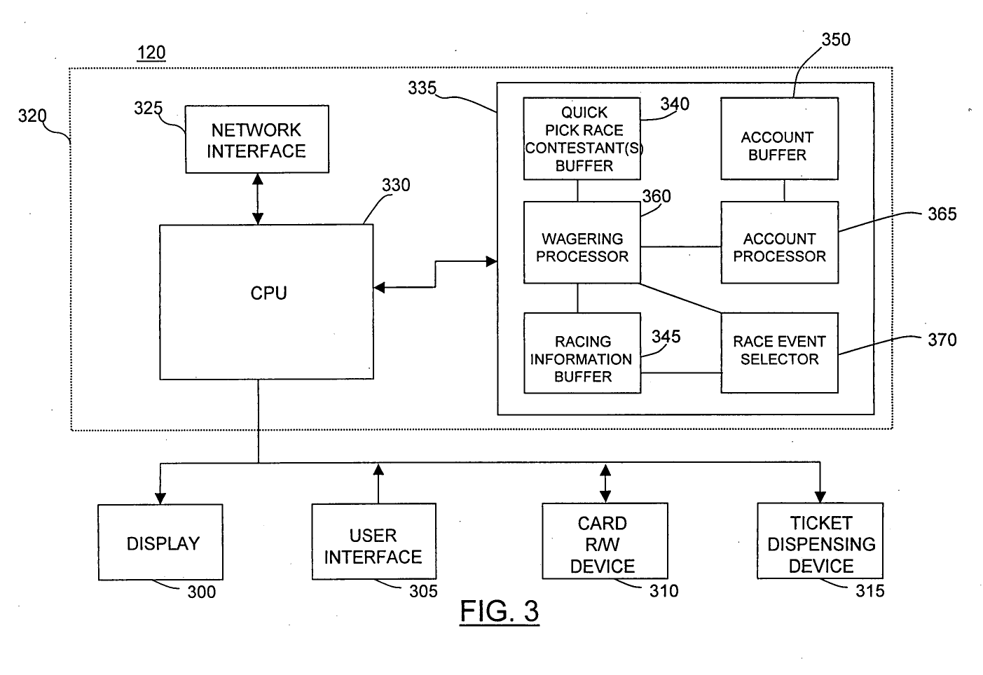

Turning now to FIG. 3, a schematic diagram of an embodiment of an at least one wagering terminal 120 is shown comprising a display 300 for presenting information regarding race events received from the race providing system, a user interface 305 for placing wagers on race events, a card read/write device 310 for receiving an electronic or magnetic-stripe card encoded with a user's account information, a ticket dispensing device 315 for providing a ticket comprising wager information for an elected race event, and a processor 320 for facilitating wagering on the selected next and other future race events and for communicating with the display 300, the user interface 305, the card read/write device 310 and the ticket dispensing device 315. The ticket dispensing device 315 is optional, as the player may remain at the terminal 120, or other accounting systems that track player use, winnings and losses.

In an embodiment, a user may open an account specifically for wagering which is credited and/or debited as required with monetary and/or other credit values. Such an account may be set-up, for example, manually with a clerk of the establishment controlling the at least one wagering terminal 120 or electronically by the user through telephone or the Internet. Typically, an electronic/magnetic-stripe card is issued by the establishment to the user through, for example, a clerk or automated device, and is encoded with information identifying the user's account balance. The user can then credit and/or debit monetary or other credit values through, for example, the clerk or an automated device. Other secure access systems for enabling player/user access may also be used.

A wagering account/card set-up kiosk may be provided for wagering account set-up and/or to issue a wagering card. The kiosk is dedicated to wagering account set-up and provides a number of options on how to set-up the wagering account. For example, the user, or a person facilitating account set-up for the user, can manually enter the necessary information into screens of the kiosk or supply a completed form into the kiosk which is read by optical character recognition hardware and software of the kiosk. Once the wagering account application is accepted, a wagering card or access number may be issued by the kiosk. The access may be limited to the actual amount in the account or may be debited to other accounts (e.g., bank accounts, credit cards, etc.).

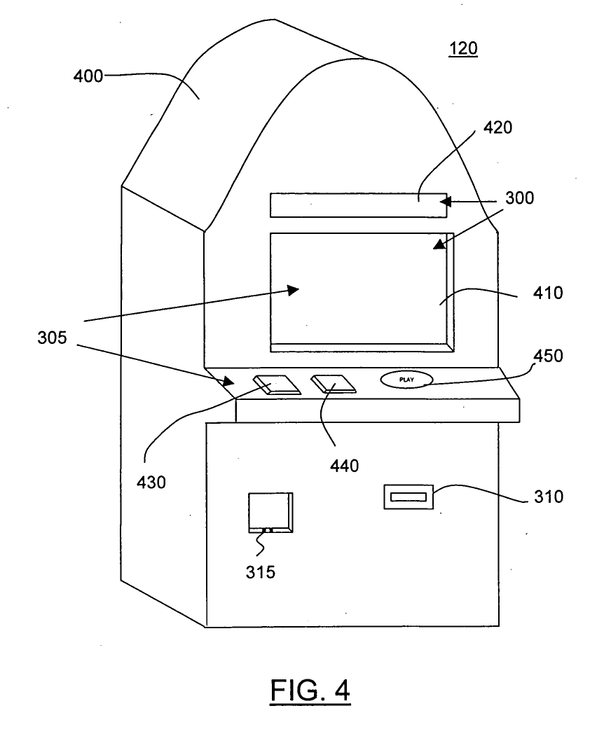

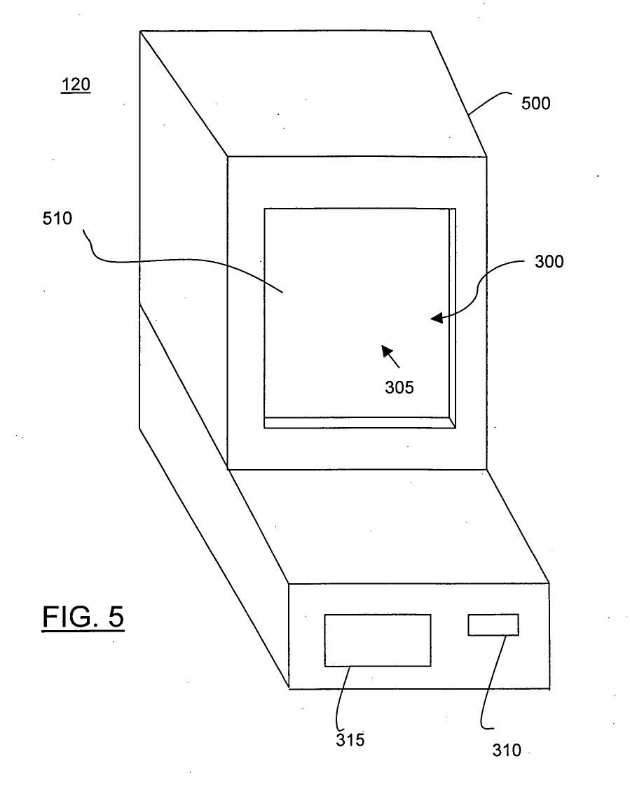

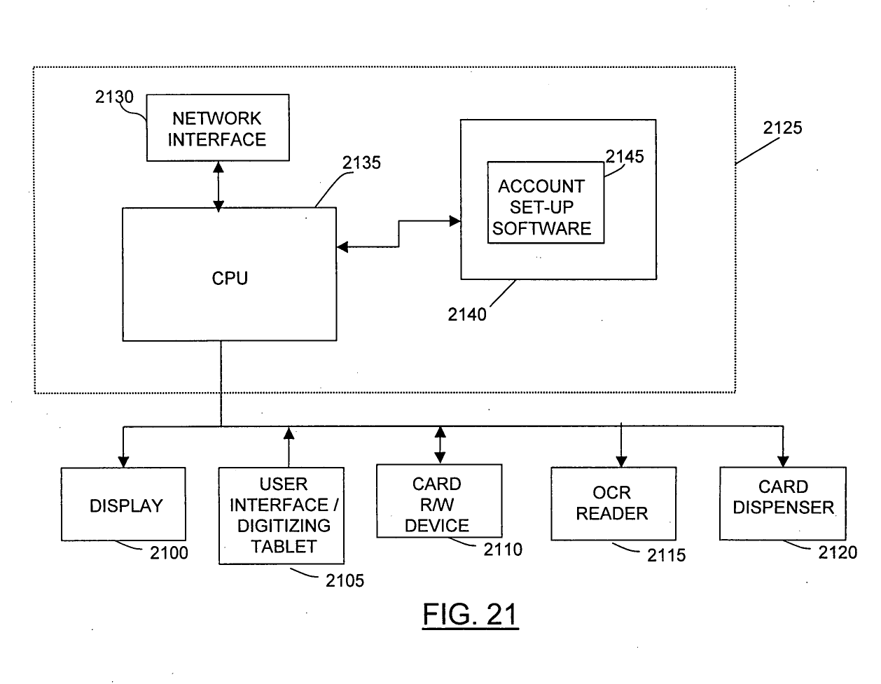

Referring to FIG. 21, the kiosk may include a display 2100 for presenting information about wagering account set-up, optical character recognition reader 2115 (hardware and software) to scan and parse a completed wagering account application form, a wagering card dispenser 2120 to issue a wagering account card on successful completion of wagering account set-up, a user interface and digitizing tablet 2105 to capture a user's input and signature, optionally a card reader 2110 to read various types of cards such as drivers licenses, ATM cards, etc., and a processor 2125 to facilitate account set-up. The account processor 2125 may include a network connection 2130 to an account management system and optionally a credit database, and a central processing unit (CPU) 2135 in communication with the various devices noted above. The processor 2125 may also include a memory 2140 in communication with the CPU 2135. The memory 2140 may comprise account set-up software 2145 to facilitate wagering account set-up. The kiosk may be of the same or similar design as the wagering terminal depicted in FIGS. 4 and 5 and further described below.

As an example, the kiosk may present a message such as “Press here to signup now or insert a completed application”. If the user inserts a completed application (for which copies of blank applications should be available with or near the kiosk), the OCR reader scans the application form and collects all relevant information from the form. The kiosk will confirm the information with the user through a screen presented on the kiosk's display and prompt the user for any missing or illegible information from the application. Once the application has been processed, the account may then be validated and set-up through, for example, a connection to a credit database such as an Equifax™ database. Optionally, the kiosk may request the insertion of a drivers license or credit card into a card reader of the kiosk or request a social security number, password, PIN number or other identifier for validation of wagering account set-up. The kiosk may also request a deposit of value into the wagering account through, for example, the insertion of an ATM card or credit card into a card reader of the kiosk. When the wagering account set-up is successful, a wagering card is dispensed by the kiosk. The user can use the wagering card and, optionally, a personal identification number (PIN) provided by the kiosk, to immediately begin wagering at, for example, a wagering terminal. The completed application may include a signature and the kiosk collects the hard copy applications for later retrieval. The hard copy application form may be used as a permanent record of the user's agreement to the terms and conditions of the wagering account and of the user's eligibility for the wagering account. Alternatively, the wagering card may be mailed or separately delivered to the user. Further, a separate wagering account set-up confirmation may be sent to the user by mail, fax, e-mail, etc. to provide the security that a wagering account has not been fraudulently established.

If the user elects to set-up the wagering account/card immediately, the kiosk provides relevant screens on its display to guide the user through the wagering account set-up process and to prompt the user for the necessary information. In an embodiment, the screens request substantially the same information as on the wagering account application. The kiosk may provide a digitizing tablet to capture a user's signature or fingerprint, or in the future, retinal scans, in order to complete wagering account set-up. Once the screens are completed and the signature is provided, the account may then be validated and set-up through, for example, a connection to a credit database. Optionally, the kiosk may request the insertion of a drivers license or credit card into a card reader of the kiosk or request a social security number or other identifier for validation of wagering account set-up. The kiosk may also request a deposit of value into the wagering account through, for example, the insertion of an ATM card or credit card into a card reader of the kiosk. When the wagering account set-up is successful, a wagering card may be dispensed by the kiosk. The user can use the wagering card and, optionally, a personal identification number (PIN) provided by the kiosk, to immediately begin wagering at, for example, a wagering terminal. The digitized signature may be used as a permanent record of the user's agreement to the terms and conditions of the wagering account and of the user's eligibility for the wagering account. Alternatively, the wagering card may be mailed or separately delivered to the user. Further, a separate wagering account set-up confirmation may be sent to the user by mail, fax, e-mail, etc. to provide security that a wagering account has not been fraudulently established.

To place one or more wagers, the user would introduce the card to the card read/write device, a form of a wagering value mechanism, of the at least one wagering terminal on which the user would like to place one or more wagers. Other accessing formats described herein or acceptable to the field would also be useable by the player user. Thus, the access system, such as the card read/write device of the at least one wagering terminal allows the user to supply the monetary or other credit value needed to place a wager. Further, in an embodiment, the card read/write device of the at least one wagering terminal may facilitate the payout to the user of a winning wager. As will be apparent to those skilled in the art, accounts that are not specifically set up for wagering such as bank accounts or credit accounts could be used in place of or in addition to the wagering account set-up specifically for wagering and similarly, other types of electronic/magnetic-stripe cards such as credit cards or debit cards may be used be used in place of or in addition to the wagering card set-up specifically for wagering.

Further forms of wagering value mechanisms may be provided in addition to or as a substitute for the card read/write device including a currency receiver (not shown) for receiving currency and, where applicable, a currency dispensing device (not shown) for dispensing currency payouts. The currency receiver allows the user to supply the monetary or other credit value needed to place a wager and may also be used to credit monetary or other credit value to a user's account, for example, stored on a card. For example, a user can deposit cash into the user's account by inserting the user's wagering card into the card read/write device and then inserting currency into the currency receiver for deposit into the wagering account. The currency dispensing device may facilitate the payout to the user of a winning wager or the withdrawal of currency from the user's account. For example, the at least one wagering terminal may be registered in the account system as a teller machine and when a withdrawal is made, the user's account is debited and the cash on hand balance for that wagering terminal/teller machine is debited. Similarly, the at least one wagering terminal may be registered in the account system as a teller machine and when a deposit is made, the user's account is credited and the cash on hand balance for that wagering terminal/teller machine is credited. Internal controls are established to ensure that the cash on hand in the at least one wagering terminal, the amount of cash withdrawal and the physical access to the wagering terminal is adequately secured.

As will be apparent to those skilled in the art, the at least one wagering terminal may have electronic access, another form of a wagering value mechanism, to the user's account such that the user's account balance need not be on an electronic/magnetic-stripe or for that matter no card or currency device may be required. For example, the race providing system may provide facilities to access user accounts including the ability to credit and debit the user's account, to receive account information requests from the at least one wagering terminal, verify access to an account by a user using the at least one wagering terminal, etc. Alternatively, another system connected to the at least one wagering terminal may provide such access to user accounts such as credit card merchant services. The user accounts may be accounts specifically set up for wagering or may be general accounts not necessarily maintained at the race providing system such as credit or bank accounts. The at least one wagering terminal could use a card read/write device to get the necessary information for the user's account (for example, for credit and bank accounts) or could allow the user to provide the necessary information to access the user's account through the at least one wagering terminal's user interface. As will be apparent, any number of wagering value mechanisms known now or developed in the future may be employed to provide a wager amount and/or deliver a payout for a winning wager.

In an embodiment where the user opens an account specifically for wagering, to facilitate monetary or other credit value deposit to and withdrawal from the wagering account and the associated wagering card, the wagering account and card may be related to a financial account and/or card, such as a bank account and/or ATM card or a credit card account and/or credit card, to facilitate monetary or other credit value deposit and withdrawal. Where the wagering account/card holds monetary value, a direct transfer between the financial account and/or card and the wagering account/card can be made subject to currency conversions. Where the wagering account/card holds other credit value, a transfer between the financial account and/or card and the wagering account/card involves a conversion process to convert monetary value to the other credit value, subject to currency conversions.

Where the user does not have a financial account and/or card and the establishment controlling the at least one wagering terminal has an agreement with a partner financial institution or bank, the user may automatically get a financial account and/or financial card along with a wagering account/card for use with at least one wagering terminal. The financial account would be similar or identical to a traditional bank or other account. The financial account information will automatically be associated to the user's wagering account information for the purpose of making withdrawals and deposits.

Where the user has an existing financial account/card, such as a bank account/ATM card or a credit card account/credit card, the account information of that financial account/card is associated with the wagering account/card during, for example, the wagering account set-up by the user providing the financial account/card information or electronically swiping the financial card to obtain the financial account/card information. If the user does not have the financial account/card information available, a follow-up offer is made to the user to provide the financial account/card information via, for example, a cancelled check, an on-line check processing step (where a blank check is scanned and used by the system), or an online form. The financial account/card information will be associated with the user's wagering account/card. Through the association, the user is provided a convenient way to transfer monetary or other credit value to and from the user's wagering account/card directly to or from the financial account/card, monetary or other credit value the user can access via, for example, an automated teller machine or other mechanism.

To withdraw monetary or other credit value from the wagering account/card to the financial account/card associated with the wagering account/card, the user can use an automated phone system, an Internet application, a signup kiosk or at least one wagering terminal to request a withdrawal. If the wagering account/card is mapped to the financial account/card, the withdrawal can be available in the form of cash by using the financial card in, for example, an automated teller machine. Similarly, to deposit money into the wagering account/card from the financial account associated with the wagering account/card, the user can use an automated phone system, an Internet application, a signup kiosk or at least one wagering terminal to request a deposit. Appropriate user prompting and/or screens are provided to facilitate withdrawal and deposit. For example, the at least one wagering terminal may provide one or more special icons and/or buttons to access the withdrawal and/or deposit functionality. One or more screens may be triggered and provided by at least one wagering terminal software upon selection of the icons(s) and/or button(s) to prompt the user for an amount to withdraw and/or deposit and optionally request a user identification code such as a PIN. Appropriate transaction processing is provided to the at least one wagering terminal, sign-up kiosk, etc. to facilitate the monetary or other credit value transfer between the financial account/card and the wagering account/card. Such transaction processing can be, for example, provided by a race providing system, a hub or account wagering clearing services described in more detail below, or some other financial transaction processing system.

Further, there are currently a variety of account wagering suppliers in the U.S. and internationally. Each account wagering supplier maintains ownership of their wagering account records and is responsible for reporting and reconciling wagering activity through an aggregation function such as the Inter-Tote Service Protocol (ITSP). Account wagering is provided at, for example, race event tracks, off-track betting facilities, telephone betting facilities and Internet betting facilities. Account wagering is also facilitated in the at least one wagering terminal in accordance with an embodiment of the present invention. However, the variety of account wagering offerings presents a less than ideal solution to a user because of the inconvenience of maintaining several accounts with different account wagering suppliers each with different restrictions and minimum balance requirements. The reasons for fragmentation in account wagering services supply include account wagering suppliers' need to own their customer data, account wagering suppliers' need to control the quality of account wagering service to their customers, variations in the rules governing account wagering from jurisdiction to jurisdiction, tote companies having incompatible account wagering interface formats, and account wagering suppliers and other stakeholders competition to control account wagering services. It is desirable for the present system to have the protocols available to access these tote systems, rather than establishing an independent tote system, but the latter is also an option.

So, according to at least one embodiment of the invention, there is provided a method and system of increasing collaboration between account wagering suppliers to a user location. Advantages of increased collaboration between account wagering suppliers include improved user experience and de-fragmentation of the account wagering environment. The method and system according to an embodiment of the present invention includes a universal wagering card, a portable card reader module, an account wagering clearance service and a business model to provide incentives to wagering account suppliers to accept each others account wagering cards. As will be apparent to those skilled in the art, sub-combinations of these aspects may be provided.

A first aspect is the creation and branding of a universal wagering card. For example, the universal wagering card aims to resolve a problem in the racing industry that wagering cards are associated with specific race event tracks and typically cannot be used at different race event tracks. The lack of a portable wagering card poses problems when a user wants to move between or to new race event tracks. This problem may be significant for account based wagering using the at least one wagering terminal in accordance with an embodiment of the present invention because the at least one wagering terminal may be available at a variety of locations including at race event tracks. Requiring a user to manage numerous different wagering cards could turn a user away from account wagering and using the at least one wagering terminal.

The universal wagering card (UWC) is a wagering card that allows additional account wagering capabilities. In particular, the UWC will essentially be a debit card authorized for account based wagering. In order to meet this need, the UWC will have, in an embodiment, certain features. First, the UWC must have credibility. The card should be prestigious in nature so that users demand it. A gold or platinum card is attractive compared to the existing mag-stripe cards. Further, the UWC should offer benefits over a regular wagering card, such as rebates or prizes. Further, the UWC should be secure. The UWC should be very difficult to duplicate and protected by a PIN code. The UWC should be tied to a trusted account management facility (TAM) via, for example, secure web services and support secure public key communications. In an embodiment, the at least one wagering terminal according to an embodiment of the present invention may be interfaced to the TAM via a VPN concentrator described in more detail below.

Additionally, the UWC should have acceptance. The UWC will be accepted at wagering terminals located at other than a race event track or an off-track betting location. The UWC will be accepted at Internet sites. If a card reader is not present, the wagering account number and PIN may be used and certain wagering restrictions may apply to ensure security. The UWC will be accepted at race event tracks and off-track betting facilities where approved by that facility. Additionally, the wagering terminals should be able to accept traditional wager cards as well as the UWC, especially those wagering terminals at race event tracks and off-track betting locations. The wagering terminals may be configured to allow an account wagering supplier to supply a module to handle that wagering supplier's wagering card as discussed in more detail below in respect of the portable card reader module.

Account wagering suppliers and account wagering customers, such as race event tracks, off-site betting facilities, Internet sites, etc., should be provided an incentive to allow the use of the UWC. For example, the UWC system can vouch money for local (non-UWC) transactions at trusted account wagering customers. An account wagering customer that issues a UWC to a user can receive a percentage of all transactions placed on that user's issued UWC. An account wagering customer that issues a UWC to a user can be entitled to data on UWC card usage. An account wagering customer that accepts a UWC transaction can receive data on UWC users and transactions at that account wagering customer's facility. Also, the UWC card can ensure compliance with all racing regulations regarding deposits, withdrawals, etc. The TAM can provide problem gaming compliance and government reporting. As will be apparent to those skilled in the art, sub-combinations of features or additional features can be provided in relation to the UWC.

In a further aspect, there is provided a portable card reader module (PCRM). The PCRM is a portable hardware/software module for processing account wagering transactions from disparate account wagering cards using a hardware card reader. The PCRM module works in conjunction with, for example, a VPN concentrator described in more detail below to allow an account wagering customer's existing facility to accept foreign wagering account transactions using one or more foreign wagering cards, i.e., wagering account transactions from a wagering card(s) issued by other account wagering customers. Currently, a wagering device that accepts a wagering card typically reads a 2 track magnetic stripe card and potentially receives a PIN via keypad or input device. Accordingly, in an embodiment, there are two models of the PCRM: the first model is a software only component that provides field compatibility with foreign account cards and/or the UWC for existing card readers and the second model upgrades the card reader and keypad/input device to support foreign account cards and/or the UWC. Both models comprise a software module that intercepts the communications between the wagering device software and the card reader/key pad/input device. If the inserted wagering card is a foreign account card or a UWC, the PCRM module provides a reserved account identifier to the wagering device and uses out of band communications through, for example, the VPN concentrator to record the sub-account for the pending transaction. The transaction is then processed through an account wagering transaction processing system such as, for example, a race providing system, a hub or account wagering clearing service described in more detail below, or some other transaction processing system. Additionally, if a wagering device performs a balance lookup function on a wagering account, this function must be wrapped to intercept requests on the reserved account and route them through, for example, the VPN concentrator for fund approval. In an embodiment, this may occur in the account management functions within a race providing system by providing a 3^{rd} party library along with a VPN concentrator to enable real-time balance lookups on foreign wagering accounts or the UWC wagering account.

In accordance with a further aspect, there is provided an account wagering clearing service (AWCS). The AWCS is a secure facility that provides data interchange between multiple account wagering suppliers along with many other crucial pieces of hub functionality described in more detail below for the at least one wagering terminal in accordance with the present invention. The AWCS is able to process foreign wagering account transactions. In an embodiment, the AWCS is Internet based.

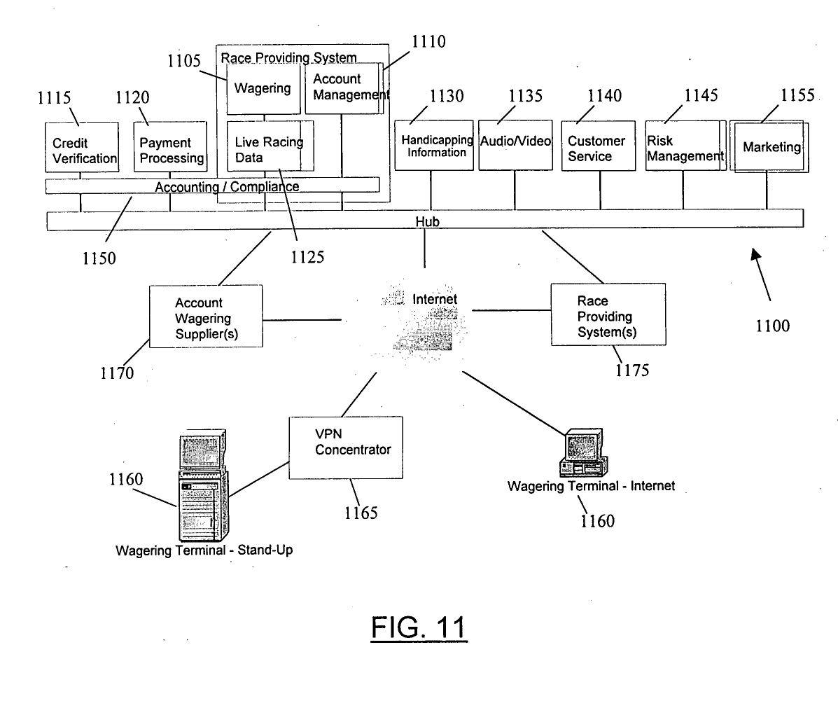

The hub may provide a set of services necessary to support field installations of the at least one wagering terminal in accordance with at least one embodiment of the present invention. Referring to FIG. 11, the hub 1100 may support the aggregation of vendor services including wagering 1105, account management 1110, credit verification 1115, payment processing 1120, live racing data 1125, handicapping information 1130 and audio/video 1135. The hub 1100 may provide a common services application programming interface that will serve as a scalable platform for supporting the at least one wagering terminal and other devices and for delivering wagering services through the at least one wagering terminal and other devices. The hub 1100 may also support business management functions/applications, including customer service 1140, risk management 1145, accounting and compliance 1150, and marketing 1155.

In addition to the broad range of services described above, the AWCS may provide the capabilities of: 1) placing a wager in a foreign wagering account; 2) transferring or vouching for funds between foreign wagering accounts; 3) checking a user's balance in a foreign wagering account; 4) canceling a wager in a foreign wagering account; 5) logging into a foreign wagering account; 6) connecting to foreign wagering account via, for example, IVR, HTTP, XML/Web services, Amtote Gateway API, Autotote ATL, and/or United Tote IVR serial protocol; 7) ensuring compliance with a broad range of jurisdictional gaming regulations via a regulatory rule base; 8) providing detailed user and account data to trusted parties based on access policies represented by an access control rule base; and 9) providing immediate calculation of actual payouts on a given wager and pushing that data to a requester on a given live data channel. As can be seen in FIG. 11, the hub 1100 may have connections to the at least one wagering terminal 1160 via an optional VPN concentrator 1165, to an account wagering supplier(s) 1170 and to a race providing system(s) 1175. In an embodiment, the connections are via the Internet although as will be apparent to those skilled in the art the connections may be a private or direct connection.

In another aspect, a business model is provided to supply an incentive to existing account wagering customers to accept or create foreign wagering cards. In an embodiment, if an account wagering customer chooses to become a member of an account wagering consortium (AWC), the account wagering customer's wagering cards will be accepted by all wagering devices, such the at least one wagering terminal in accordance with an embodiment of the present invention, of at least one prominent member of the AWC. Furthermore, wagering cards of an account wagering customer of a certain level of membership in the AWC will be accepted at all AWC member facilities of the same or higher level of membership. Wagering cards of an account wagering customer of a certain level of membership in the AWC will also be accepted at all AWC facilities of the same or higher level of membership. Members of the AWC agree to accept the UWC at their facilities including Internet site(s) and wagering devices at race event tracks. The AWC members also agree to display an AWC logo prominently at their wagering facilities, on wagering devices, and on their wagering cards.

For each foreign wager account transaction placed at an AWC member, the foreign wager account issuer and the AWC member will each receive a percentage of the handle and/or a percentage of any wagering fee. The AWC will receive a percentage of each wager and fee in exchange for processing the inter-entity transaction, owning the AWC brand, managing jurisdictional restrictions, serving as a clearing house and underwriting the transfer of funds.

The AWC, the foreign wager account issuer or the AWC member may process the wager depending on whether the wagering account supports miscellaneous debit and credit functionality. The foreign wager account issuer will own customer and transaction information for its customers. The AWC member processing the foreign wager account transaction will have per wager information, optionally anonymously, as well as detailed aggregate reports describing foreign wager account issuer(s) transaction volumes and high level user demographics. The AWC will be the trustee for all detailed wagering data to provide a complete audit trail and satisfy various jurisdictional requirements.

In an embodiment, the ticket dispensing device issues wager tickets to provide tangible evidence of a wager placed as well as to provide a means to obtain a payout of a winning wager in addition to or instead of payout via any one of the wager value mechanisms described above. The payout for a wager ticket can be obtained, for example, by providing the wager ticket to an automated machine that processes the wager ticket and provides a payout and/or credits a user's account. Alternatively, the payout can be obtained by presenting the wager ticket to a clerk who may provide the payout and/or credit a user's account. In an embodiment, the wager ticket includes information about the wager including the race track name, race number and date of the wagered race event, the wager amount, the wager type, the selected race contestant(s) of the wager, and the user account balance. In an embodiment, the selected race contestant(s) are shown in detail for the particular wager type. For example, an exacta and 3 wheels bet would show in detail the race contestants of the 3 combinations of this wager.

The processor 320 may comprise a network interface 325 for communicating with the race providing system 110, and a central processing unit (CPU) 330 in communication with the display 300, the user interface 305, the card read/write device 310, and the network interface 325. The processor 320 may also include a memory 335 in communication with the CPU 330.

The memory 335 may include a quick pick race contestant(s) buffer 340 for receiving the quick pick race contestant(s) data for the race events received from the race providing system, a racing information buffer 345 for receiving racing information, including odds information, from the race providing system, and an account buffer 350 for recording the monetary value of funds in the user's account. The memory 335 may also include processor instructions for the CPU 330 to define a wagering processor 360, an account processor 365 and a race event selector 370. As will be apparent to those skilled in the art, the various buffers and processor instructions may be combined into one or provided in alternate arrangements.

The race event selector 370 may communicate with the racing information buffer 345 and the wagering processor 360. The race event selector 370 may be configured to select race event information received from the race providing system for presentation on the display 330. In an embodiment, the race event selector 370 may be configured to determine and make available for display information about a next race event which is scheduled to run at all or certain of the race event tracks for which the race providing system has supplied race event information. The race event selector 370 may also be configured to determine and make available for display future race events in time order at all or certain of the race event tracks for which the race providing system has supplied race event information. If more than one race event is scheduled to run at or about the same time, the race event selector 370 may select information about one of the race events for display (for example, choosing a race event at a more preferred race event track). In this manner, the at least one wagering terminal may continuously provide a succession of race events to a user upon which to wager. As will be appreciated, some race events can only entertain certain types of wagers. For instance, superfecta wagering may not be permitted at a certain race event. Consequently, the race event selector may select for display only those race events for which the at least one wagering terminal is configured to receive wagers.

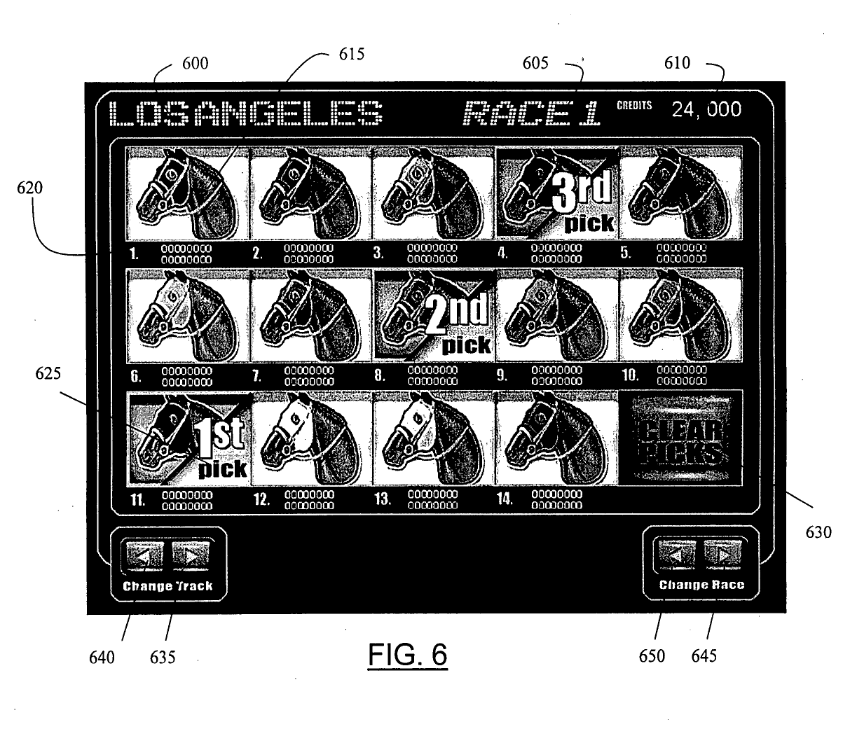

Further, the race event selector 370 may be configured to accept a next or previous race selection command from the user interface via the wagering processor 360, thereby allowing the user to view information regarding a next race event or future race events. For example, referring to FIG. 6, the user may “scroll” back and forth through a next and other future race events by starting time by touching the “Next Race” and “Previous Race” buttons/icons, each touch of the buttons/icons causing the wagering processor to present, as applicable, updated information on the display corresponding to the “previous” or “next” race event by start time. Essentially, the user is able to view (and thus wager on) in time order a next race event and other future race events for which the at least one wagering terminal has information. In an embodiment, a next and other future race events by starting time may be the next race events by starting time found at all of the race event tracks for which the race providing system has supplied race event information. In another embodiment, a next and other future race events by starting time may be the next and other future race events at the certain current race event track which is presented on the display of the at least one wagering terminal.

In at least one embodiment, an algorithm may be used to select a next race event from available race events at various race event tracks. The algorithm may determine a next race event by analyzing a number of factors which are weighted by importance. The weights may be manually or automatically adjusted to configure the determination of the next race event. The algorithm may continuously evaluate the latest information available for the various factors to make adjustments to the next race event provided to the at least one wagering terminal. The algorithm may also adjust for system factors such as the timely display of audio/video corresponding to the race events and/or the display of race event results. The factors can include: 1) estimated start of race event; 2) estimated duration of race event; 3) nature of the race event such as, for example, popularity, type of race, purse, handle, quality, number of bet types available, etc.; 4) actual start of the race event as affected by delays, for example, horse out of gate, inquiry, weather, etc.; and 5) playability, such as adequate time for a user to bet.

The race event selector 370 may also be configured to determine and make available for display race events at different race event tracks. In this regard, the race event selector 370 may be configured to accept a next or previous race event track selection command from the user interface 305 via the wagering processor 360, thereby allowing the user to view information regarding a race event at different race event tracks. For example, referring to FIG. 6, the user may “scroll” through future race events at different race event tracks by touching the “Next Track” and “Previous Track” buttons/icons, each touch of the button/icons causing the wagering processor 360 to present, as applicable, updated information on the display corresponding to the future race events at “previous” or “next” race event tracks. Essentially, the user is able to view (and thus wager on) race events at different race event tracks for which the at least one wagering terminal has information. In an embodiment, the race event track (of all of the race event tracks for which the race providing system has supplied race event information) having the next starting race event is presented, along with that next race event, on the display 300 of the at least one wagering terminal in response to a “next” race event track command. In another embodiment, the next race event track in alphabetical order (of all of the race event tracks for which the race providing system has supplied race event information) is presented, along with next starting race event at that race event track, on the display 300 of the at least one wagering terminal in response to a “next” race event track command.

The race event selector may or may not have a manual override which deviates from estimated past times derived from the tote feed.

One of the problems with parimutuel wagering on race events is that there is a tremendous amount of terminology that the player must be familiar with such as track codes which are abbreviated to save room or “real estate” on the user interface. For example, a track code for Gulfstream Park Racetrack is GP, another track code example is EVD for Evangeline Downs racetrack. A typical betting user interface may have 40 tracks taking up 40 square inches of the user interface. For the player the track codes become a guessing game because track codes such as AP, which stands for Arlington Park racetrack or ArP which stands for Arapahoe Park racetrack become very similar for a new player or “unseasoned” player. With worldwide simulcast there are over 1000 track codes and there is only 137 square inches on a typical wagering interface, thereby only accommodating 137 tracks (1 square inch per track code) per user interface. The player must then scroll through alphabetical pages to find track codes. By having a race event selector the track codes can be spelled out rather than abbreviated such as AP can be shown as Arlington Park, Race 3 with the race number included. The race number is the step or may be the next step with the track code on a conventional wagering terminal. However, track code and race number are combined by the race event selector.

Another aspect of the invention is the selection of races by the provided system based on the time until the next race. The system has access to races at numerous locations and the system selects races for wagering (unless overridden by player input) based upon identifying a race at the most convenient time in the near future. For example, assuming that each player spends 15 seconds placing a wager (including access time to a distal tote where applicable), the system will select the next race for wagering that is at least 15 seconds away. A safety zone of 5-30 seconds (or any time frame that is determined appropriate, essential, or desirable for practice of the invention, but less than 15 minutes, preferably less than 10 minutes, more preferably less than 8 minutes and less than 5 minutes, and most preferably less than 3 minutes, less than 2 minutes, and less than 1 minute) may also be built into the system to avoid the frustration of having the system switch races during the middle of wager placement and wasting the player's time. It must be remembered that once the wager has been placed on one race, the system may then switch to another race for wagering. This time control access, and the queuing of races is a unique feature of the present invention. Available races may be preferably queued in time for system selection and display to the player, and races may be replaced as time passes and the time limit for allowing a player to access and enter a wager on the race passes. The advantage of next race selection with the reasonably closest post time is that it prevents a bettor from missing a race and guides the bettor to the closest post time in the simulcast menu which gives the bettor more accurate odds because the odds are likely to change less because of the proximity of the race. For example, the odds have a greater chance of varying with 5 minutes to post versus 1 minute to post.

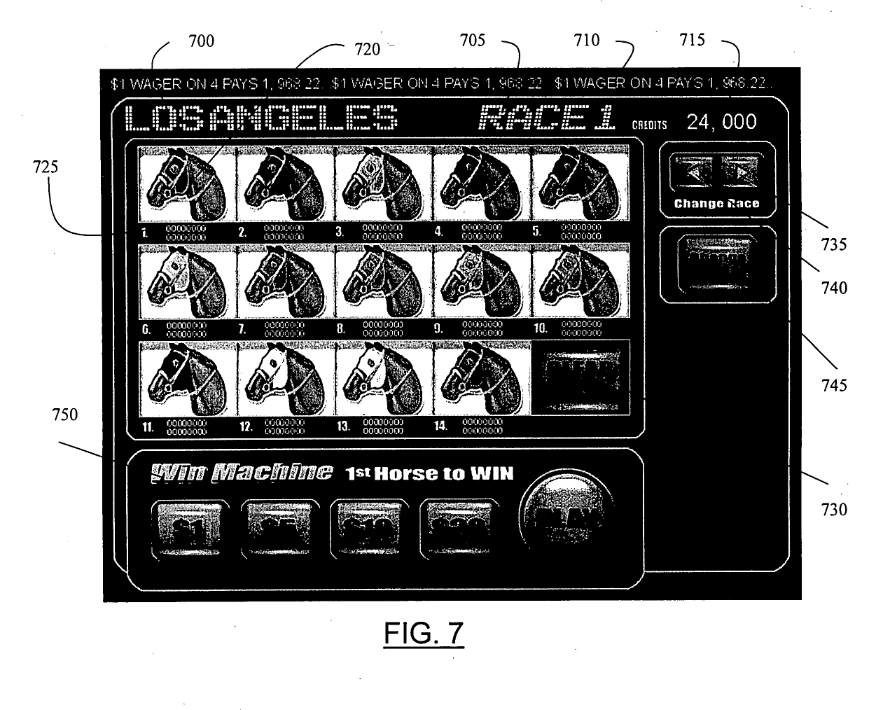

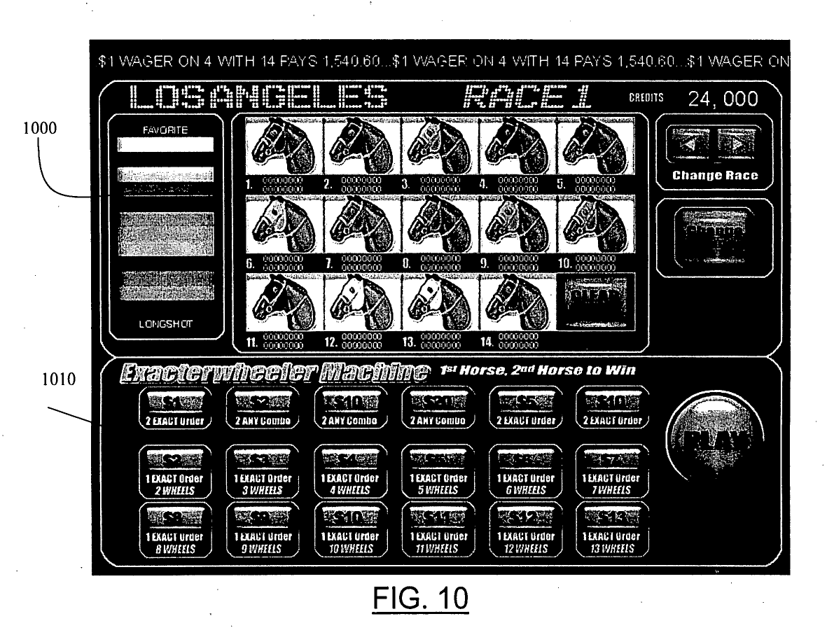

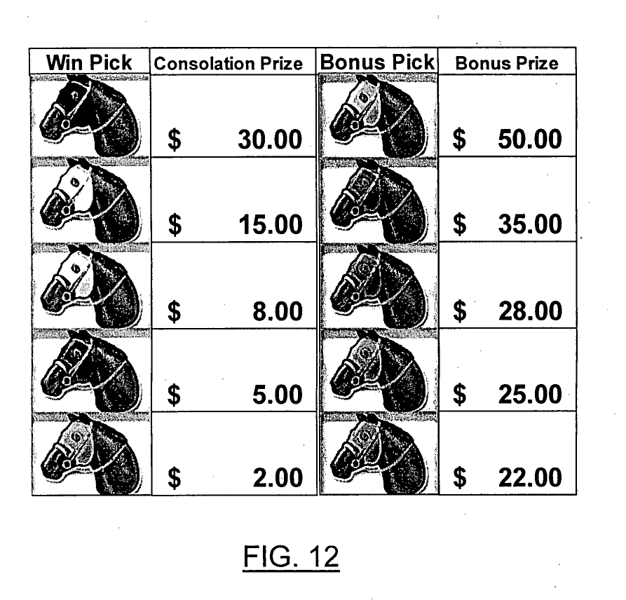

Some unique performance characteristics that have already been discussed above. Those will be further described and elaborated upon here. Automatic arrangement of odds and picks (e.g., a vertical or horizontal list from highest odds to lowest odds or lowest odds to highest odds [favorites to long shots]), are shown on FIGS. 12-18. The odds/payouts are placed into a readily viewable display that can be easily interpreted. FIG. 10 clearly shows color-coding of the odds, especially when arranged, so that players can see the odds in a color scheme both on the odds board and/or on images of the runners used to assist in or enable runner election. For example, the odds board may show the odds on rows that are, in order, red, white, blue, orange, pink, purple, green, etc. The odds would, by way of non-limiting example, be on the display red 5-7, white 2-1, blue 4-1, orange 6-1, pink 7-1, purple 9-1, green 12-1. Whatever the odds on a particular race, the same order of color would be used to display the order of the odds. As the odds shift during wagering, the colors on the odds of a particular runner may shift, but the order of the odds on a horse remain the same. This enables players to select runners (e.g., horses, dogs, etc.) by their colors based on a player' inclination to select horses according to their odds. Similarly to b), payouts can be simultaneously or later displayed in the reverse order of color scheme as the odds, as the potential payouts are relatively inverse in order to the odds, so the color scale will be reversed from the odds scale. The color scale 1000 could include within it, the inverse list of payout amounts or list the specific odds, or include both within the color rows. Alternatively, a separate table may show one or the other of the odds or payouts that are displayed on list 1000, as well as other displays on the screen. This allows the players to maintain a semblance of cognizance about wagers. The runner being wagered on may be shown in a series of rows and columns with representative images as shown in FIG. 7. These are not actual pictures or images of the horses, but representations of horses with the odds/payout colors used to further highlight the display of the runners. The odds or payout colors are associated with the images of the runners (e.g., the ‘color’ on the runner image re the colors of the odds arrangement, not the actual colors of the runner on the track. The colors may shift on the horses, although names of the horses that may be displayed with the symbolic images and the numbers of the horse in the race will remain consistent with the specific runner to be wagered upon in the event. The original display of the images may be by runner number, runner name or randomly on the display, or alphabetically or in numeric order, or by any arrangement that is designed into the system. When the wagers are placed by the player or automatically selected or automatically completed by the software, the columns and rows spin (giving the appearance of reels on a reel-type video slot machine), the spinning stopping, and the selection(s) positioned on a predefined position on the final display of the reels. For example, the winner wagered upon may be shown in column 1, row 1, or column 1, row 2 as a predetermined selection. If a trifecta were wagered upon, the three runners in the selection may be displayed as column 1, rows 1, 2 and 3; columns 1, 2 and 3 row 1; columns 2, 3 and 4 in row 1 or row 2, etc. The final display of the runners wagered upon may also and preferably highlight the runners wagered on, as by screen highlights, overlay of numbers on the runners (e.g., an image saying 1^{st}, 2^{nd} and 3^{rd} overlaying each of the runners wagered on in a trifecta, and any other visual indication of the actual runners that a wager has been placed. When an automatic select function has been made or elected, the ‘reels’ may spin until the decision is displayed. Also, the wheels spin while the system is having its wager entered into a parimutuel pool. Similarly, the winning runners or horses may be displayed on the same or separate ‘reels’ for comparison with the wager display or to follow the wager display. It is important to be able to provide in the practice of the invention to have a workable system, software, algorithm etc. to enable handicapping. The preferred system uses handicapping that incorporates tote odds, pool odds, HCW, odds dropping, standard handicapping functions and parameters, singly or in combination. The preferred method combines tote odds and HCW information.

In an embodiment of the invention, referring to FIG. 1, a wagering network, denoted generally as 100, is shown comprising at least one wagering terminal 120 and a race providing system 110 in communication with the at least one wagering terminal. In an embodiment, the communications connection or network between the race providing system and the at least one wagering terminal comprises a closed connection or network. However, the communications connection or network may instead comprise an open connection or network, such as the Internet, if the open connection or network has sufficient bandwidth for adequately servicing the at least one wagering terminal. Additionally, security safeguards such as signatures, user identification requirements, encryption of signals and trails, and the like are desirable attributes of various embodiments of the invention. Moreover, such a connection or network may be of any form including without limitation wire, cable or wireless or any further developed system. Each of these formats is merely a communication system for transmission of signals used in the practice of the invention.

The wager processor also does not send a specific bet type to the wager terminal machine if that specific bet type is not available and (with certain screening controls applied), if the top payouts of the relevant race are not available. A wager processor has the ability to not send an event with a certain field size to machines. For example, 5 horse fields are very unpopular since there are less handicapping angles and smaller betting pools.

The account processor 365 may be in communication with the card read/write device 310, the account buffer 350 and the wagering processor 360. The account processor 365 may be configured for crediting and debiting, in accordance with the amount wagered and the outcome of the elected race event, the balance of a user's account. For example, the account processor 365 may determine whether the user has introduced an electronic/magnetic-stripe card to the card read/write device 310, and then establish an account for the user in the account buffer 350. The balance of the user's account may be stored, for example, on the electronic/magnetic-stripe card which is introduced to the card read/write device 310. Information about the amount wagered and the outcome of the elected race event is supplied by the wagering processor 360. The account processor 365 may perform basic checks to ensure that the user's account has a credit, that the account has enough credit for the amount wagered and that the card is otherwise operating properly. Information regarding some or all of these checks may be communicated to the wagering processor 360 in order to allow the wagering processor 360 to submit a wager to the race providing system. In an embodiment, the account processor 365 may also be configured to request from the user an appropriate password or other identification information via the user interface 305 before establishing the account for the user in the account buffer 350. In an embodiment, the electronic/magnetic-stripe card is specially designed and configured for the at least one wagering terminal. As will be apparent to those skilled in the art, other types of cards may be used such as credit and debit cards.

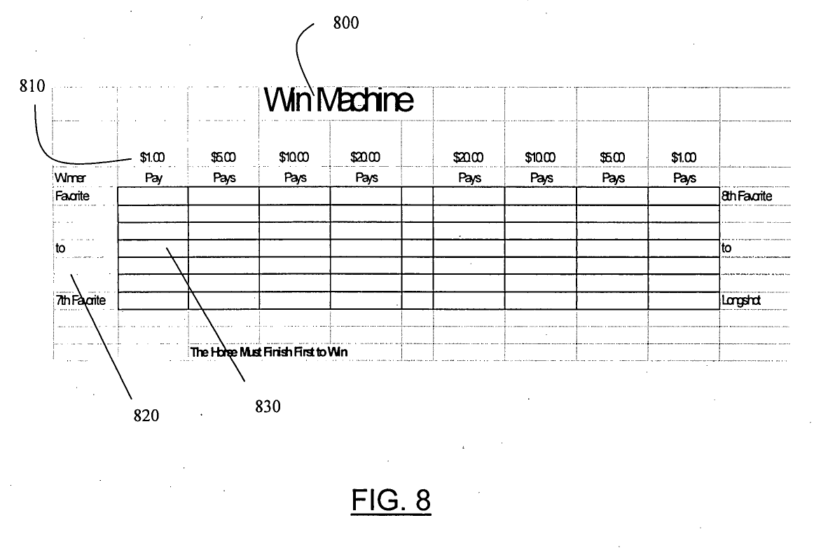

The wagering processor 360 may communicate with the quick pick race contestant(s) buffer 340, the racing information buffer 345 and the account processor 360. The wagering processor 360 may be configured to display the race contestants of the displayed race event using the odds information stored in the racing information buffer 345. In an embodiment, race contestants are shown as differing shaded/color icons on the display depending on the odds information associated with the race contestants. A color palette may be provided on the at least one wagering terminal to identify the colors associated with the race contestants, namely colors ranging from favorite to long-shot. In an embodiment, the color palette is provided physically on the glasswork of the housing of the at least one wagering terminal although as will be apparent to those skilled in the art, the color palette may also, for example, be provided on the display or as part of a payout table (as described in more detail below with respect to FIG. 8). For example, a horse icon for a favorite horse race contestant may be shown in blue while a horse icon for a lesser favorite horse race contestant may be shown in purple (see, e.g., the color chart 1000 of FIG. 10). In an embodiment of the at least one wagering terminal, each differing shaded/color icon is associated with a race contestant based on the win odds associated with the race contestant. If two race contestants have the same win odds, then the amount wagered on the race contestant in the win pool (if available) is used to select the favorite. Otherwise, whichever race contestant has the lower number assignment will be considered more favorite. In another embodiment of the at least one wagering terminal, each differing shaded/color icon is associated with a race contestant based on the amount wagered on the race contestant. As will be apparent to those skilled in the art, any number of means of assigning one or more colors reflecting odds associated with a race contestant may be used.

In an embodiment, a user may place wagers according to the user's risk profile by using handicapping information with odds shopping and using colors and other indicators to present choices according to the user's risk profile to the user. For example, different users may have different preferences and tolerances for risk/reward. Some users may favor long shots while other users may prefer wagering the favorites. So, in an embodiment, the user can indicate the user's risk/reward profile in setting up a wagering account or by indicating a desired risk/reward profile on a wagering screen of the at least one wagering terminal. For example, a button/icon on the at least one wagering terminal may allow the user to request race contestant wagering information according to a selected profile such as a long-shot profile or a favorites profile. More detailed profiles, as identified above, can also be inserted at the beginning of play or entered into a permanent player profile.

Handicapping information may be provided using gaming industry terminology and formats. For example, in at least one embodiment, handicapping information may be provided in accordance with the Running Style-Position (RS-Pos™) methodology available from Handicappers Data Warehouse (HDW), Inc. of Georgetown, Ky. The Running Style-Position methodology is a complete methodology that is designed to help users understand the race event (e.g., a horse race event) and may be used alone or to supplement another handicapping methodology. By assigning a descriptive label on each race contestant (e.g., horse), the similarities and differences between race contestants and the race events can be identified, thereby allowing the user to view the handicapping process from a new and different perspective. This method may involves two major components: determining projected “RS” (Running Style), and determining projected “Pos” (position).

The projected “RS” may be determined, for example, prior to the race event. The projected “RS” attempts to project how the race contestant can win the race event, while the actual running style, after the fact, may indicate how the race contestant actually ran the race event. For example, every paceline in the race contestant's past performance may have a projected “RS” and an actual running style. In an embodiment, multiple major categories of running styles may be used, including, but not limited to: “E” “EP”, “P”, “PS”, “S”, “SS”, and “U” as defined below in Table 1 for an actual winning “RS.”

TABLE 1

| Running | | |
|---|---|---|
| Style | Description | |
| E | Early | A win where the horse goes wire to wire |
| EP | Early | A win where the horse is within 1 length of the |
| | Presser | leader at the ¼ mile call |
| P | Presser | A win where the horse is within 1 length of the |
| | | leader at the ½ mile call |
| PS | Presser | A win where the horse is within 1 length of the |
| | Sustained | leader at the stretch call |
| S | Sustained | A win where the horse does not qualify for any of |
| | | the above but is never more than 7 lengths off the |
| | | pace or positioned farther back than seventh |
| SS | Slow | A win where the horse does not qualify for any of |
| | Sustained | the above, in other words, a deep closer |
| U | Unknown | The horse has not demonstrated it's running style |
| | (or Ugly) | yet |

Every race contestant's projected “RS” may be defined by the way the contestant has won recent race events. For example, the projected “RS” may consider the last three, last four or last five wins (any other number determined to be useful may also be used). According to this example, if a race contestant has won only as an “E” then that contestant may be projected as an “E”; if, however, the contestant has won as an “E” and an “EP” then that contestant may be projected as an “EP.” Furthermore, if the contestant has won as an “E”, “EP”, and “P” then that contestant may be projected as a “P”. In each case, the running style furthest off the pace when the race contestant has won with more than one running style may be selected. The RS-POS™ method of projection can be used as a powerful elimination tool, and may further include additional subcategories and subtleties beyond those described here. By defining the running styles of the race contestants, a picture of the race is will begin to evolve.

By way of example, an “E” race contestant is likely going to try to win wire to wire. A “PS” race contestant, on the other hand, may not get involved in the early going and will not put any pressure on the early pace. In fact, the “PS” race contestant may not get involved in the race until the stretch if he is to win. An “SS” race contestant may be at the back of the pack, won't put any pressure on any part of the race, and will win probably on the last stride. The “SS” race contestants typically do not win their fair share of race events. The specific definitions described above may provide an opportunity to predict a race contestant's chance of winning by only knowing the contestant's projected “RS”. For example, an “EP” race contestant that is slower than the “E” contestant in the race event has a reduced chance of running his best race. A “PS” race contestant, whose stretch pace ratings are inferior to all other contestants, cannot run his best race. A “P” race contestant that has never run a half-mile close to others in the race event has a small chance of running his best race. With a little bit of experience, a user can quickly review the RS-Pos™ reports and immediately see which race contestants have a good chance of winning, and which have little or no chance of winning.

The “Pos” portion of RS-Pos™ may be calculated by predicting how fast each race contestant can run based on, for example, the best time a contestant has actually run in the last 10 race events. A very high correlation between this ranking and finish position has been found in practice. Applying this, of the race contestants with the best times (e.g., “B1/4”) for each of the last 10 race events, the contestant that ranks first will win more race events than the contestant that ranks second, who will win more than the contestant that ranks third, who will win more than the contestant that ranks fourth, etc. The race contestant that ranks seventh will most likely be seventh at the first call and will most likely finish seventh. This fact gives us a powerful tool to use in handicapping.

Such RS-Pos™ information may be provided as raw speed information and need not be adjusted in any manner. Race contestants that can run fast have demonstrated that they can run fast. An error is to try to make some type of adjustment to the raw speed data. However, when a race contestant moves from a very fast track to a very slow track, the contestant slows down; however, not all contestants will slow down by the same amount. Conversely, to assume that race contestants speed up when moving from a slow track to a fast track can be incorrect, because not all contestants do. However, “E” race contestants may be more affected than “S” contestants. What is very difficult to determine with any accuracy is by now much.

By combining the two types of information, running style and position, the RS-Pos™ methodology may provide a descriptive label that uniquely identifies each contestant in a race event, for example: E1, P4, PS5, S7, EP2, SS13. Once these labels are applied, the understanding of each race event may be greatly improved, and the reasons why certain race contestants win or lose become much more evident. While the number of different race scenarios is still large, the user's understanding of the race event using the RS-POS™ methodology may provide the user with a significant edge. Some example applications are set forth as follows.

For example, a lone E1 race contestant with an inside post will get the lead 60% of the time and will win 50% of the time that he gets the lead. If that contestant has been in races in his recent past where he has been an E3 or E5 or not alone (not the only E), he can go wire to wire today at a big price. “P” race contestants tend to place more than they show, and very often a morning line favorite P5 or P6 will be the place contestant and not the win contestant. A P1 will run his best race when he is outside, ridden for example by a jockey that likes to track, and is behind an E1 and E2. An S7 can't win on his own the contestants in front of him have to go to fast and set the race up for him, and the S7 must have final times far superior to an EP1 in the same race event if he is expected to beat him. “S” race contestants may show more than they win and are key to playing trifectas. An E7 is more likely to run last than first, and at times are favored to win without any significant chance of doing so. In a horse racing example, “Cigar” was almost always a P2 or P3 in his races, but in the Breeder's Cup he was a P7 with “Alphabet Soup,” an EP1. Furthermore, in a horse racing context, the user may soon begin to notice that certain jockeys have strong preferences for a particular position that they would like to obtain, and will do fine if the horse happens to be capable of getting to that position, but fall otherwise. Horses will finish better when the jockey matches the horse's position or takes back from that position. However, horses perform worse when the jockey moves them forward of their preferred position. For example, a P4 will fare better from fourth position than from first. An EP6 doesn't fit the race. “E” horses tend to run first and third, “P” horses tend to run second, “S” horses tend to run third more than they win, etc. Horses that are first, second, and third at the 1 mile win about 60% of the races, and the running style position methodology readily identifies these horses to the user. Exemplary codes for use with the RS-Pos™ handicapping methodology are included in an Appendix to this specification, which Appendix is herein incorporated by reference as if set forth fully herein. With a risk/reward profile selected, handicapping data showing estimated probability of race contestants finishing in specific positions can be matched against current odds to find wagering opportunities where the user may have a positive return on investment. The determination of the profiled race contestant wagering information can be performed in the at least one wagering terminal or performed at the race providing system and then fed to the at least one wagering terminal. In an embodiment, different odds shopping algorithms may be employed and may be triggered to be used by a user.

The at least one wagering terminal may then present the profiled race contestant wagering information according to the user's profile to allow the user to choose a wager that fits the user's profile. In an embodiment, the user interface 305 can use color, position, symbols, flashing, etc. to present the profiled race contestant wagering information in order to allow the user to choose a wager that has been partially handicapped automatically by the system. For example, the horse head icons described in more detail below may be provided in different specific color or have another indicator to signify the preference of the race contestants according to the user profile. A chart may be provided on or near the at least one wagering terminal to instruct the user on the significance of the color or other indicator. In another embodiment, specific wagers, race contestant selections and/or wager amount may be presented to the user in accordance with the user's risk profile. For example, two particular horse head icons may be flashing on a wagering screen of the at least one wagering terminal with an indication to wager those race contestants in an exacta wager for a certain amount.

The wagering processor 360 may also be configured to display the potential estimated winning payout of a wager on one or more race contestants of a race event according to the wager type of or selected in the at least one wagering terminal. For example, a wagering terminal configured for or in which is selected, an exacta wager type may present on a display (see, e.g., the ticker-type display of FIG. 4 and associated description below) a combination of race contestants (such as horse 5 and horse 3) of the race event about which information is shown on the display (see, e.g., the CRT display of FIG. 4 and associated description below), that may yield a certain estimated winning payout (such as $10,000 if horse 5 and horse 3 finish in that order in first and second place). In an embodiment, the greatest potential estimated winning payout(s) (and associated race contestant(s) that need to be selected to win the estimated payout(s)) is displayed according to the wager type of or selected in the at least one wagering terminal and the race event displayed on the at least one wagering terminal. In another example, a wagering terminal (e.g., configured for or in which is selected a superfecta wheeler wager type) may present on a display (see, e.g., the ticker-type display of FIG. 4 and associated description below) the current pool total of the race event about which information is shown on the display (see, e.g., the CRT display of FIG. 4 and associated description below), such that perhaps a certain unique winning wager combination of the superfecta wager type may yield a payout of the pool (“jackpot”).

The wagering processor 360 may also be configured to receive wager information from the user interface 305 and for selecting one or more race contestants for the wager. For example, the wagering processor 360 may receive through the user interface 305 an instruction for a wager amount, for an elected race event, which is transmitted to the race providing system together with the elected race contestants once the user instructs through the user interface 305 the submission of the wager. In an embodiment, referring to FIGS. 4 and 5, the at least one wagering terminal has buttons corresponding to certain wager amounts and/or combinations which when engaged by the user instruct the wagering processor 360 the wager amount and/or combination and a play button which when engaged by the user instructs the wagering processor 360 to submit the wager. In an embodiment, the wagering processor 360 may employ a default wager amount and/or combination, e.g., the lowest wager amount and/or the quick pick race contestants, when it is not instructed the wager amount and/or combination through the user interface 305 but is instructed to submit the wager.

Through the user interface 305, the user also can manually select the one or more race contestants for a wager or select that a set of quick pick race contestant(s) as provided in the quick pick race contestant(s) buffer 340 is used for the wager. As discussed below, the one or more sets of quick pick race contestant(s) may be supplied in a substantially continuous fashion to the wagering processor 360 and/or as requested by the wagering processor 360 (typically via the quick pick race contestant(s) buffer 340). In an embodiment, the user can manually select one or more race contestants for a wager by touching a touch-sensitive screen of the display or may select a set of quick pick race contestant(s) by pressing the “Play” button of the at least one wagering terminal. In an embodiment, the wagering processor 360 may employ one or more race contestants from a set of quick pick race contestant(s) to complete a wager if all the necessary race contestants for the wager type have not been selected but the wagering processor is instructed nevertheless to submit the wager. In this fashion, the wager will comprise the race contestant(s) selected by the user and one or more race contestant(s) from the quick pick race contestant(s) needed to complete the wager of the applicable wager type.

The wagering processor 360 may also be configured to show on the display the race contestants (usually in symbolic form, rather than real images of the race contestants) that have been manually elected by the user or the race contestants in a set of quick pick race contestant(s). For example, in an embodiment, the user selection of a race contestant on a touch-sensitive display causes an icon corresponding to the race contestant to change in appearance to indicate the race contestant has been selected. Similarly, the icons of quick pick race contestant(s) may change in appearance to indicate their selection.

The wagering processor 360 may also be configured to receive information regarding the sufficiency of credit in a user's account from the account processor 360 and to provide the amount wagered and the outcome of the elected race event to the account processor 360 for crediting and/or debiting a user's account.

The wagering processor 360 may also be configured to provide a prize to a user upon the submission of a wager. For example, the submission of a wager may trigger, according to a prize selection algorithm, the provision of a prize to the user, for example, in the form of a credit of the user's account or a credit or other type of prize on a ticket provided from the ticket dispensing device. In an embodiment, the prize selection algorithm may simply be a random seed or else the prize selection algorithm may determine to provide a prize after every certain amount of wager submissions through the wagering terminal. In another embodiment, where the prize selection algorithm is implemented across the wagering system, the prize selection may determine to provide a prize to a particular wagering terminal after every certain amount of wager submissions through wagering terminals throughout the wagering system.

The wagering processor 360 may also be configured to select one or more race contestants, according the applicable wager type, which represent the least chosen one or more race contestants for the wager type, particularly the one or more race contestants for the wager type that will yield a payout of the entire pool. Such selected race contestant(s) may determined using the odds information and/or betting pool information or may be provided by the race providing system. In an embodiment, a button (titled, for example, “Jackpot” button) is provided to allow the automatic selection of such one or more race contestants for a wager.

In an embodiment, the wagering processor provides one or more bonus picks to provide additional ways for a user to win and win larger payouts. By tying into a “jackpot” or bonus pool in addition to the regular wagering of race events, new ways to win are provided to users. A bonus pick is a selection of a race contestant from the remaining race contestants in the race event not included in the user's wager or other bonus picks. In an embodiment, the selection of the race contestant is random. Alternatively, the selection may be performed according to an algorithm. A user wins a bonus prize if each of the bonus picks finishes in exact order following the finish of the user's chosen winning race contestants. For example, in the case of a win bet, the 1^{st} bonus pick horse must finish 2^{nd} if the chosen horse finishes st. Similarly, in the case of a place bet, the 1^{st} bonus pick horse must finish 3^{rd} if the chosen horse finishes 2^{nd}. Accordingly, the results for the whole field of race contestants for a race event (not just the 1^{st} 4 finishers) will usually need to be known to determine the payout for a winning bonus pick(s).

In an embodiment, the at least one wagering terminal or the race providing system may provide 1 to 4 bonus picks (or none at all). Where the at least one wagering terminal makes the bonus pick selection, the bonus picks are sent to the race providing system for record keeping in a database and to facilitate payout. If the race providing system makes the bonus pick selection, the bonus pick(s) are maintained in a database and a feed of the bonus picks is provided to the at least one wagering terminal by the race providing system. The number of bonus picks or whether bonus picks are offered at all can be configured in various ways. For example, the number of bonus picks selected may simply be random or may depend on the amount wagered, the specific configuration of the at least one wagering terminal, the wager type, or any other type of algorithm. If a bonus pick(s) is provided, it is typically added to every wager placed on the at least one wagering terminal.

The pool out of which the bonus prize(s) for a winning bonus pick(s) is paid out may be funded by a one or more of: 1) a set aside of a percentage of the wagering handle; 2) an additional contribution by the race event track(s); and/or 3) a wager surcharge. In an embodiment, the pool may be underwritten by an insurance policy to ensure the bonus prize(s) can be paid. As is apparent, the pool for the bonus prize(s) may be separate from the parimutuel pool typically used for race event wagers through the at least one wagering terminal. Optionally, the pool for the bonus prize(s) may be added to or be a part of the parimutuel pool.

The payout of the bonus prize for the winning bonus pick(s) may be determined by: 1) the size of the entire bonus pool; 2) the straight odds of winning the entirely random segment (bonus picks) of the wager; 3) the effective payout or odds of winning the user's wager (whether composed of actual user race contestant pick(s) and/or quick pick race contestant(s)); 4) an actuarial based approach to determine the bonus prize(s); or 5) a parimutuel approach with a jackpot and reserve similar to lottery systems.

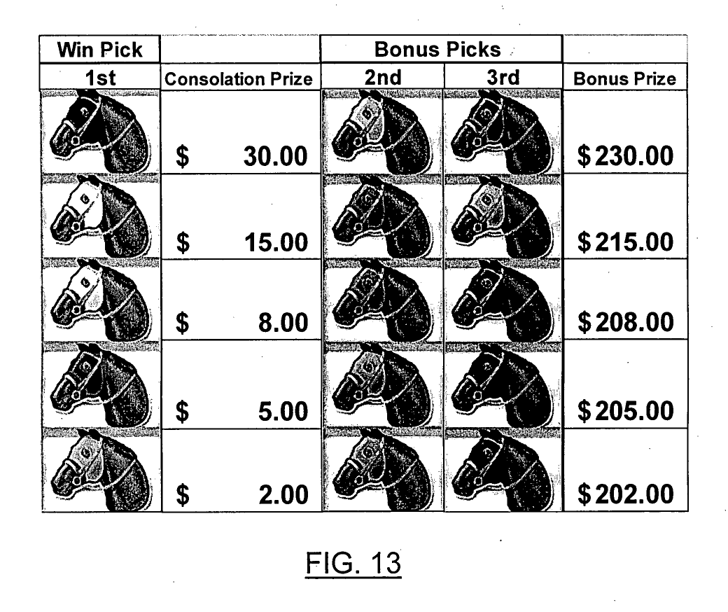

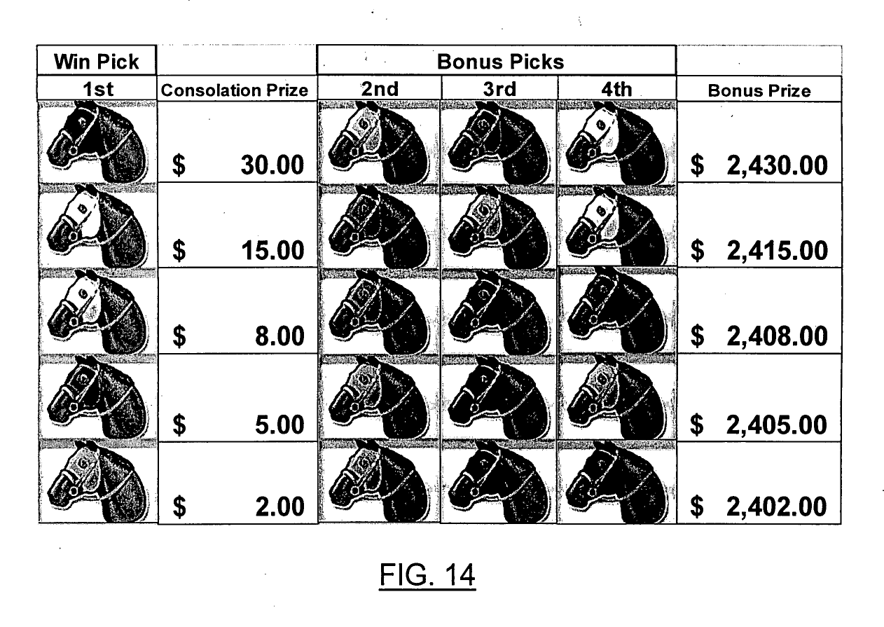

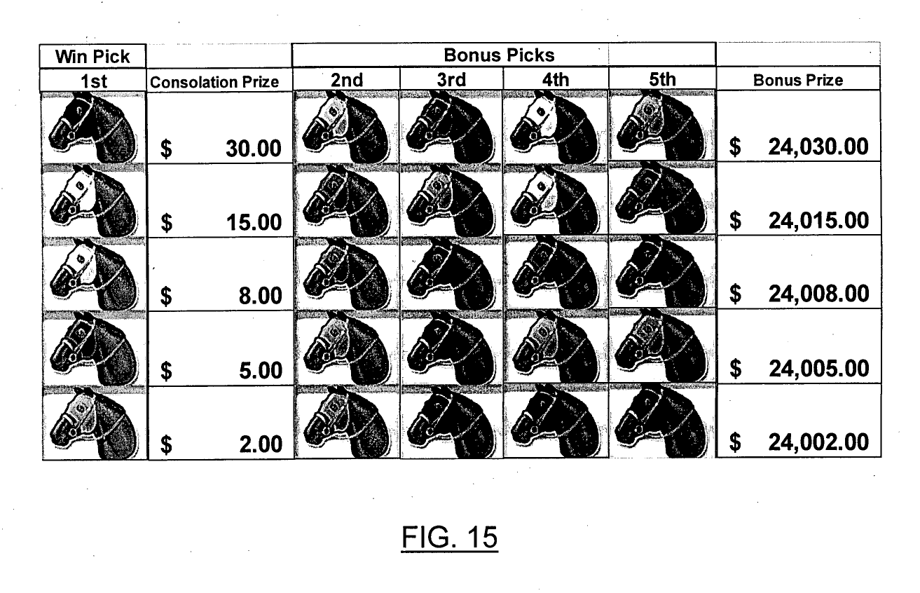

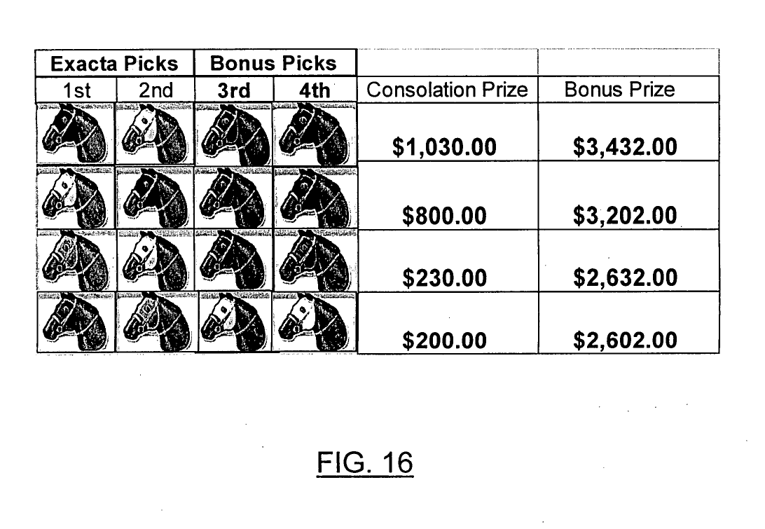

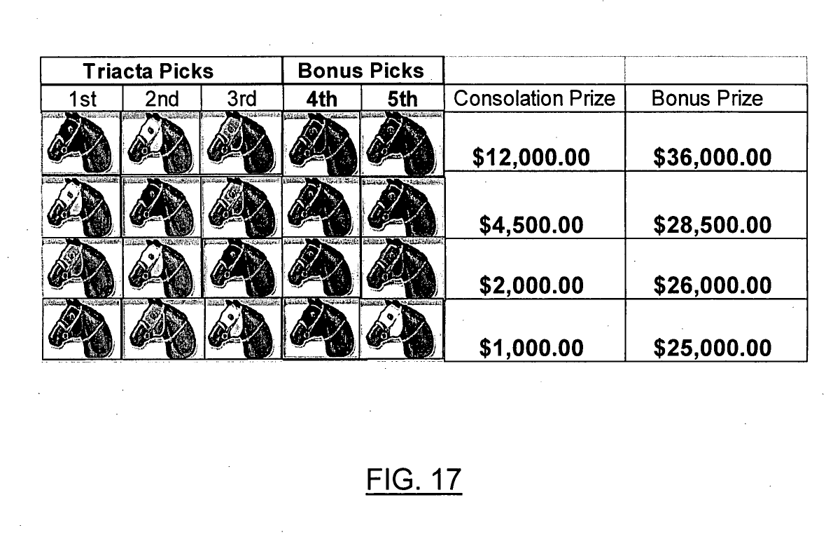

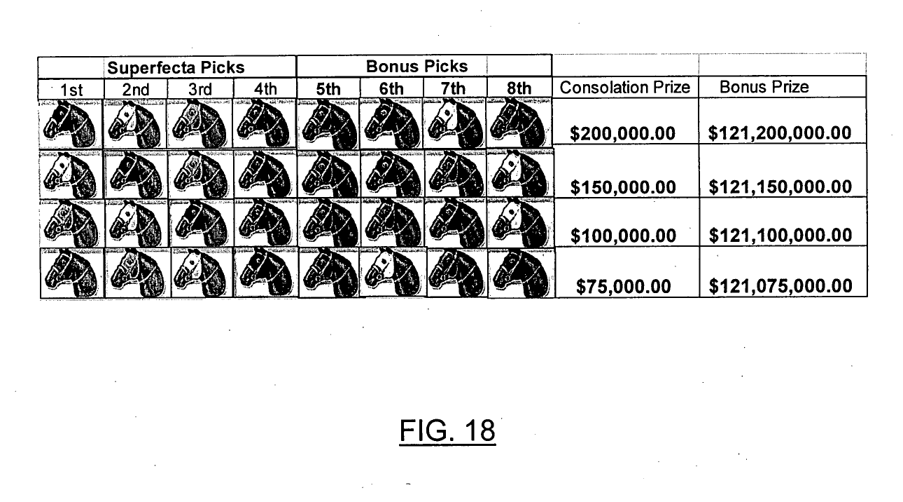

Referring to FIGS. 12 to 18, sample estimated payout tables for various wagers and an associated bonus pick(s) are shown. In an embodiment, the payout table(s) may be provided on the at least one wagering terminal, e.g., on the display of the at least one wagering terminal. FIG. 12 shows a sample estimated payout table for a win wager with one bonus pick. The “Consolation Prize” column lists the estimated payouts for the basic win wager for several race contestants shown in the column “Win Pick”. The “Bonus Prize” column lists the bonus prize for each race contestant shown in the “Win Pick” column if the corresponding bonus pick race contestant in the “Bonus Pick” column comes in 2nd place behind that race contestant shown in the “Win Pick” column. In this example, the bonus prize is the consolation prize plus 10% of the total odds (which in FIG. 12 amounts to $20). FIG. 13 shows a sample estimated payout table for a win wager with two bonus picks. As in FIG. 12, the “Consolation Prize” column may list the estimated payouts for the basic win wager for several race contestants shown in the column “Win Pick”. The “Bonus Prize” column may list the bonus prize for each race contestant shown in the “Win Pick” column if the corresponding bonus pick race contestants in the “Bonus Picks” column comes in 2^{nd} and 3^{rd} place behind that race contestant shown in the “Win Pick” column. In this example, the bonus prize is the consolation prize plus 10% of the total odds (which in FIG. 13 amounts to $200). FIG. 14 shows a sample estimated payout table for a win wager with three bonus picks. FIG. 15 shows a sample estimated payout table for a win wager with four bonus picks. FIG. 16 shows a sample estimated payout table for an exacta wager with two bonus picks. FIG. 17 shows a sample estimated payout table for a trifecta wager with two bonus picks. And, FIG. 18 shows a sample estimated payout table for a superfecta wager with four bonus picks.

In an embodiment, a separate (that is a distinct ticket, with wagering information on only the bonus event(s) in play, although a ticket may issue with an underlying wager information and the bonus free wager information) ticket may be issued incorporating the details of the user's wager and providing the bonus pick(s). Alternatively, the bonus pick(s) may be provided on the same ticket of the wager in association with which the bonus pick(s) are provided. In an embodiment, the ticket having the bonus pick(s) may be provided with a bar code to track and facilitate payout of the bonus prize(s) for a winning bonus pick(s).

In a variation (not shown), the user interface may include a reselect button for initiating reselection of the race contestants, and the wagering processor 360 may be configured to reinitiate selection of race contestants upon receipt of the reselection command from the user interface 305. In this variation, the wagering processor 360 may be configured to issue a command to the race providing system to provide a one or more new sets of quick pick race contestant(s) and then to select from the one or more new sets of quick pick race contestant(s) provided by the race providing system. In this manner, the wagering processor 360 typically selects different quick pick race contestant(s) for each actuation of the select button.

The details of the wagering process of an embodiment, as facilitated by the processing instructions of the wagering processor 360, are explained in greater detail below in regards to FIG. 7.

In an embodiment, a portable wagering terminal module may be provided with memory 355 to cooperate with the CPU 330 and network interface to support interoperability with various race providing systems. Race providing systems typically have proprietary protocols for communications of race information. Accordingly, to communicate with disparate race providing systems, the at least one wagering terminal may support a plug-in software module to provide the interface between the at least one wagering terminal and the race providing system(s) with which the at least one wagering terminal communicates. One side of the module defines an application programming interface based on the behaviors provided by and the requirements of the at least one wagering terminal. The other side of the module will provide serial and/or flexible networking services for the race providing system. A race providing system vendor (or other party) would be able to rapidly adapt existing terminal code to create a plug-in module for use in the at least one wagering terminal. The portable module will define means to specify the capabilities supported by the portable module and plug-in module(s). The at least one wagering terminal will query those capabilities and determine the best way to utilize the race providing system. Accordingly, the race providing system vendor will not need to disclose its protocol in detail and the at least one wagering terminal vendor will not have to share the wagering terminal design.

Turning now to FIG. 4, an embodiment of the at least one wagering terminal 120 is shown comprising a display 300 for presenting information about the selected race events, a user interface 305 for viewing race event information and placing wagers on an elected race event, a card read/write device 310 for receiving an electronic, optical or magnetic-stripe card encoded with a user's account information, a ticket dispensing device 315 for providing a ticket comprising wager information for an elected race event and a stand-up type housing 400 for retaining the display 300, the user interface 305, the card read/write device 310 and the ticket dispensing device 315. The wagering terminal 120 may also include a processor 320 (not shown) as discussed above for facilitating wagering on race events. The wagering terminal 120 may also include a speaker (not shown) for playing audio associated with the wagering and race events information.

Preferably, the at least one wagering terminal 120 according this embodiment may be configured for providing a wager in only a single wager type, and the housing 400 includes a wager description, prominently displayed on the housing 400, identifying the wager type using words which explain the wager type in simple betting terminology. For example, the at least one wagering terminal 120 may be configured to provide a win, place, show, win-place-show (a win, place and show bet on a particular race contestant), exacta, trifecta, superfecta, exacta and wheels, trifecta and wheels and superfecta and wheels wager type. Example wager descriptions include “Pick a Winner”, “Pick Two Exact Order”, and “Pick Three Exact Order”. In an embodiment, the wager type of the at least one wagering terminal 120 can be changed, for example, by manually configuring the at least one wagering terminal 120 from one wager type (e.g., exacta) to another wager type (e.g., place) or by issuing a configuration change command from the race providing system to the at least one wagering terminal 120 to cause the at least one wagering terminal to change from one wager type (e.g., exacta) to another wager type (e.g., place). Optionally, the configuration change command can be issued to the at least one wagering terminal 120 that in its current configuration is able to process a wager type that is not available for a next race event (about which information is made available for display and wagering on the at least one wagering terminal 120).

The display 300 may comprise a CRT display 410 for displaying information regarding the race events and ticker-tape type display 420 for displaying select wagering information regarding the race events. Preferably, the CRT display 410 comprises a touch-sensitive CRT display, including a touch-sensitive membrane (not shown) in communication with the processor for “scrolling” between next and previous race events and race event tracks and for manually selecting race contestants for an elected race event. As will be apparent to those skilled in the art, any appropriate type of display may be used.

The user interface 305 may comprise a series of wager buttons 430, 440 for accepting wagers in certain wager (e.g., dollar) amounts and/or combinations. For example, referring to FIG. 4, button 430 may be engaged for a $1 wager amount and button 440 may be engaged for a $5 wager amount. Although not shown in FIG. 4, the wager buttons may also represent certain wager combinations, e.g., exacta and 2 wheels (see, e.g., buttons/icons 1010 in FIG. 10). The user interface also includes a bet submission button 450 for initiating transmission of a wager to the race providing system.

Turning to FIG. 5, another embodiment of the at least one wagering terminal 120 is shown comprising a display 300 for presenting information about the selected race events, a user interface 305 for viewing race event information and placing wagers on an elected race event, a card read/write device 310 for receiving an electronic or magnetic-stripe card encoded with a user's account information, a ticket dispensing device 315 for providing a ticket comprising wager information for an elected race event and a table-top type housing 500 for retaining the display 300, the user interface 305, the card read/write device 310 and the ticket dispensing device 315. The wagering terminal 120 may also include a processor 320 (not shown) as discussed above for facilitating wagering on race events. The wagering terminal may also include a speaker (not shown) for playing audio associated with the wagering and race events information.

The display may comprise a CRT display 510 (or any other visual display, including but not limited to LED, liquid crystal, plasma display, flat screen, reflection system, backlit system, or the like) for displaying information regarding the race events and preferably, the CRT display 510 comprises a touch-sensitive CRT display, including a touch-sensitive membrane (not shown) in communication with the processor for selecting the desired wager type, for selecting the desired wager amount, for “scrolling” between next and previous race events and/or next and previous race event tracks, for manually selecting race contestants for an elected race event and for initiating transmission of a wager to the race providing system. As will be apparent to those skilled in the art, any appropriate type of display may be used.

Preferably, the at least one wagering terminal 120 according to this embodiment is configured for providing a wager in a plurality of wager types, although as will be apparent it may be configured for a single wager type. Information presented on the display 300 will facilitate easy selection of the wager type. For example, each time the user touches a portion of a touch-sensitive screen of the display 300 associated with a button/icon to change the wager type of the at least one wagering terminal 120, the user scrolls through the various wager types offered by the at least one wagering terminal 120. Each time the user scrolls through the wager types offered by the at least one wagering terminal 120, the information regarding race events is presented according to the selected wager type. Alternatively, for example, the selection of the wager type may be performed by selecting a desired wager type in a menu presented on the display or by selection of icons corresponding to specific wager types offered by the at least one wagering terminal 120.

It should be understood that the configurations shown in FIGS. 4 and 5 are only an implementation for an at least one wagering terminal 120, and that other configurations are also envisaged. In a variation, not shown, the user interface includes a plurality of wager type buttons, each identifying a respective wager type (e.g., win, place, show, exacta, etc.), for facilitating placement of the wager according to one of a plurality of wager types.

In an embodiment of the at least one wagering terminal 120 for a trifecta wager type or the at least one wagering terminal 120 capable of selection of a trifecta wager type, a button and/or display icon may be provided for placing a $1 trifecta wager amount for the three selected race contestants in the exact order as selected and another button and/or display icon may be provided for placing six $1 trifecta wager amounts on the three selected race contestants in any order. Similarly, in an embodiment of the at least one wagering terminal 120 for a superfecta wager type or the at least one wagering terminal capable of selection of a superfecta wager type, a button and/or display icon may be provided for placing a $1 superfecta wager amount for the four selected race contestants in the exact order as selected and another button and/or display icon may be provided for placing 24 $1 superfecta wager amounts on the four selected race contestants in any order.

In an embodiment of the at least one wagering terminal 120 for an exacta and wheel wager type or the at least one wagering terminal 120 capable of selection of an exacta and wheel wager type and referring to FIG. 10, a number of buttons and/or display icons 1010 may be provided for placing various combinations and amounts of wagers according to this wager type. For example, there may be provided a button and/or display icon for placing a $1 exacta wager amount for the two selected race contestants in the exact order as selected, a button and/or display icon for placing two $1 exacta wager amounts on the two selected race contestants in any order, a button and/or display icon for placing a $5 exacta wager amount for the two selected race contestants in the exact order as selected, a button and/or display icon for placing two $5 exacta wager amounts on the two selected race contestants in any order, a button and/or display icon for placing a $10 exacta wager amount for the two selected race contestants in the exact order as selected, and buttons and/or display icons each for placing X (where X is greater than or equal to two) number of $1 exacta and wheel wager amounts on the one selected exacta race contestant and the X selected wheel race contestants selected.

In an embodiment, the parimutuel wagering terminal configurations shown in FIGS. 4 and 5 may be constructed using gaming cabinets, peripherals, operating systems and software that are certified for use in a slot machine application. By using slot machine equipment, the wagering terminal has a greater resale value by providing a larger market and range of applications in which the equipment can be used, allows the wagering terminal 120 to provide features requiring a greater level of security, e.g., cash handling, and gives regulators, users, tracks and other stakeholders a greater sense of confidence in the wagering terminal 120 because it is wholly or partially certified by a set of rigorous and mature standards compared with those of the parimutuel industry. Further, using slot machine equipment allows the at least one wagering terminal 120 to additionally offer slot or other casino-type gaming if the at least one wagering terminal 120 is properly configured with appropriate hardware and software.

In an embodiment, a virtual private network (VPN) concentrator may be provided to streamline performance of one or more wagering terminals and other devices. The deployment of a wagering terminal(s), signup kiosk(s), telephones and network connected handheld computing devices into a facility can pose a variety of challenges for security, reliability, and scalability. For example, wagering terminals streaming audio/video from an Internet source should not have to retrieve multiple copies of the data stream, but rather should share a single copy within the facility. Wagering terminals and other devices should not require wiring and configuration changes depending upon the type of network access. Wagering terminals and other devices should be “plug and play” and require only physical wiring for power. Telephones and network connected handheld computing devices used to support staff at the facility should not depend on or assume infrastructure capabilities of the facility itself. Accordingly, there is provided a concentrator device to streamline provisioning and to provide a simple, efficient, reliable and secure means for installing the above mentioned terminals and devices in a facility.

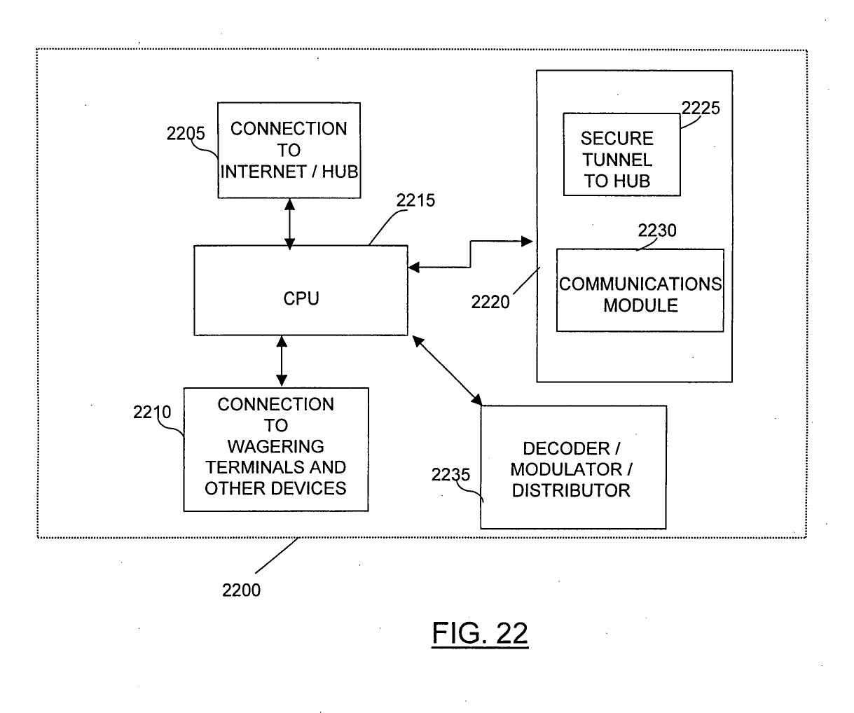

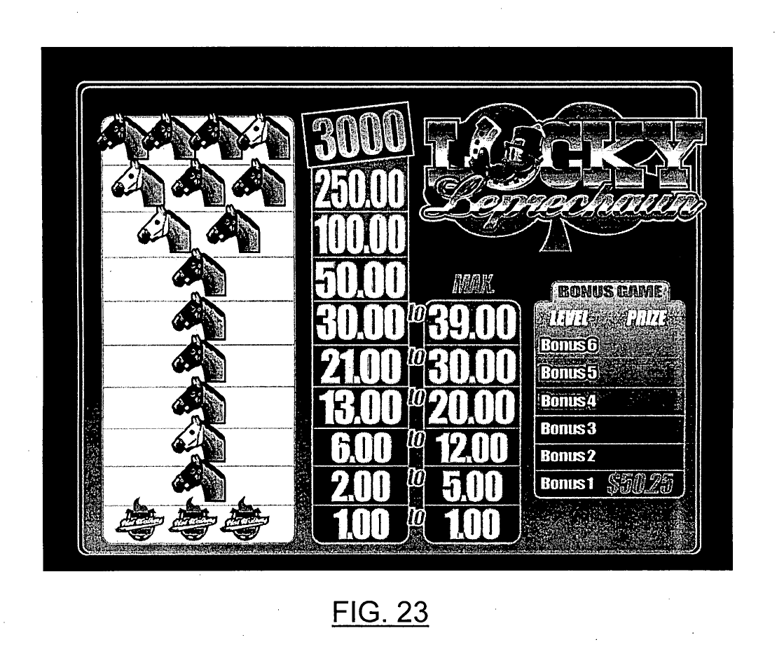

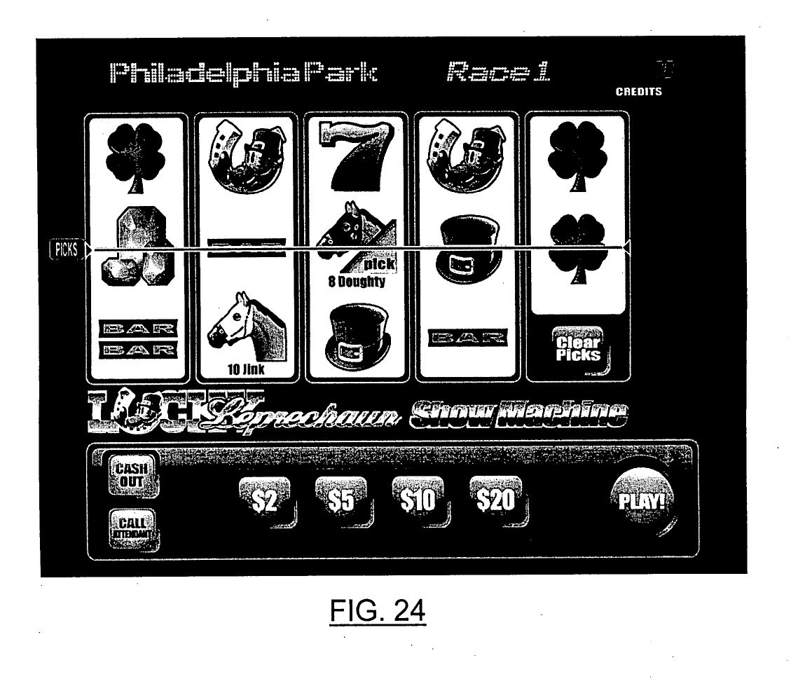

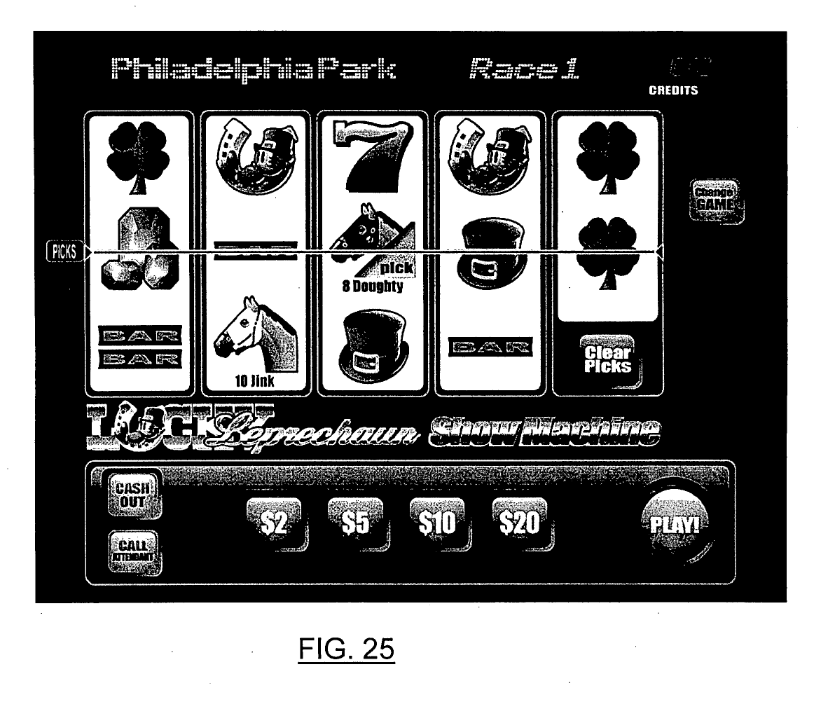

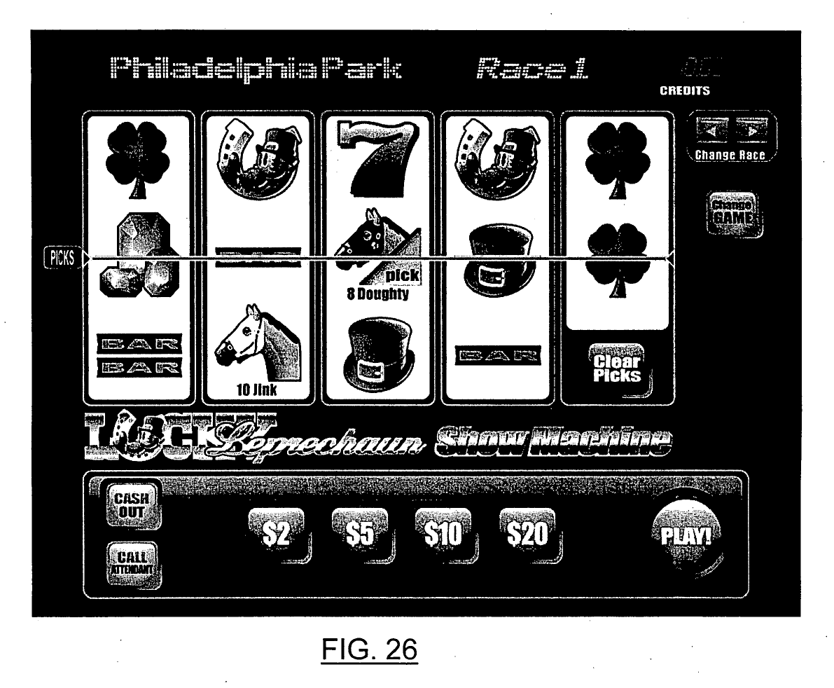

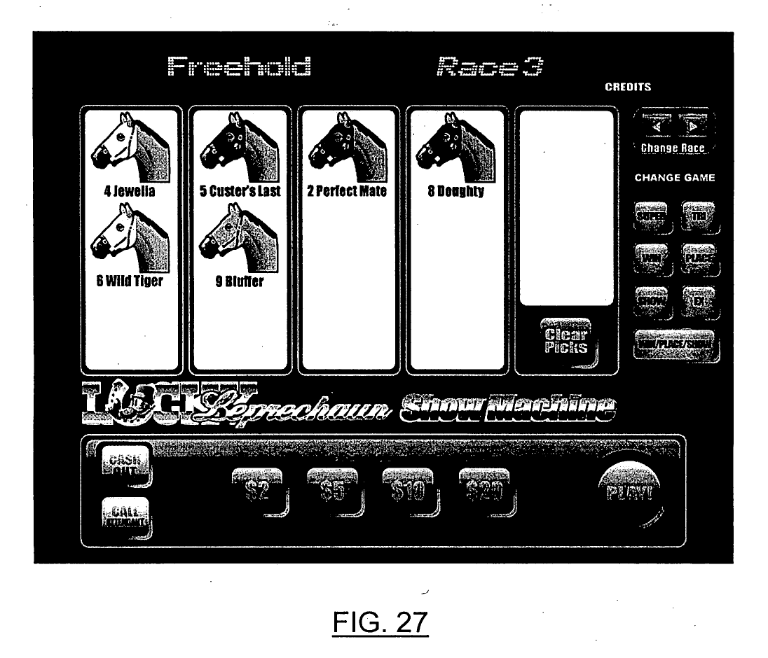

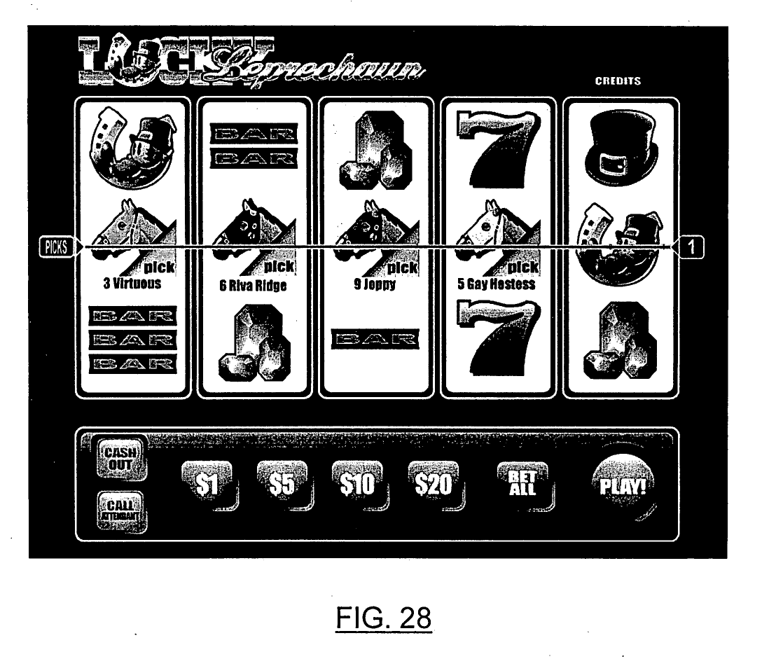

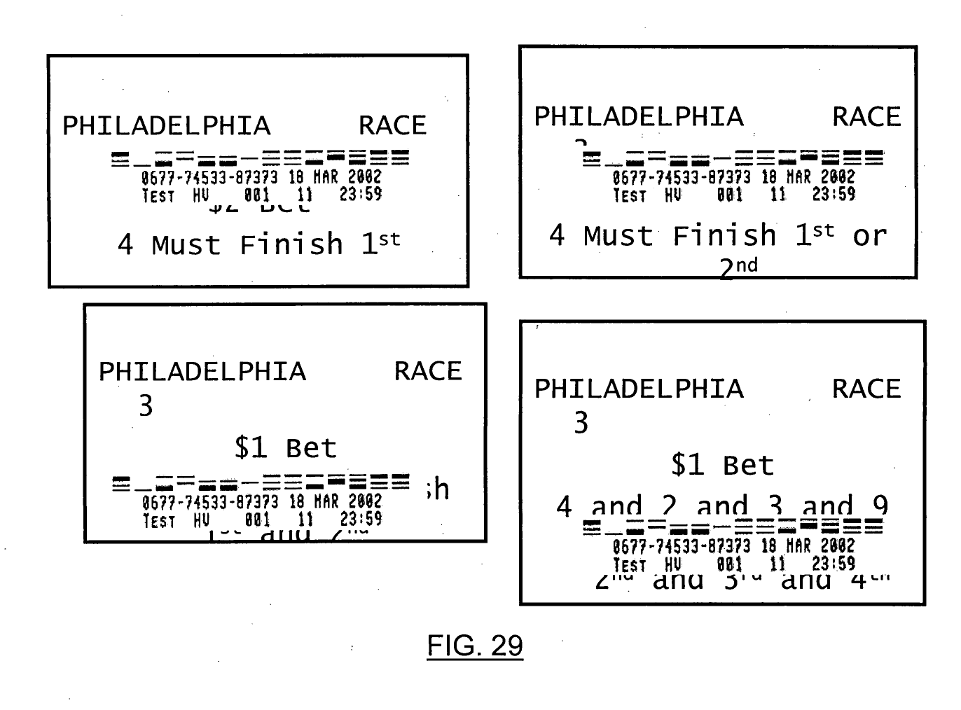

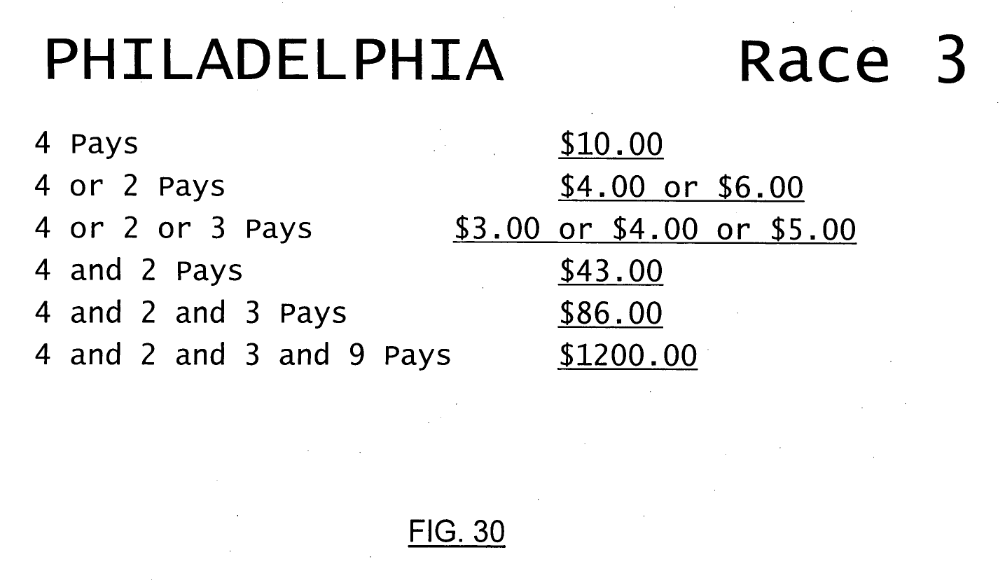

The VPN concentrator may include hardware/software to provide VPN Internet connectivity to facilities, particularly facilities currently served by hardwired wagering devices. Referring to FIG. 22, the VPN concentrator 2200 may include a hardware device and software modules that provide: 1) a secure tunnel 2225 (via IPSec or similar means) between the wagering terminals and other devices and a hub, such as the account wagering clearing service described above; 2) a wired or wireless connection 2210 for the wagering terminals and other devices to connect to the VPN concentrator; 3) a wired or wireless connection 2205 for the VPN concentrator to connect to the Internet and/or the hub; and 4) a software module 2230 to facilitate structured communications between the wagering terminal and other devices and the hub. The VPN concentrator may further comprise a central processing unit 2215 communicating with the various connections. Further, the VPN concentrator may also comprise a memory 2220 that communicates with the CPU and comprises the secure tunnel software and the software module to facilitate structured communications.

Thus, the VPN concentrator 2200 may provide at least one or more of the following functions: 1) a wireless networking access point for wagering terminals, signup kiosks and handheld computing devices; 2) a wireless telephony access point for telephones used at the facility in relation to the wagering terminals; 3) a decoder 2235 to downlink satellite signals for race event audio/video; 4) a gateway to WAN networking services, i.e. CSAT, cable, DSL, etc. available through the hub; 5) a RF modulator 2235 to pipe downlink audio/video onto facility cable TV wiring; and 6) a distributor 2235 for streaming audio/video to allow one copy of an audio/video stream to be shared by the wagering terminals and other devices at the facility.

In another variation, the at least one wagering terminal may be a personal computer or a handheld device with all wagering functions provided on the display of the personal computer or handheld device for selection by use of a pointing device and/or designated keys on a keyboard associated with the personal computer or handheld device. In this variation, an electronic wager ticket mechanism may be provided in place of a physical wager ticket dispensing device. The electronic wager ticket mechanism would generate an electronic representation of the wager ticket that may be presented, for example, graphically on the display of the at least one wagering terminal. Further in this variation, a user may provide the relevant account information to the at least one wagering terminal instead of introducing an electronic or magnetic-stripe card to a card read/write device. For example, the user may manually enter the account information or employ any other electronic wallet or other automatic means for making the account information available to the wagering system. Many other variations of the wagering terminal will be apparent to those of ordinary skill in the art.

Turning to FIG. 6, an embodiment of a screen shown on a CRT display of a stand-up type at least one wagering terminal is depicted. The screen depicts information regarding Race 1 at the Los Angeles horse race track. More particularly, race event track information 600 (“Los Angeles”) and the race event number information 605 (“Race 1”) are shown. The screen also depicts account balance information 610 regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers.

Further, a number of horse head shaped icons, such as horse head icon 615, associated with the race contestants of the depicted race event are shown. Moreover, the race contestant start position information, such as race contestant start position information 620 (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant may change appearance to indicate the race contestant has been selected. For example, a pick number 625 may be presented on the display to indicate the selection of the race contestant and, where applicable, the race contestant's order in selection of a set of race contestants. In an embodiment, the user can clear the selected race contestant(s) using a “Clear Picks” button/icon 630 in order to re-select one or more race contestants, as applicable, for a wager.

Further, the user may “scroll” through future race events at different race event tracks by touching the next 635 and previous 640 track buttons/icons, each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next 645 and previous 650 race buttons/icons, each touch of the icons causing the wagering processor to present, as applicable, updated information on the display corresponding to the “previous” or “next” race event by start time.

Turning to FIG. 7, an embodiment of a screen shown on a CRT display of a tabletop type at least one wagering terminal is depicted. The screen depicts information regarding Race 1 at the Los Angeles horse race track. More particularly, race event track information 700 (“Los Angeles”) and the race event number information 705 (“Race 1”) are shown. The screen also depicts account balance information 715 regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers. Further, in an embodiment, a ticker-tape type display 710 for displaying select wagering information regarding the race events, such as potential payouts for selected race event contestants for the current wager type depicted on the screen, is provided.

Further, a number of horse head shaped icons, such as horse head icon 720, associated with the race contestants of the depicted race event are shown. Moreover, the race contestant start position information, such as race contestant start position information 725 (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant changes appearance to indicate the race contestant has been selected. For example, a pick number (not shown in FIG. 7) may be presented on the display to indicate the selection of the race contestant and, where applicable, the race contestant's order in selection of a set of race contestants. In an embodiment, the user can clear the selected race contestant(s) using a “Clear Picks” button/icon 730 in order to re-select one or more race contestants, as applicable, for a wager.

Further, the user may “scroll” through future race events at different race event tracks by touching the next and previous track buttons/icons (not shown), each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next 735 and previous 740 race buttons/icons, each touch of the icons causing the wagering processor to present, as applicable, updated information on the display corresponding to the “previous” or “next” race event by start time.

As discussed above, in the tabletop type wagering terminal, the wager type presented on the display can be changed by the user by touching the “Change Game” button/icon 745. So, by using the “Change Game” button/icon, the user may change the display to present a “Win” wager type as shown in FIG. 7 or scroll to any other wager type such as place, exacta, superfecta, etc. wager types offered by the at least one wagering terminal. For the “Win” wager type, for example, the screen comprises additional buttons/icons 750 corresponding to the win wager type of the at least one wagering terminal to allow the user to select the wager amount (“$1”, “$5”, “$10”, “$20” buttons/icons) and to initiate the wager (“Play” button/icon). For other wager types, different additional buttons/icons may be provided as required by the particular wager type selected. As will be apparent to those skilled in the art, the wager type change feature may also be provided in the standup or any other type of display for the at least one wagering terminal.

A variation of the screen of FIG. 7 may also be used for a personal computer or handheld device variation of the at least one wagering terminal. In this variation, the screen of FIG. 7 or another screen could provide the ability for a user to enter account information (as discussed above) through, for example, the touching of a button/icon that initiates an account information entry dialog.

Further, audio and/or video content related to the race event displayed on the at least one wagering terminal may be provided to a user of the at least one wagering terminal. In an embodiment, the screen of FIG. 7 or another screen could permit the user to view race event video corresponding to the race event displayed on the at least one wagering terminal and a speaker of the at least one wagering terminal can provide the race event call for the race event displayed on the at least one wagering terminal. So, for example, as the race event displayed on the at least one wagering terminal changes, the race event audio and/or video would change to correspond to the displayed race event. Symbolic races scenes, using the color scheme of the odds and payouts, could be used to provide a simulated race event, with data from the wagering source and/or race track fed to the terminal or a central distributor at intervals to provide a continuous stream or segemented stream (e.g., at each eighth mile) simulated event image. In an embodiment, a separate display may be provided on the at least one wagering terminal for the race event video display. In a further embodiment, separate devices, such as televisions, monitors and speakers, may be provided in association with the at least one wagering terminal, which devices present the audio and/or video for the race event displayed on the at least one wagering terminal. The audio and/or video may be provided, for example, in a feed from the race providing system or from a cable or satellite system.

In an embodiment, the race event audio and/or video may be presented when the wagering closes on a next race event displayed on the at least one wagering terminal. So, for example, the wagering screens are presented on the at least one wagering terminal until the wagering closes for the next race event. When the wagering closes, the display of the at least one wagering terminal may be replaced with the video display of the next race event or race event information (or a portion of the wagering screen or another display associated with the at least one wagering terminal includes the video of the next race event) and the audio of the race is played over the speaker of the at least one wagering terminal. When the race event is over, the whole wagering screen may be once again presented for wagering on a next race event. Such a sequence may repeat while the at least one wagering terminal is in operation. In an embodiment, the audio and/or video of the next race event may be presented while simultaneously the wagering screen of the at least one wagering terminal is available to the user.

In an embodiment, the determination of the presentation of the audio and/or video is made based upon the feed from the race providing system indicating that the wagering on the next race event is closed. The race video and audio is then presented for as long as the last race event wagered upon is taking place. If no wager had been placed on that race event, the apparatus could and should shift to the next available race event and ignore the event on which no wager was placed. The time for the race event is determined, for example, by estimating the run time of the race event and adding extra time for delayed starts and slow race events. The time for the race event may also be determined through the feed from the race providing system or other system indicating the race event finish, e.g., the unofficial results.

In an embodiment, audio and/or video for a race event may only be presented when a user has wagered on that race event. In another variation, a user may override the audio and/or video presentation or just the video presentation in order to access the wagering screen. The race event audio and/or video may also only be displayed on or in association with specific wagering terminals, such as terminals where a user has wagered on that race event. Further, the user may selectively request presentation of the audio and/or video through for example a “View Race” button/icon instead of having the audio and/or video automatically provided. Optionally, tape delay or other buffers may be used to present the audio and/or video of a next race event in case of scheduling conflicts/overlaps with a next following race or where the user overrides the audio and/or video presentation. Previously run race events may also be presented where there is a long time gap between next race events. Thus, a scheduling algorithm manages the presentation of the audio and/or video of next race events so as to maximize wagering, such as selecting between the presentation of conflicting or overlapping race events by, for example, picking randomly, choosing the next race event at a preferred race event track or picking the race event with the largest handle.

Also, the screen of FIG. 7 or another screen could provide the display of information regarding electronic wager tickets (as discussed above) corresponding to wagers placed by the user of the at least one wagering terminal. For example, representations of unofficial electronic wager tickets corresponding to user wagers can be displayed at the bottom of the screen of FIG. 7 to show the outstanding user wagers. As the user's wagers become official, the representations of those unofficial electronic wager tickets could drop off the display at the bottom of the screen of FIG. 7. Further, a monitor bets button/icon may be provided on the screen of FIG. 7 which allows the user to review the details of all unofficial and official electronic wager tickets.

Referring to FIG. 8, a payout table is depicted for a “Win” wager type of an at least one wagering terminal. The payout table includes a title 800 generally describing the wager type, such as the win wager type in FIG. 8, of the payout information included in the table. More particularly, the payout table includes columns 810 indicating the wager amount placed for a particular wager type, e.g., $1 placed on a win wager. The payout table further includes rows 820 indicating race contestants, e.g., identifying information for each race contestant or combinations of race contestants, such as the post position or name(s) and, if applicable, the corresponding icon color (as described above), ranked from favorite to longshot. The payout table then further includes information for each row-column combination 830 indicating the actual or potential payout for the wager represented by the row and column information according to the wager type of the payout table. So, for example, the intersection in the payout table of FIG. 8 of the $1 wager amount column and the favorite race contestant would provide information for the actual or potential payout of that wager. In an embodiment, the payout table may be an electronic display that provides updated payout information depending on race event and/or wager type presented on the display of the at least one wagering terminal. Alternatively, where possible, the payout table may be simply a printed table of actual or potential payout information. As will be apparent to those skilled in the art, payout tables may be provided for wager types other than the win wager type.

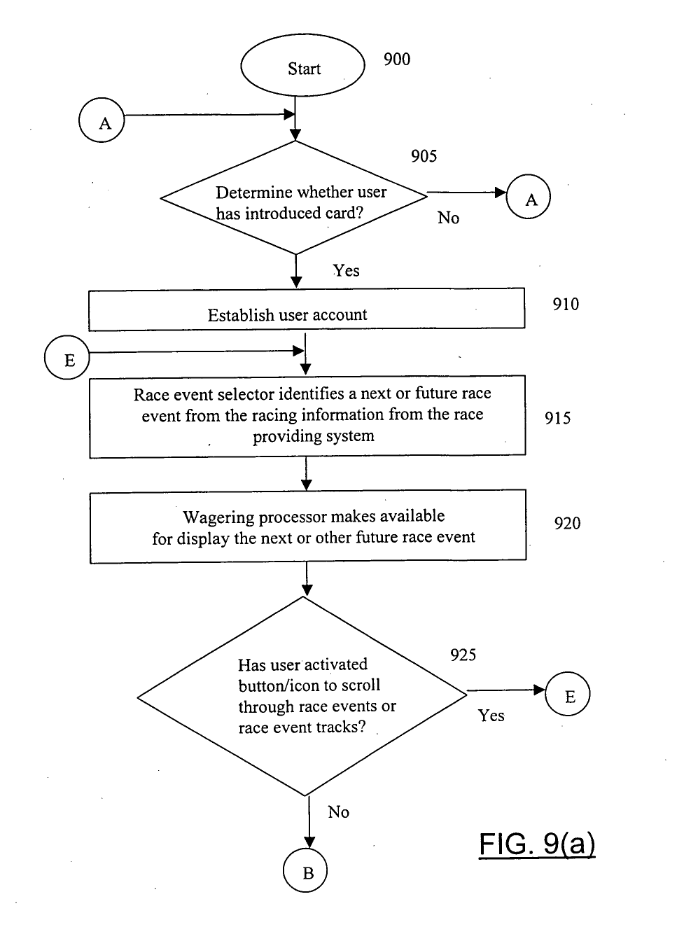

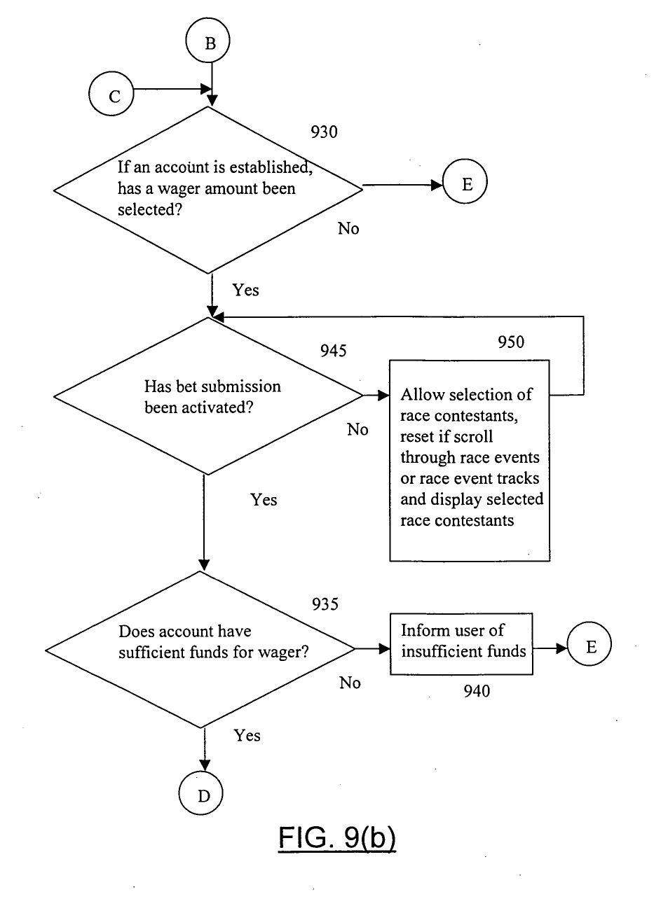

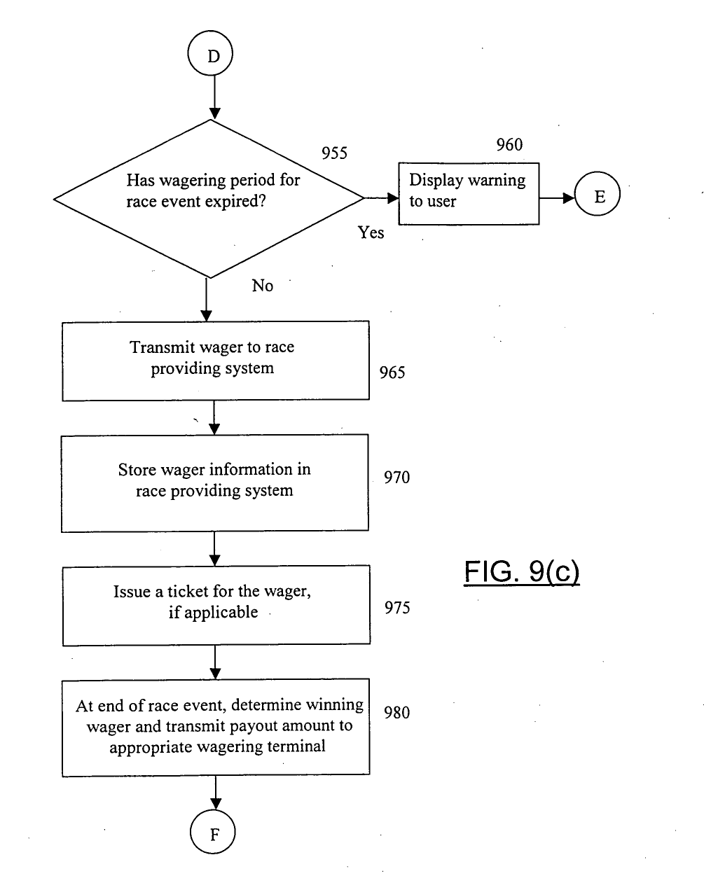

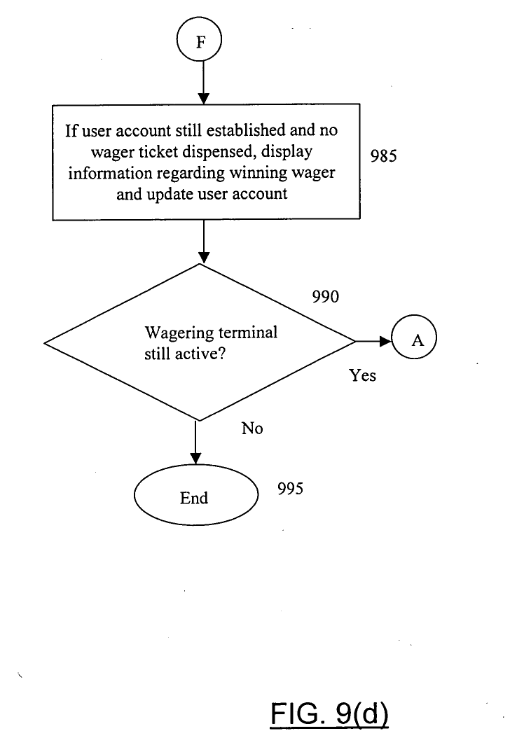

Referring to FIG. 9, the wagering facilitated according to an embodiment of the invention will be described. In this embodiment, the at least one wagering terminal may be configured to provide a single wager type (although it may be reconfigured to a different wager type by a configuration change command). Where the at least one wagering terminal provides multiple wager types, the wagering facilitated by the wagering system according to that embodiment would query the user to select a particular wager type (not shown in FIG. 9) but would then operate according to the wagering described below in reference to FIG. 9. For example, the user interface may include a plurality of wager type buttons to allow the user to select a desired one of the wager types.

The account processor may determine whether the user has introduced an electronic/magnetic-stripe card 905 to the card read/write device and if so, establishes an account 910 for the user in the account buffer if there is a credit in the account sufficient for the lowest wager amount available on the at least one wagering terminal and the card is otherwise operating properly. If the user has not introduced an electronic/magnetic-stripe card to the card read/write device, the account processor may keep determining whether a card has been introduced and the user will be unable to submit a wager or scroll through race events, e.g., the user interface is inactive, until a card is introduced. Optionally, the account processor may make available for display a warning to the user if the card is not operating properly, the user's account does not exist or there is an insufficient credit in the account. In an embodiment (not shown in FIG. 9), the account processor of the at least one wagering terminal is configured to request from the user an appropriate password or other identification information via the user interface before establishing the account for the user in the account buffer. In an embodiment (not shown in FIG. 9), a user may scroll through race events without having to introduce an electronic/magnetic-strip card to the card read/write device. In an embodiment (not shown in FIG. 9), only the buttons/icons corresponding to wager amounts and combinations available for wagering in view of the balance available in the user's account and the particular race event displayed will be active. For example, available wager amount and combination buttons/icons are lighted or shown when the user has a sufficient balance for those wager amounts and/or the wager combination is possible at the displayed race event. Similarly, the inactive wager amount and combination buttons/icons are dark or not shown when the user has an insufficient balance for those wager amounts and/or the wager combination is not possible at the displayed race event.

Once a card is introduced, the race event selector of the at least one wagering terminal may query the racing information received from the race providing system, and identifies 915 a next and other future race events, as described in more detail above, for display on the at least one wagering terminal via the wagering processor. At the outset and as the wagering pools associated with displayed race events close, the race event selector may identify a next race event for display on the at least one wagering terminal. As a user scrolls through race events by, for example, next or previous race event and/or race event track selection commands, the race event selector may identify other future race events for display on the at least one wagering terminal.

Thus, in an embodiment, a next race event is displayed on the at least one wagering terminal at the outset when a user introduces a card to the at least one wagering terminal. Thereafter, the user may scroll through race events and race events tracks but when the pool closes for a displayed race event, a further next race may be displayed on the at least one wagering terminal. In essence, the race providing system provides a substantially continuous stream of racing information to the at least one wagering terminal in order to provide a substantially continuous display of information regarding a succession of race events. Further, the race providing system may also provide one or more sets of quick pick race contestant(s) as other information pertaining to the racing information in a substantially continuous fashion to the at least one wagering terminal and/or as requested by the at least one wagering terminal. Optionally, the at least one wagering terminal may receive a configuration change command to change the wager type assigned to the at least one wagering terminal.

The wagering processor may make available for display 920 the information regarding the next and other future race event, particularly the race event track name and race event number, as identified or supplied by the race event selector. Particularly, the wagering processor may make available for display, as identified or supplied by the race event selector, next race events upon the introduction of a card to the at least one wagering terminal or as the pool for a displayed race event closes and next and other future race events scrolled through by the use of next and previous race events and race event tracks selection commands.

The wagering processor may further make available for display a number of icons corresponding to the race contestants in the displayed race event, including icons of varying shade/color to identify the different odds information associated with each race contestant. The wagering processor may use, for example, the odds information in the racing information buffer to assign varying shades/colors to the icons associated with each race contestant of the displayed race event.

The wagering processor may also determine 925 whether the user has activated a button/icon to scroll through race events and/or race event tracks i.e. the “Next Race”, “Previous Race”, “Next Track” or “Previous Track” buttons/icons. If so, the race event selector may determine a next or other future race event for display and the wagering processor may make available for display information regarding the user elected next or other future race event, determined by the race event selector, resulting from the scrolling.

If an account is established, the wagering processor may query 930 whether a wager amount has been selected (for example, via selection of one of the wager buttons). If not, the at least one wagering terminal may continue to determine next and/or other future race events for display, display information regarding such race events, and present on the display information regarding elected next or other future race events resulting from the scrolling through race events and/or race event tracks. In an embodiment (not shown in FIG. 9), the wagering processor may employ a default wager amount, e.g., the lowest wager amount, when bet submission has been activated but no wager amount has been selected.

If a wager amount has been selected, the wagering processor may wait for one or more race contestants to be selected by awaiting 935 the activation of the bet submission button i.e. the “Play” button. For example, the race contestant(s) may be manually selected 940 via touching a portion of a touch-sensitive screen of the display associated with the icon(s) of the selected race contestants (and then hits the “Play” button to submit the wager). If the user hits the “Play” button without selecting race contestants or only a partial number of the needed race contestants (not shown), the wagering processor may query the quick pick race contestant(s) buffer to derive a suitable set of quick pick race contestant(s) to complete the wager (as discussed in more detail above), in accordance with the wager type assigned to the at least one wagering terminal. If the user at any point touches a “Next Race”, “Previous Race”, etc. button/icon, the wagering is reset and the account processor waits for a new wager.

In a variation not shown in FIG. 9, the user interface may include a select button for initiating selection of the race contestants. Accordingly, in this variation, the user places a wager by selecting one of the wager amount buttons. The user can then manually select one or more race contestant(s) according to the wager type or activate a select button causing the wagering processor to query the quick pick race contestant(s) buffer and display a set of quick pick race contestant(s) in accordance with the wager type by, for example, changing the appearance of the icon(s) associated with those race contestant(s). If the selected race contestants are deemed by the user to be unacceptable, the user can manually select new race contestant(s) or re-activate the select button, causing the wagering processor to obtain and display a set of quick pick race contestant(s), in accordance with the wager type, picked using an alternate algorithm for selecting quick pick race contestant(s). Once the race contestants are deemed by the user to be acceptable, the user may complete the wager by activating the bet submission button i.e. touching the “Play” button. As will be apparent, error checking loops may be employed with related dialogues for display to the user. It is to be noted that even with the handicapping be automatic as an available component of the system, the ‘reselect’ function is expected to provide a different selection than the first selection. This can be implemented in a number of ways. The reselect can delete the last selection as an option, the nature of the wager form (win, place or show, etc.) can be altered, the player profile adjusted or reconsidered to provide additional input, and the fact that the handicapping system may be implemented in a manner where there are a variety of selections that may be appropriate according to the handicapping system, and these various selections may be randomly selected from upon the initial selection and the activation of the reselect mode.

If the selected race contestant(s) were picked manually by the user, the wagering processor may then present 950 the manually selected race contestant(s) on the display by, for example, changing the appearance of the icon(s) associated with those race contestant(s) (for example, as described above in more detail). If the selected race contestant(s) are deemed by the user to be unacceptable, the user can override the selection by, for example, touching a button or a portion of a touch-sensitive screen of the display associated with an icon for resetting the manually selected race contestant(s) so a new set of selected race contestant(s) can be manually chosen or a set of quick pick race contestant(s) can be chosen by pressing the “Play” button. Alternatively, the user can continue to pick race contestants until too many race contestants have been chosen at which point the selection of race contestants is reset so a new set of selected race contestant(s) can be manually chosen or a set of quick pick race contestant(s) can be chosen by pressing the “Play” button. If the user at any point touches a “Next Race”, “Previous Race”, etc. button/icon the wagering is reset 950 and the account processor waits for a new wager. If the manually selected race contestant(s) are deemed by the user to be acceptable, the user completes the wager by activation of the bet submission button i.e. the “Play” button. As will be apparent, error checking loops may be employed with related dialogues for display to the user.

Once the bet submission has been activated, the account processor may query 945 the account buffer to determine whether there are sufficient funds in the user's account for the wager. If the account processor determines that the account does not have sufficient funds for the wager, the wagering processor is informed 950 of the insufficient funds and the wagering processor may present a message on the display indicating that the user has an insufficient credit balance for the wager. The account processor may then check for next race events, as applicable, and waits for a new wager.

In an embodiment, once the bet submission has been activated, the screen of the display of the at least one wagering terminal shows a spinning reel animation (e.g., like a slot style wheel) with sound effects until the wager ticket is printed or displayed. During the animation, the wager may be processed including the selection of one or more race contestants as the bonus pick(s) and, where applicable, one or more quick pick race contestants. The spinning wheel represents that the wager is being processed. When the animation is finished, the screen will pause to show the race contestant(s) selected for the wager centered on the middle of the screen. The race contestant(s) are re-organized from betting number (numerical) order to ordering the user's picks and bonus picks in numerical order starting from the center row (“pay line”). After the pause, the screen will revert back to where another wager may be placed. This screen shows for the first time the race contestant(s) chosen as the bonus pick(s) as well as, where applicable, the quick pick race contestant(s) for the wager.

If the account processor determines that the account does have sufficient funds for the wager, the wagering processor may then determine 955 whether the wagering period has expired for the race event upon which the wager has been placed, that is, if the race event has started or the ability to wager on the race event has been closed. If the wagering processor determines that the wagering period has expired, the at least one wagering terminal may present 960 on the display a warning to the user to indicate that the wagering period has expired, continue to determine next and future race events for display, display information regarding such race events, etc. As will be apparent, since the race providing system continuously updates the at least one wagering terminal with information on the future race events, shortly after a wagering period expires the at least one wagering terminal will display information about a next race event.

If the wagering processor determines that the wagering period has not expired, the wagering processor may transmit the wager amount 965 and the selected race contestant(s) to the race providing system. The race providing system stores the wager information 970 in the wager database, together with the network address of the at least one wagering terminal. The race providing system continues to receive wagers until the end of the wagering period of a race event. The wagering terminal may also issue a ticket 975 corresponding to the wager, which can be used to obtain a payout for a winning wager via an automatic device and/or a clerk. The delivery of a ticket may be initiated by the activation of the bet submission button i.e. the “Play” button and/or by a separate button/icon activated by the user to request the printing of a ticket.

In an embodiment, at the end of a race event, the wager processor of the race providing system may query the wager database 980 to identify the winning wagers, calculates the payout payable to each user in accordance with the amount wagered (and either the payout odds if the wager was a fixed odds wager, or the size of the parimutuel pool if the wager was a parimutuel wager), and then transmits to each winning wagering terminal (using the network address stored in the wager database) a data packet indicating the payout amount.

Upon receipt of the winning contestant data packet, if the user's account is still established in the at least one wagering terminal and a ticket with respect to the winning wager has not been dispensed, the at least one wagering terminal may present on the display 985 information regarding a winning payout. Upon receipt of the payout data packet and if the user's account is still established in the at least one wagering terminal, the account processor may update the user's account including, if appropriate, updating the account information on an electronic/magnetic-stripe card. The user can then place a wager on the next race event, or else discontinue wagering by closing the user's account on the at least one wagering terminal by, for example, disengaging the electronic/magnetic-stripe card from the card read/write device. If the wagering terminal is still active 990, the wagering terminal may determine whether a user has introduced a card, identify future race events, etc.

In an embodiment, winning users of the wagering terminal may be announced and a results board of winning users is provided. To protect the privacy of users, a key phrase may be provided, for example, on tickets so that wagering account holder names and winning amounts are not disclosed to the public.

To generate excitement, a wagering terminal may ring its bell or provide some other audio signal depending on a) the number of winning tickets played on that terminal and/or b) the amount of money won on that terminal. The audio signal may occur at the completion of each race.

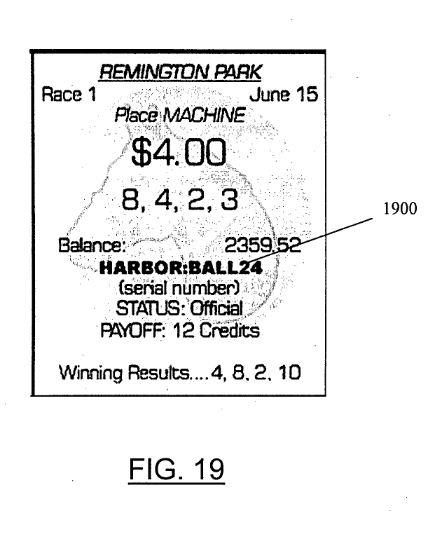

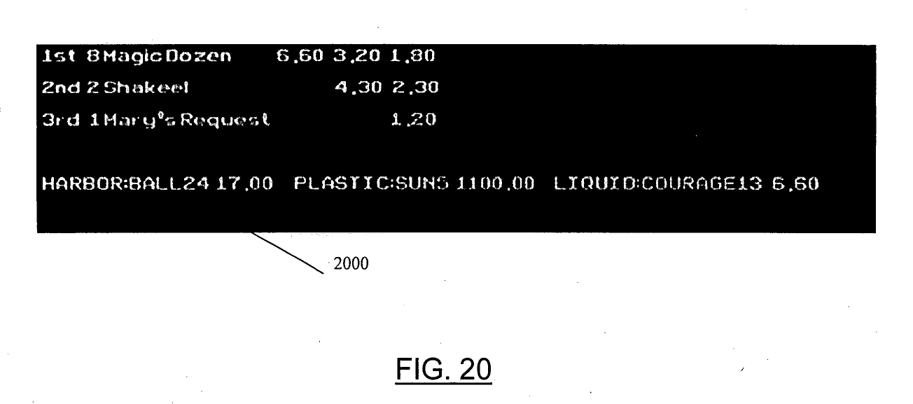

Further, the results of one or more races may be displayed on a results board provided on the at least one wagering terminal or provided separately with the at least one wagering terminal. Flashing lights, scrolling, sound and colors can be used to attract attention to the results board. The results board may display individual winners along with the amount won through a code name. Each ticket provided by the at least one wagering terminal may include a code name corresponding to the particular wager placed by a user. The code name protects the identity of the user but allows for the identification of the winning amount through a public display board and may enable the money to be directed to and directly deposited into an account. In an embodiment, the code name may be simply a concatenation of a randomly selected word (or combination of randomly selected words) followed by a 2 digit number. For example, referring to FIGS. 19 and 20, a user makes a $4 place wager on at least one wagering terminal. Referring to FIG. 19, the user's ticket prints the code name “HARBOR:BALL24” 1900 on the ticket. More secure code names based on random number generation, encoding sequences, bar codes, and the like may alternatively provided. In this example, the race is run and the user's wager is a winner. Referring to FIG. 20, the results board will either flash or scroll the code names and winning amounts for all winning tickets such as “HARBOR:BALL24 $17.00” 2000. The code name associated with each ticket may be stored in a database. After the race runs, the database may be used to determine approximate winning amounts and to display them on the board. The database may be stored on the machine or concentrator in volatile memory and is reset if a machine is power cycled. The amount shown is an approximate amount and not exact due to various differences in the calculation of winnings across jurisdictions. When the player inserts their wagering card, the balance will “ring-up” their last known credit balance up to their current balance if they won.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the invention is not limiting of the invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the invention described herein; the operations are machine operations. Useful machines for performing the operations of the invention include general purpose digital computers, special purpose computers or similar devices.

Each operation of the method may be executed on any general computer, such as a mainframe computer, personal computer or the like and pursuant to one or more, or a part of one or more, program modules or objects generated from any programming language, such as C++, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a processor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or the operations described herein without departing from the spirit of the invention. For instance, in certain cases, the operations may be performed in differing order, or operations may be added, deleted or modified.

An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD−RW, CD+RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

On conventional wagering machines, a player must choose a track code, then a race number, then an amount or denomination for that respective track code and race number. For example, a user engages the machine in selecting AP (Arlington Park), Race 3 for the wager to be placed. However, choosing a denomination requires a bet type and the denomination or wager amount. For a bet type that involves two or more race contestants, the process may require mathematical factorial considerations. For example, if one were to place a wager such as a superfecta that keyed race contestant number 5 and then wheeled race contestants number 2, number 6, and number 9, the bettor would have to do the factorial math in order to arrive at a denomination amount or wager amount for the respective wager Key 5, wheel 2, 6, 9 which cost $6 (3×2×1=6) for $1 wagers on each combination. Therefore, it would be advantageous to have a wager amount/bet type selector that performs these calculations for the race providing system and the user interface to save time. A wager amount/bet type selector, according to the present invention, combines bet type and dollar amount. By having a wager amount/bet type selector, fewer tickets will be cancelled by the player since the player is not “surprised” at how much the wager will cost. For example, the difference between 3 wheels and 4 wheels is $18. (3 wheels =−$6, 4 wheels=$24=24-6=18) and the difference between 4 wheels and 5 wheels is $96 (5×4×3×2×1=12 and 4×3×2×1=24=120-24=96) Notice how 1 wheel can make a difference of $96 in this type of situation causing the bettor to cancel a ticket with a clerk manually or start the whole process over again by hitting “Cancel Wager” on the user interface, which increases bet process time for the player and the other players waiting to use the machine and the respective players may be “shut out” of the race due to the race “going off” and pool closings.

A conventional wagering machine allows a player to select a dollar amount (for example $2) and then a bet type, for example, an exacta wager, and then a bet type within a bet type (for example key-wheel and wheel) where race contestants are chosen simultaneously or interchangeably between the key function and the wheel function. Another way to do this on a conventional wager machine would be to choose an amount, then a bet type then a bet type within a bet type (box) and choose the race contestants by a random numbered quick pick that has no algorithm or handicapping formula. Rather than doing these conventional steps as mentioned above, it is an optional aspect of the invention to provide a wager amount/bet type within a bet type selector that enables the player to select a bet type (for example exacta) then a dollar amount (for example $2), then the wager amount. A bet type selector according to the invention chooses the bet type with the bet type selector and the race contestants via a handicapping formula. Whether the dollar amount is chosen first or the bet type is chosen first is irrelevant in regards to conventional wagering or in an embodiment of this invention. Having a wager amount bet type within a bet type selector is advantageous to the player for two reasons:

1) It eliminates the number of steps or expedites the wagering process since a bettor does not have to understand specific betting terminology such as key, wheel, box or wheel-all. The player also does not have to choose race contestants either simultaneously or interchangeably between the key, wheel, box or wheel-all functions.

2) The second advantage is that if the player has a choice between two bet types within a bet type such as key 1^{st}, key 2^{nd} or 2 exact order or wheel 1, wheel 2, or 2 any order, the handicapping formula will make this decision by an algorithm that combines a third party vendor (for example HDW) and a race providing system. For example if the handicapping formula says that horse number 1 will run a PSR (projected speed rating) of 80 and horse number 2 will run a PSR of 70, this indicates a 10 point different and the odds are about 30 to 1. Then the algorithm will make an economic, handicapped race contestant decision to process the wager key number 1 for 1^{st} and key number 2 for 2^{nd} since the wheel number 1 and wheel number 2 only pays $10. By way of example, this wager does not make wagering sense since the 1 horse will most likely beat the number two horse and the results would pay $20 more to key the number 1 horse for 1^{st} and the number 2 horse for 2^{nd}.Quick Pick Rotator Summary. In small countries or small parimutuel betting market countries where there is not much live racing and not a significant number of simulcasts, it would be beneficial to have non-commingled pools using a quick pick rotator making sure that each bet type pool is balanced. As long as a pool is balanced in regards to amounts wagered on each race contestant, even though the pool may be small, the payouts will be economically enticing. For example, if you had a $10 pool where there were 10 race contestants where there was $1 wagered on each respective race contestant, the winning wager would pay $8. (10−$2 takeout=$8[8 to 1 payoff]). Now, consider the situation where there is a $100,000 pool where there is 60,000 bet on #2 and 10,000 on #1 and 15,000 on #3 and 5,000 on #4 and 5,000 on race contestant #5. If horse #2 wins, the winning wager only pays (100,000-20,000 takeout=80,000÷60,000) 1.30 to $1 wagered. Notice that even though the betting pool was larger in the second example (100,000) versus first example ($10), the first example paid 8 to 1 versus 1.30 to 1 in the second example. This is because the quick pick rotator “flattened” or “evened” or “smoothed” the pool by assigning the same dollar amount to each respective race contestant. Since the wagering terminal keyboard or betting user interface icons only contain small denominations (for example $1, $2, $5) it is easy to smooth pools. For example, player #1 chose $1 play and is assigned race contestant #1. Player #2 chooses the $2 denomination and the quick pick rotator assigns to player #2 horse #2. Player #3 comes along and chooses a denomination of $2 just like player #2 and the quick pick rotator assigns player #3, race contestant #3. Therefore, we have $1 on race contestant #1, $2 on race contestant #2 and $2 on race contestant #3.

If there are only 3 race contestants in the win bet type pool, when player #4 arrives and chooses $1 denomination, that player #4 will be assigned, via the quick pick rotator, horse #1 to even out or smooth the win bet type pool. Now, there will be equal dollars on each race contestant providing each player the same odds and payoffs. The quick pick rotator prevents the racetrack management from having minus pools. Minus pools can cause a track to lose money on a bet type pool or make no money on a break-even on a bet type pool. If a player wagers $100,000 in a $1,000 pool, there are state regulations that require the player be paid a minimum of 10% profit on any winning wager. This even includes show bet types that where the pool must be divided three ways. In the scenario just previously mentioned the track would have to forfeits $9,000 of a $10,000 betting commission to pay the player 10,000 on a 100,000 wager. (1,000 pool+9,000 commission forfeit=10,000 payoff). It would be ideal to a user interface that contains small denominations or keyboard buttons that have small denominations to be supplemented by a quick pick rotator in order to prevent “lop-sided” or unbalanced pools where the track is in danger of losing commissions due to state laws on minimum payoff and the player receives very uneconomical returns for his $2 wager where the bettor only receives 10 cents profit due to a large bettor destroying his wager with one minute to post time. The small bettor's wager is destroyed because the large bettor and the small bettor chose the same race contestant.

Also in small countries where there is very little live racing to supplement the simulcast menu or very little simulcasting due to U.S. tax laws such as IRS withholding tax, foreign countries cannot commingle betting pools between two countries because IRS agents cannot claim taxes in Mexico for example. In Mexico, there is only one live racetrack running and U.S. simulcast racing there must be separate pools since the IRS will not let the Mexican players, for example, commingle with U.S. live pools due to IRS withholding tax on foreigners. The only way for a foreign country to bet into large American live pools is to have a tax treaty with the U.S. regarding this issue. Therefore, it would be ideal to have separate betting pools for each U.S. track and using the quick pick rotator to make sure the betting pools are balanced so the bettors are left with economical payoffs and racetrack management is not responsible for minus pools. With the quick pick rotator functioning in separate non-commingled pools, the player can play thousands of races in a small foreign betting market. This reduces dead time between races and increases total handle for racetrack management since there is a direct correlation between the amount of races carried that day to total handle wagered that day. The correlation is the more races offered the more handle is generated for the racetrack due to less “dead time” between races which enables the player to bet more races in a shorter time frame.

Summary of Quick Pick Wager Amounts Rotator and Separate Betting Pools. There are jurisdictions where separate pools are required due to laws that forbid commingling of international wagering pools mainly for tax purposes. This is because a commingled pool requires that the tax laws and takeout be the same as the host track that is hosting the wager. For example, if Mexico wanted to commingle wagers with a Canadian pool, the Mexican track would have to adopt the Canadian parimutuel regulations regarding what bet types are allowed at what minimum wager amount. (Many jurisdictions require $2 minimum for win, place, show bet types and $1 for exacta, triactor, superfecta). For example, for years there was no superfecta wagering in Canada, therefore a Mexican track could not commingle a superfecta wager into a Canadian on track betting pool. Also, communication costs are very expensive. For example, for Mexico to commingle with Canada, since it is far away, there may not be enough bandwidth to accommodate wagers that require speed to enter the host pool with only one minute or less to post. Communication costs for commingled pools is very expensive due to fact that superfecta wager may have 24024 different combos in a 12 horse field with each combo containing 32 bits of synchronous or asynchronous data (24024×32=748,768 bites). Since the average takeout of every betting dollar is 20% (10% to horsemen for race purses and 10% to track management) whereby only 7% only goes to track management since another 3% is deducted for a commingling fee and broadcast fee to the track. The host track also sends a satellite feed to a non-host track that wants to commingle wagering pools so the fans in the building can see the race at the non-host track or non-host off-track betting location (O.T.B.). However, the costs of uplinking the satellite fee is absorbed in the 3% charge which is called a simulcast export fee or broadcast fee by the host track. One can view a simulcast export fee as a “broadcast” fee just as the major broadcast networks do business.

Now that we have mentioned above how the business, regulatory, technological framework of simulcast works it would be beneficial to have a self-sufficient, self-contained, non-commingled, statewide only or national only network so that a racetrack at off-track betting shops in these statewide or national parimutuel network would not have to adopt other state or other national parimutuel betting regulations to commingle. Also in the self-contained network there would be no need to convert different currencies to commingle wagers (such as U.S. dollars in Canadian dollars in order to commingle into a Canadian host pool). Also the network costs would be drastically reduced due to only on-site communications or communications that only involved an inter-state hub where only O.T.B.'s or racetracks of that country or state were connected unlike a worldwide simulcast network that involves “double bouncing” of satellite feeds between three continents or an “intra” state hub (a hub that connects several states) which is larger than a state only hub. Intrastate hubs are usually on a GAN network whereas an interstate hub is usually on a MAN network. Another benefit of having your own network is that you can have fractional betting which is very attractive in more economically depressed regions in the world or where the monetary value of the currency is less. For example, it is very expensive for a Mexican to wager $2 U.S. or Canadian into these countries respective pools in order to commingle since the countries require a $2 minimum to commingle win, place, show bet types. By having a 1 Peso wager it would enable a greater market to play the machines or betting terminals rather than $2 U.S. minimum denomination which is roughly 20 pesos which is out of reach or too expensive for low income players. 5 cent slot machines or 25 cent slot machines are very popular and cater to a different market that would otherwise not play or wager. However, the downside of non-commingled separate pools is that they tend to be very small because they only cater to one regional or national or even one local site such as a racetrack that has no phone wagering or off track betting thereby have very little distribution. With very small pools a large bettor could cause a “minus” pool. For example, a bettor wagering 100,000 dollars into a 10,000 pool will cause a minus pool when the takeout is factored in. It is unlikely that a bettor want to invest so much in a small pool because many state regulations require a minimum 5% or 10% payout which is more money than what you get leaving your money in the bank for the day. Also in a five horse field, the chosen race contestant must only beat two horses to get 3rd place in a show bet. Many race contestants in these situations are only entered for 4^{th} or 5^{th} money and really don't “belong” in the race, they are there only for a guaranteed paycheck since most races pay up to 5^{th} place. The issue becomes how to prevent the huge professional bettors (whales) from destroying the betting pool. (It is not fun making a wager on a race contestant that is at 4 to 1 at post time and when the gates open it is 1 to 9 thereby only paying 5 cents on a $2 bet to return $2.05. The solution is to use a quick pick rotator to even out the wagering dollars on each of the race contestants in conjunction with a keyboard or button panel or user interface denomination icons that are only available in small amounts. For example, in an embodiment where only $1, $2, $5 denominations. If a player wants to place a large bet such as $1,000 via the $5 button he will receive (1,000÷5=200) 200 different wagers on different race contestants. For example, in a 10 horse field, this large bettor will receive 20 $5 bets on each race contestant. 20×$5=$100×10 different horses=1,000 total dollars wagered) thereby neutralizing this large bettor which could otherwise created a minus pool or make the win bet. For example, only paying 10 cents on a $2 wager takes the “fun” or economic reasons for playing away. Also, with a quick pick rotator less confident or new players will play because the rotations in the processor or in the software are not revealed to the respective players. Therefore, depending on the rotation, the best handicapper may get the worst horse and the worst handicapper may get the best horse or horse with the statistically best chance because the horse which the player is about to receive is not revealed on the user interface until the bet enters the pool or a ticket is printed. By having separate pools, racetrack management does not have to know the world-wide state regulations for commingling with various jurisdictions which reduce legal costs for the racetrack since they (racetrack management) only have to abide by their own state regulations since the separate pools are only hosted in that respective state or country. It is very confusing for the player to have many different takeout rates associated with each state or country. For example, in Arizona the win/place/show takeout is 28% and in New York the win/place/show takeout rate is 15%. However, these takeout rates are not blatantly advertised because it is not the most attractive thing to have a 28% takeout rate. Takeout rates are viewed as taxes and wherever takeout rates are increased bettors get angry because not as much money goes into the actual betting pool. Therefore, it would be ideal to have a betting network that has one standard takeout rate instead of hundreds of different takeout rates for each track and bet types. Many bet types are taxed differently for each state. For example, in New York, win/place/show betting is taxed 15% and exacta, triacta, and superfecta is taxed at 20%

Summary of betting pools with no consolation. Small betting pools that have consolation rules associated with their state or national parimutuel regulations cannot carry over since there will always be a player that will have a winning ticket by default to the next winning combo or succession of default winning consolation wagers until a winning ticket is eventually claimed. For example, if the winning result is 4,1,2,9 for a superfecta wager and nobody has this combination, the default combination may use the 5^{th} place horse instead of the 4^{th} place horse such as 4,1,2,11 where the race contestant #11 ran in 5^{th} place and now became the 4^{th} horse for a superfecta combo by default. In another default scenario may be when nobody has the 3^{rd} horse in a result such as 4,1,2,9 where nobody had two for third in their superfecta combo. Again, the winning wager combo by default would bump up the 4^{th} to the third spot and 5^{th} horse to complete the superfecta in the 4^{th} position. For example, mentioned earlier 4,1,9,11 would be the winning superfecta combo.

However, in small commingled betting pools or separate betting pools it would be advantageous to have no state regulations in regards to consolations or a state regulation saying that unless the exact numbers of the race result are chosen or picked and entered into the pool, there will be a carry over to the next respective race at that racetrack. This would be very beneficial to a small betting markets that only have a couple hundred bettors on the parimutuel network betting at one moment in time. If there were no carry over and each player wagered an average of $2 per race, and there were 500 people playing each respective race the pool would only amount to roughly $1,000 per race with a consolation ticket most likely winning the wager instead of a ticket that had the 1^{st}, 2^{nd}, 3^{rd}, 4^{th}, horse respectively which is very unlikely in a 12 horse field where the odds are 24024 to 1 (12×11×10×9=24024.

Thereby, it would be advantageous to have betting pools that with no consolation prizes so the prize could carry over until an exact winning ticket with the first 3 race contestants in a trifecta bet type or the exact winning ticket with the first 4 respective horses in a superfecta bet type is achieved. I mention, triactor and superfecta because win, place, show and exacta wagers have on so few possibilities such as win/place/show is 10 to 1 in a 10 horse field and an exacta is 90 to 1 in a 10 horse field (10×9=90). There are hundreds or thousands of people playing in the exacta pool it is most likely to have an exact winning ticket will be achieved because it is not expensive to box or wheel or key an exacta because it is only based on 2 factorial or the first and second position being chosen. It would also be advantageous to have a third party handicapping system interfacing with a race providing system and a quick pick rotator or a handicapping formula built in a race providing system that would only pick horses that were most likely to lose or not run in the top 3 for a triactor or top 4 in a superfecta thereby producing a carry over. The quick pick rotator in this case would start with the combo involving 12 highest longshot, 11 highest longshot, 10 highest longshot for the first quick pick. The second quick pick would be the 11^{th} highest longshot followed by the 12, 10 highest longshot respectively. The third quick pick rotator would be the 10 highest longshot followed by the 12, 11 highest longshot respectively for a triactor quick pick rotator selection.

This procedure by using the most unwanted horses would involve using either a handicapping formula to find the least desirable race contestants or live odds or morning line odds. If there were no more unwanted or undesirable race contestants left to be chosen then handicapping algorithm would start to use moderately desirable horses followed by favoured race contestants until all the different combinations were all taken or accounted for in the bet type pool. By using a statistical systematic approach more carry overs will be achieved, therefore increasing the pool to create a larger prize or “jackpot”. Lotteries today use carry overs in order to create larger prizes and more excitement or lifestyle changing prizes for their players.

### SUMMARY OF BET TYPE SELECTOR

Many players today do not understand bet type terminology or don't know which bet type to use for a specific race. For example, show betting has a better economical payoff in a 12 horse field versus a five horse field because in a 12 horse field nine losing race contestants and the respective money wagered on each of those nine race contestants is given to the bettors which had one of the three winning race contestants. In a five horse field in a show bet type with only five race contestants, there are three winning race contestants and only two losing race contestants with the respective money of the two losing race contestants going to the players that chose one of the three winning race contestants. Therefore, the handicapping formula contained in the race providing system or a handicapping system from an outside data supplier in communication with a race providing system can do financial analysis of each bet type by comparing the cost of the wager versus the payoff of the wager but also in conjunction using the handicapping formula to determine the probability of the race contestant. Therefore, it would be ideal to have a bet type selector that chose bet types based on the number of race contestants associated with that bet type. For example, 20 race contestants for a win bet type may be too many race contestants. In races with 20 horses there are several handicapping angles or many race contestants that have a high probability to win. Also “racing luck” is needed to make sure the horse does not run into a “traffic jam” or are impeded during the races due to so many race contestants running. Therefore, it would be beneficial to place a show wager to compensate for “racing luck” and the very little difference between the ability of the top race contestants. Also, in this example, a show wager is a good economic decision due to the fact that there would be 17 losing contestants contributing their respective money wagered on each of those 17 race contestants going toward the players who had one of the three winning race contestants. Another reason for a bet type selector is when you have coupled betting interests. Coupled betting interests run as a team and have the same number of the saddlecloth such as 1 and 1A or 2 and 2A if there are two coupled betting interests in the race. In races where there are coupled betting interests it would be beneficial to choose place or show bet types if both race contestants in the coupled entry had a high probability of “placing” or “showing” thereby the place pool gets divided by one winning race contestant instead of two winning race contestants which leads to a bigger payoff since the bettors who had the coupled entry receive the whole place pool and the show pool gets divided by two winning race contestants instead of three winning race contestants which leads to a bigger payoff for the players who choose the coupled betting interest entry since both the race contestants showed and the show pool is divided by two winning race contestants instead of 3. Software would therefore be installed that provides a bet type selector that chooses bet types for each race, or a bet type selector that chooses bet types based on the amount of race contestants in the race, or a bet type selector that chooses bet types based on the probability of race contestants associated with that bet type, or a bet type selector that chooses bet types by the amount in the bet type pool, or a bet type selector which chooses bet types according to “takeout” per bet type, or a bet type selector which chooses bet types based on coupled betting interests, or a bet type selector that chooses bet types based on state regulations or parimutuel commingling laws, or a bet type selector that chooses a lowest minimum denomination amount to commingle.

Choosing Bet Type by Pool Size

It would also be ideal to have a bet type selector that chooses bet types based on pool size. For example, if the pool size for a win bet type is 40,000 and a superfecta pool is 250,000, this may be due to the fact that there are no consolation state parimutuel laws or the state parimutuel laws say that consolation prizes are not allowed. Therefore carry overs enable the pool to grow to 250,000. This superfecta pool would be preferred by the player due to the chance of lifestyle changing prize in the bigger pool. Also, it would be advantageous to choose race events with associated bet types that don't have lop-sided or uneven pools based off the morning line whereby the chosen handicapped race contestant is overplayed or over-bet. For example, HDW or a third party handicapping information supplier or a race providing system might suggest that race contestant #3 at the racetrack Tampa Bay Downs in race 2 should have morning line or pre-race odds or odds before the actual live pool is open at 10 to 1 as compared to the live odds 1 to 9 at one second to post. The bet type selector in this case would consider this situation as an unbalanced or lop-sided pool and choose a different bet type for that race other than a win bet type. Therefore, the bet type selector would choose pools that do not have unbalanced pools where the over-bet or over-played horses are the same race contestants as chose by the handicapping software. However, it is satisfactory to choose bet types where the pools are unbalanced as long as the race contestants that are over-bet or over-played causing the pools not to be unbalanced are different race contestants than the race contestants the handicapping software has chosen. It would be ideal to choose bet type pools that have low takeout rates. For example, in New York State win/place/show wagering takeout is 15% versus 28% in Arizona. By choosing a takeout that is lower the players benefit since more dollars go into the actual live pools versus the coffers of government racetrack management or H.B.P.A. associations (horsemen unions). However, racetrack management may not want where low takeout rates are chosen since they make less money and they may want to commingle with jurisdictions that have high takeout rates like Arizona that has 28% takeout on win/place/show wagering. Since the track wanting to commingle into the host tracks pool must adopt the host tracks take out rate. Therefore if a tracks take out rate is 20% by law for their own live racing the track wanting to commingle might find a 28% takeout rate in another jurisdiction enticing. For example, many jurisdictions have different takeout rates for each bet type or groups of bet types. For example, win/place/show takeout is 18% and exacta, triacta and superfecta takeout is 21% in Ontario. The software would therefore be capable of providing a bet type selector that chooses bet type pools that are unbalanced, or a bet type selector that does not choose bet type pools that are unbalanced according to morning line odds, or a bet type selector that chooses bet type pools that are unbalanced whereby the unbalanced or over-played horses are different from the chosen race contestants or race contestant, or a bet type selector that chooses bet type takeout rates of “X” or less, or a bet type selector that chooses bet type takeout rates of “X” or greater, where x is a predetermined numerical value.

While this invention has been described in relation to certain embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the invention is not intended to be limited to the embodiments shown above but rather is to be accorded the widest scope consistent with the principles and novel features disclosed in any fashion herein.

An additional feature that can be present in the practice of this technology could be provided as either a physical button or on-screen user interface icon. The feature would be available where the gaming apparatus is specifically identified as a paramutuel wagering system and is not completely masked in the exclusive appearance of a facade of a slot-type wagering apparatus. The issue to be addressed is the ability to enable a player to leave the gaming apparatus and not leave active money in the system that cannot be traced to the specific player or be credited to the player. An example of this situation would be where there were 200 credits in the machine and the 200 credits were already wagered on the next race in the simulcast. There are four different scenarios that could exist in this situation when a [player wishes to leave the machine. Those four secenarios include a time frame when the race either (1) had not started yet (2) the race was currently being run (3) the race had begun but had not been declared official yet (4) the race had been declared official, but the player had not exercised or played out all his credits yet. If the player elected to touch the Cash Out button for (1) scenario, the wager would be cancelled and the credits would be returned in the form of a cash voucher since at this point in time the wagers are still cancellable. For scenario (2) and (3) the player would receive a combined available credits voucher and active game credit voucher since the ticket or credits could not be cancelled since the race was being run or had been run but not declared official yet. The active game credit voucher would be treated as a wagering ticket and, if there were an account established for the player, any wining would be credited to that account. Otherwise, the voucher could be later validated and paid off at a window or by a wagering terminal programmed to pay out vouchers. For scenario (4) the players would receive a game credits voucher for whatever races or credits or wagers that were not played out via the play button and a cash voucher for whatever previous credits were winning spins or wagers that were forwarded to the win meter. Therefore, whatever amount has been registered on the win meter will always be available to be distributed in the form of a cash voucher when the cash out button is pressed.

Returning to scenarios (2) and (3), where the player has touched the Cash Out button only to receive a $200 game credits voucher, in order to turn the game credits voucher into a cash voucher the player would have to reinsert the 200 game credits voucher into the machine again, once the race or races where the 200 game credits were wagered have been declared official. Then the player could play or spin out (collect by hitting the Cash Out function) the $200 worth of credits in this example. At this point in time any winning wagers or a winning wager would be forwarded to the win meter if played out. Scenarios (1), (2), (3) and (4) can be achieved only if the player inserts cash into the bill acceptor or inserts a winning ticket or a game credits voucher or a cash voucher or an account wagering card with credits loaded on the account card or otherwise has an active account accessed through the wagering system as a first step operation. In other words, some form of a monetary instrument or electronic account recognition needs to be inserted into the machine or available through the machine before scenarios (1), (2), (3), (4) can be achieved. These pari-mutuel race contestant wagering machines, upon receiving credits or money via the monetary instruments just mentioned, may immediately enter all the credits or money into a live sporting event betting pool such as a live horse racing event. Once a monetary instrument has been inserted into the machine. it will or may immediately enter “X” dollars into a live bet type pool and the only way a player can cancel a wager of “X” credits is to hit the Cash Out button before the wager has entered a live bet type pool. If the wager has entered a live bet type pool, the wager of “X” dollars is not cancellable and the player will receive a game credits voucher instead of a cash voucher for the “X” dollar wager and a cash voucher for any balance that was not wagered.

In pari-mutuel race contestant wagering today, there are certain minimum wager amounts or specific wager amounts for certain bet types or individual wagers. For example, most racing jurisdictions only allow $2 minimum wager for win/place/show wagers and $1 minimum for exotic wagers such as exactor, trifecta, triactor, supertrifecta, perfectas, etc. Therefore, to commingle betting pools between two racing jurisdictions, the host betting rules must be adopted in order to combine or commingle out of state wagers with in state host state wagers. Therefore, since each state or government may have different minimum dollar amount requirements, this has an effect on each bet type. For example, for a WPS (win/place/show) machine the minimum in one racing jurisdiction may be $3 or $6 in another racing jurisdiction ($1 win, $1 place, $1 show=$3 if the minimum is $1 and $2 win, $2 place, $2 show=$6 if the minimum wager amount is $2). Therefore, if one were to have a win/place/show machine or otherwise known as $2 or $1 “across the board” machine, the buttons or icons would have to be on the CRT or LCD touchscreen, since a physical hard button with a sticker saying $1 could not change to $2 unless done on screen. This would necessitate a graphics change. The minimum commingling amounts for each bet type and for each state per bet type can be very confusing.

Therefore, it would be an improvement to have a bet minimum and bet maximum physical hard buttons for a pari-mutuel race contestant terminal whereby the buttons could be taken off screen to create more real estate on the screen for race contestant icons and race track names etc. It would be advantageous to have a standardized button panel or keyboard for every possible bet type machine since every bet type machine would have a bet minimum button and a bet maximum button. For example, a superfecta machine may have a $1 to $24 wager amount range whereby $1 bet minimum is a key 1^{st}, key 2^{nd}, key 3^{rd}, key 4^{th} (or a $1 “straight” superfecta) and the $24 bet maximum is wheel 1, wheel 2, wheel 3, wheel 4 (or a 4 race contestant box). A win/place/show machine (or an “across the board” machine) may have a $6, $12, $18 buttons (since win/place/show must have a minimum of $6 or bet in increments of $6 in most states). This produces a clearly identified machine format where $6 is the minimum bet and $18 is the maximum wager. A bet minimum and bet maximum processor would analyze each live racetrack event bet type pool in the simulcast network to determine the bet minimum wager amount and the bet maximum wager amount for each respective terminal in the network.

The minimum bet button or icon can also be activated by a quick pick feature or play or enter feature if the player did not previously choose a wager amount.

Another standardized keyboard or panel button would be a Bet All credits function since every bet type machine or multiple bet type machine could use this wagering function or feature. This feature could either be a physical button or an on screen icon. When the “Bet All” credits button or icon is touched, it will give the player a wager or multiple wagers by consolidating all previous result wager into one resulting wager whereby all credits inserted whether cash, cash voucher or on account credits would be used up in one consolidated wager. When the player presses the play and the Bet All credits function, the player watches a spin whereby, if the consolidated wager contains no winning wagers, the player will receive losing icons on a payline. However, if one or more of the wagers was a winner or the Bet All credits wager contained multiple winning result wagers, winning icons would appear on the payline that matched the appropriate payout, or provided incremental payouts that would prove whatever dollar amounts or paylines that awarded amounts closest to the actual winning wager on the corresponding paytable.

The Bet All credits processor would find a payout or series of payouts (preferably a minimum series of payouts, such as 2 payouts, or three or fewer payouts) with corresponding icons of a future race or past race payoff and match these icons and paytable payouts to the total winning amount that the consolidated result wagers paid. An example of the Bet All credits function is equivalent to the four scenarios previously described where the player had 200 credits in the credit meter whereby the 200 credits were immediately wagered on the next race in the simulcast whereby (1) the race event had not yet started and there were “X” minutes to post when the player touched the Bet All credits button. (2) The race is currently being run when the player touched the Bet All credits button (3) The race had been run but not declared official when the player touched the Bet All credits button at that moment in time. (4) The race had been declared official but the player did not play out his remaining credits when pressing the Bet All credits. For scenario (1) when using “Bet All Credits” button, all the wagers would be cancelled since the race had not “gone” off yet or had not started yet and the player would receive a spin whereby the winning icons on the payline would match a paytable range of the future odds display on the paytable. For scenario (2) and (3) the wagers that the race contestant selector, race event selector, wager amount selector orchestrated could not be refunded since the live bet type pools that these wagers used and entered would be closed. Therefore, if the Bet All credits button was touched at this point in time, the player would receive a game credits voucher that could be “played out” in the future when respective races or race had been declared official. An example of a 200 credits consolidated wager in one embodiment would be $20 to show, $20 to place, $40 to win, a superfecta box of $24 and a $38 exactor box (2×38=$76) whereby the wager totalled $200 ($20+$20+$40+$24+$76).

For example, consider if only two of the five bet types were actual winning wagers whereby the $20 win wager paid $40 and the $20 show bet paid $30 and the superfecta box, exactor box and place wagers were losers or unsuccessful. Therefore, $70 ($40 win winning wager+$30 show winning wager=$70) would be forwarded or credited to the win meter or immediately or incrementally paid out in a virtual slot facade. This $70 consolidated winning wager example could be used for scenario (4) whereby the player would receive icons or a series of icons whose payout would ultimately provide a total that matched a $70 payoff on the corresponding paytable or the player would receive icons that matched a paytable range such as $40 to $100 on the respective payline and the win meter would be credited $70. For scenarios (2) and (3) since the race has not been run or either been declared official a $200 game credits voucher would be received whereby the winning wagers would total $70 and $70 would be added or forwarded or credited to the win meter when the $200 game credits would be inserted in the voucher reader only to increase the win meter $70 when the race is deemed official. A Bet All credits feature is an ideal function to unload all the players credit and end a player's session. It is an ideal function for a player with time constraints or a player who wants to unload or play with large amounts, rather than making various wagers in order to “use up” all his credits which could be time consuming via $1 to $20 buttons if the player had $500 credits in one example on his credit meter.

A pari-mutuel race contestant terminal provides a Bet All credits function whereby all result wagers are consolidated into one wager result. This wager result is preferably based on the results of multiple wagers automatically placed by the machine with different bet types and/or different contestants wagered on in the same or different races and the same or different get types (e.g., more than one win contestant, more than one place contestant, etc.)

A Bet All credits icon that matches winning spins to a corresponding paytable for a racetrack event or provides a series of spins that pays out the race win in incremental amounts or pays a portion of the win in spins and indicates a “bonus” payout to the credit meter to balance the win amount due to the player where the race payout is not an amount that is easily distributable to the player, such as a $17.30 win on a $1 minimum wager machine. It is also possible to provide a result to a Bet All credits winning spin that uses the closest dollar amount payline on a paytable for a winning spin.

It is an inventive aspect of this technology to provide a Bet All credits icon or button that enables a player to Bet All his credits in a live bet type pool

It is an inventive aspect of this technology to provide a Bet All credits icon that totals a winning wager or multiple winning wagers into a consolidated winning wager amount and tries to match or approximately match a respective payoff on a respective paytable by issuing the same icons that are associated with that respective payoff. It is an inventive aspect of this technology to provide a Bet All credits button that cancels whatever wagers that have previously entered into a live bet type pool whereby the respective pool is not closed yet. It is an inventive aspect of this technology to provide a Bet All credits button or icon that issues a game voucher for wagers that are not yet declared official yet. It is an inventive aspect of this technology to provide a Bet All credits button or icon that can be consolidated into a winning wager amount or multiple winning wagers and the system will then forward the total winning wager amount to a win meter or credit meter.

It is an inventive aspect of this technology to provide a machine with a cash out button for a pari-mutuel race contestant terminal, the terminal then being capable of issuing both game credits vouchers and cash vouchers. It is an inventive aspect of this technology to provide a pari-mutuel race contestant terminal that issues a game credits voucher for race events that have not been played out but have been entered into a live betting pool, such as a pari-mutuel race contestant game voucher that contains a predetermined wager and can be used in the future. The pari-mutuel race contestant terminal may issue game vouchers that are playable at some point in time in the future, but not at the specific time when the game credits voucher is being printed or before the voucher has been printed but has been ordered from the terminal. It is an inventive aspect of this technology to provide a game voucher that can not be used until the respective race related to the content of the game voucher was used or placed is official. It is an inventive aspect of this technology to provide a cash out button or icon that cashes out a win meter on a pari-mutuel race contestant terminal.

The system may also provide a cash out button or cash out icon that cashes out a credits meter. In this manner, the credits shown are only wagers that are bets that have been placed on a live race event. As noted with the four scenarios described above, the method of payout, whether by cash voucher or credit voucher, or race credit voucher will depend upon the stage of the race at the time that the cash out function is initiated.

The system may also provide a pari-mutuel race contestant terminal that stores wagers that have not been played out on a payline that coincides with a paytable and are waiting to be played out. The terminal system may also provide a game credits voucher that contains a result of a past live racing pari-mutuel race event and can be reused by entering into a voucher reader. The pari-mutuel race contestant terminal may transfer winning credits or wagers to a win meter from a credit meter, for example, after race results have become final. The pari-mutuel race contestant terminal may be able to cancel wagers and cash out a win meter at the same time via pressing a Cash Out button. The pari-mutuel race contestant terminal can add credits from a win meter to credits or wagers that have been cancelled and issue a cash voucher, totaling the two amounts together on one cash voucher. The cash out button or icon can cancel wagers. There may also be present a call attendant button or icon on a pari-mutuel race contestant terminal that can talk to a central server whereby wagering tellers and wagering are notified via the central server. The call attendant button or icon can light up when winning tickets that have odds of “X” amounts or greater are inserted into the voucher reader of a pari-mutuel race contestant terminal, or the call attendant button lights up when winning wagers that have “X” odds are entered via a player card reader whereby the player card entered contains a winning wager of “X” odds or greater.

The system, as described herein, may also preferably provide a quick pick function that chooses the minimum bet state commingling amount on a per bet type basis and enters the respective amount in a live bet type pool. The system may also provide a play or enter button that enters the minimum state commingling amount per bet type in a live bet type pool if no amount is previously chosen by a player. For example, if a wager of $0.25 is made and the state wager minimum for that wager is $1.00, then the wager will be commingled with other wagers to total the required minimum. The pari-mutuel race contestant terminal may provide a bet minimum/bet maximum processor, and a standardized pari-mutuel race contestant keyboard or button panel containing bet type functions bet minimum, bet maximum, play, call attendant, and cash out may be constructed to provide a standard that is familiar to the consumer. The system may also provide a bet minimum/bet maximum processor that determines the minimum commingling amount for each live race contestant bet type pool and/or that decides the maximum amount that can be wagered in each live race contestant bet type pool.

In gaming today, where stand alone or banked machines are used as slot machines, bingo machines, video poker machines, pari-mutuel race contestant machines etc., there are so many different graphical icons due to bonusing, theming and many new functional features such as a payline meter, symbol selections by players, and the like. Therefore, a lot of on-screen graphics are required to implement theming, bonusing and new functional features which can clutter, in one embodiment, a 19 inch CPT touchscreen screen. In regards to a pari-mutuel race contestant terminal, there are many functional icons in order to process a wager such as race numbers, track codes (PHA, FG, TDN., etc.) denomination amounts, bet type icons, bet types within a bet type icons (key, with wheel etc.). Since there are so many functional icons that are required in pari-mutuel wagering to enable all levels of players to use the machines to their satisfaction, race contestant terminals, such as the Autotote device have to have pages of bet types features whereby the user can scroll through pages. This is very time consuming and can quickly frustrate the novice or even intermediate skill player. However, having pages of functional wagering option icons is done because the icons can be bigger than if everything was only on a single page, where the graphic icons would be smaller. For example, with larger icons on a 19 inch CRT the track codes can be spelled out instead of abbreviated, or there can be more denomination amounts such as $1 to $1,000 whereby for every increment of $5, a wagering dollar amount icon could appear to have a larger range of monetary amounts if there were a page dedicated only for wagering amounts. However, if a pari-mutuel race contestant terminal has too many icons on screen, the user interface may seem cluttered or confusing to the player. Also, scrolling through various pages of optional wagering functional features (Ex, Tri, $250, $2, key, wheel, with, all, FG, PHA, etc.) can make the user interface very awkward, as with a phone directory, and very time consuming in an environment where there may be lineups of impatient players who all want to bet when there is only one minute to post. Using Amtote as a comparative example, rather than using larger bet type function icons and multiple pages, one can use smaller bet type function icons whereby everything is on the front page or home page such as Amtote's pari-mutuel race contestant wagering terminal user interface. However, the single one and only page may seem confusing or cluttered with numerous bet type icons and fewer bet type options. This lesser amount of options will be given due to lack of “real estate” on the 19 inch touchscreen. For example, there may be room for only “X” track codes and “Y” wagering amounts etc.

Therefore, it would be desirable to have a standard keyboard for pari-mutuel race contestant wagering to reduce the amount of information or control on screen icons. Also, many players prefer physical buttons than screen buttons because a physical button that is spring loaded is softer on the fingertips. This may be because of the give provided by the spring as compared to jamming fingertips against hard glass, especially for women who have nails. If a pari-mutuel race contestant network were to expand to 500 racetracks a day translating into 4,000 races per day, a player's fingers would be bruised or calloused in little time with repeated wagers. This is why slot machines use spring loaded buttons when numerous repetition is required such as hitting a play button 1,000 times.

Also, many players are computer illiterate or are phobic when it comes to interacting with a CRT or computer touchscreen. However, physical buttons have been around longer than graphical user interface icons especially on a standard three wheel stepper slot machine which are ingrained into gaming society today, thereby providing less intimidation and a lower learning curve for the player. Currently, there are no pari-mutuel race contestant terminals using a standardized physical keyboard or let alone any single physical bet function button, everything is done on screen. Therefore, it would be ideal to have a standardized pari-mutuel race contestant terminal keyboard whereby bet type functions that are standard for every machine and bet type. This also would be ideal for manufacturing of terminals since a different keyboard would not be required for each machine or bet type. For example, a Superfecta machine would have different wagering amounts and bet type terminology than a win machine. For example, most states or racing jurisdictions have a minimum commingling amount of $2 for win bet type wagering. In other words, a player cannot enter a win bet type pool with $1 in most jurisdictions but in all racing jurisdictions a player can enter a $1 Superfecta amount. Therefore, all the Superfecta machines would have a $1 button or on screen user interface $2 icon and all the win machines would have a $2 button or on screen user interface $2 amount icon. There are numerous examples where the wagering amounts and buttons or icons differentiate between the different type of bets on a state-by-state basis. However, with each bet type or bet type machine there is always a minimum or a maximum wagering amount. For example, on a win machine the minimum amount may be $2 due to wagering commingling minimums and a maximum of $1,000 which could be in one embodiment the highest amount one could wager for an individual wager. In conclusion, every bet type or every bet type machine has a minimum amount and a maximum amount, therefore, every pari-mutuel race contestant bet type machine could have a physical button for a minimum credit or amount and a maximum credit or amount.

It is therefore an aspect of the invention to provide a keyboard or panel associated with a terminal wagering system having specific button controls to enable placement of a minimum wagering amount. This preferably done with a physical button on a pari-mutuel race contestant keyboard. It is preferred to have a minimum wagering amount icon or button that interacts with every bet type. There may also be a maximum wagering amount physical button on the pari-mutuel race contestant keyboard. The maximum wagering amount icon or button may interact with every bet type.

Other buttons or features that could be standardized on a pari-mutuel race contestant keyboard include a call attendant or help button. A call attendant or help button when pressed would make a noise and a light would flash and in one embodiment a “candle” would light up on top of the machine. Any pari-mutuel race contestant tickets that require filing for tax reasons would also light up the call attendant button and a candle or light. An example of a winning pari-mutuel race contestant ticket that would require an income tax return to be filled out for the I.R.S. in the U.S. would be any ticket that had odds of 300 to 1. In this situation, the pari-mutuel race contestant terminal would not issue a cash vendor upon inserting a winning pari-mutuel race contestant ticket, and in turn would light up or sound off that a jackpot has been won. In this situation the call attendant button would notify a teller or clerk via a central server that a jackpot has been won. If the player had any problems whatsoever in using the pari-mutuel race contestant terminal or website, he or she could use the call attendant button and a customer service rep, teller or clerk could physical attend the machine or call or e-mail a player playing on the internet.

The invention would also optionally include a pari-mutuel race contestant terminal that can be reactivated from a central control station when deactivated by winning wagers of “X” amount or greater. The system may also provide a minimum wagering amount icon or button that adheres to every minimum state bet type and enables commingling of amounts to enable placement of required minimum wagers.

The pari-mutuel race contestant terminal may be programmed so that it shuts down when a winning wager of “X” amount is inserted or achieved.

The pari-mutuel race contestant terminal that should be capable of being reactivated manually or automatically by software once a respective jackpot response has been adhered to. For example, if a winning wager that requires an I.R.S. filing for tax purposes is achieved or a jackpot of at least “X” amount is achieved thereby making the pari-mutuel race contestant terminal inactive, it can be reset on location or from a central control centre once the winning wager or jackpot response has been adhered to.

1. A wagering account set-up facility to register with and/or communicate with a wagering account holder, the facility comprising:
a display that identifies capability to accept one or more information requests to establish a wagering account;
a reader to read a wagering account application;
a user interface to capture a an identification source of a holder of the wagering account and to capture input from the user in response to the one or more information requests on the display; and
a processor to process a) the wagering account holder's identification source, b) the input, c) where an application has been submitted to the reader, information from the wagering account form, and d) set-up the wagering account.

2. The wagering account set-up facility of claim 1, wherein the facility is a kiosk further comprising a wagering card dispenser to issue a wagering card on the set-up wagering account.

3. The wagering account set-up facility of claim 1, further comprising a card reader to read a card that enables at least one interaction selected from the group consisting of identifying a wagering account holder; and read a card that can deposit value into the wagering account.

4. The wagering account set-up facility of claim 1, further comprising a connection to a credit database to validate set-up of the wagering account.

5. The wagering account set-up facility of claim 1, wherein the processor instructs a wagering account set-up confirmation to be sent to the wagering account holder.

6. A wagering terminal in communication with a race providing system that facilitates wagering on race events and provides information regarding the race events, the terminal comprising:
a display to present information regarding selected race events;
a user interface enabling a user to place a wager on an elected race event of automatically processor-selected race events displayed or on a single automatically processor-selected race event;
a card reader to receive a card having information pertaining to a user account and to enable identification of available wager amounts for wagers on the elected race event;
at least one currency receiver or credit receiver to receive currency or credit, respectively,
wherein currency or credit provided to the currency receiver or credit receiver may be deposited to the user account.

7. The wagering terminal of claim 6, comprising a currency dispensing device to dispense currency and wherein currency dispensed is withdrawn from the user account.

8. The wagering terminal of claim 6, further comprising digital communication access to a race event selector to select race events, wherein the selected race events are next race events for wagering.

9. A wagering terminal in communication with a race providing system that facilitates wagering on race events and provides information regarding the race events, comprising:
a race event selector to select next race events for wagering, the race event selector using an algorithm to select next race events by analyzing one or more factors selected from the group consisting of estimated start of race event; estimated duration of race event; nature of the race event; actual start of the race event as affected by delays, and playability;
a display to display information regarding the selected race events;
a user interface by which a user may place a wager on an elected race event of the selected race events displayed or a single race event selected; and
a wagering value selector to select a wager amount for the wager on the elected race event.

10. The wagering terminal of claim 9, wherein at least two of the factors are weighted and can be adjusted automatically to configure selection of the next race event.

11. The wagering terminal of claim 9 wherein the wagering value selector enables either player selection of wagering amounts or automatic selection of wager amounts.

12. A wagering terminal in communication with a race providing system that facilitates wagering on race events and provides information regarding the race events, comprising:
a display to present information regarding selected race events, the information including race contestant wagering information displayed according to a profile of a user of the wagering terminal;
a user interface enabling placement of a wager on an elected race event of the selected race events displayed or a single race event selected; and
a wagering value selector to provide a wager amount for the wager on the elected race event.

13. The wagering terminal of claim 12, wherein the profile is a risk/reward profile and there is a manual control on the wagering terminal through which a user may select a profile.

14. The wagering terminal of claim 12, wherein the race contestant wagering information is generated from matching handicapping data showing estimated probability of race contestants finishing in specific positions against current odds to find wagering opportunities according to at least one algorithm using the handicapping data and the current odds.

15. The wagering terminal of claim 12, wherein the user interface displays icons corresponding to race contestants in a race event and a color or other indicator of the icons represents the race contestant wagering information.

16. The wagering terminal of claim 12, wherein the race contestant wagering information comprises at least one of a specific wager, a race contestant selection and a wager amount in accordance with the user profile.

17. A wagering terminal in communication with one or more race providing systems that facilitates wagering on race events and provides information regarding the race events, the wagering terminal comprising:
a display to present information regarding selected race events;
a user interface to place a wager on an elected race event of the selected race events displayed;
a wagering value identifier to provide a wager amount for the wager on the elected race event; and
a portable module providing a library of at least two protocols for accessing different API's for different tote-providers to support interoperability of the wagering terminal with more than one race providing systems.

18. The wagering terminal of claim 17, wherein the module defines an application programming interface for the wagering facilitated by the wagering terminal and an application programming interface for networking services of the race providing systems.

19. The wagering terminal of claim 17, wherein the portable module is adapted to accept one or more plug-in modules, each defining the interoperability to a specific race providing system.

20. A wagering terminal in communication with a race providing system that a) facilitates wagering on race events and b) provides information regarding the race events, comprising:
a display to present information regarding selected race events;
a processor in communication with the wagering terminal;
a user interface to place a wager on an elected race event of the selected race events displayed; and
a wagering value mechanism to provide a wager amount for the wager on the elected race event,
wherein software executed by the processor requires a user identifier to be provided in association with the wager to limit access to wagering or credit accounts so as to protect the identity of a user that made the wager when winning wagers are disclosed.

21. The wagering terminal of claim 20, wherein, if the wager was a winning wager, a results board displays the user identifier associated with the wager.

22. The wagering terminal of claim 21, wherein, if the wager was a winning wager, a results board displays a winning amount associated with the wager.

23. The wagering terminal of claim 20, wherein, if the wager was a winning wager, an audio signal is activated at the end of a selected race event when a winning wagers has been played on the wagering terminal and an amount of money has been won on the wagering terminal.

24. A user interface for a wagering terminal, comprising:
a spinning reel animation;
selection system for selecting at least one race location and at least one contestant in a race event;
communicative connection to a race information provider that carries information of the at least one race contestant selected to the race information provider to enter a wager on the at least one selected contestant on a wager in the race event;
and
when the spinning reel animation is completed, a screen presenting identification of the at least one race contestant in the race event selected for a wager.

25. The user interface of claim 24, wherein the one or more race contestants comprise one or more quick pick race contestants automatically selected on at least the basis of handicapping data.

26. The user interface of claim 24, wherein the one or more race contestants comprise one or more quick pick race contestants in which quick pick selection is based on handicap data and odds data.

27. A wagering terminal in communication with a race providing system that facilitates wagering on race events and provides information regarding the race events, comprising:
a display to display information regarding selected race events;
a user interface to place a wager on an elected race event of the selected race events displayed;
a wagering value mechanism to indicate a wager amount for the wager on the elected race event; and
a wagering processor to automatically provide one or more bonus picks in association with the wager.

28. The wagering terminal of claim 27 wherein the wagering processor provides bonus picks when a wager results in a predetermined event.

29. The wagering terminal of claim 28 wherein the predetermined event comprises a payout equal to or in excess of a predetermined amount.

30. The wagering terminal of claim 27, wherein the bonus pick is an automatic selection of a race contestant from remaining race contestants in a race event not included in the wager or other bonus picks.

31. The wagering terminal of claim 30, wherein the selection of the race contestant for the bonus pick is random.

32. The wagering terminal of claim 27, wherein a pool out of which the bonus prize(s) for a winning bonus pick(s) is paid out is funded by one or more of a set-aside of a percentage of wagering handle; an additional contribution by one or more race event tracks and a wager surcharge.

33. The wagering terminal of claim 29, wherein the pool is underwritten by an insurance policy to ensure that a bonus prize can be paid.

34. The wagering terminal of claim 29, wherein a payout of a bonus prize for a winning bonus pick is determined by one or more of a size of the entire bonus pool;
straight odds of winning the bonus pick; an effective payout or odds of winning the wager; an actuarial determination of the bonus prize; and a parimutuel determination with a jackpot and reserve similar to a lottery system.

35. The wagering terminal of claim 34, wherein a separate ticket is issued from a ticket for the wager, the separate ticket incorporating details of the wager and providing the one or more bonus picks.

36. The wagering terminal of claim 35, wherein the separate ticket is provided with a bar code to track and facilitate payout of a bonus prize for a winning bonus pick.

37. The wagering terminal of claim 34, wherein the one or more bonus picks are provided on a same ticket of the wager in association with which the one or more bonus picks are provided.

38. The wagering terminal of claim 34, wherein a time for display of the audio or video of a next race event is determined by estimating a run time of the next race event and adding extra time for delayed starts and slow race events.

39. A method of placing a wager on a race event comprising a player accessing a wagering system, the player authorizing a wager to be placed, the wagering system automatically selecting at least one race location and race event upon which a wager may be placed, and a wager on the automatically selected race location and race event being placed through the wagering system.

40. The method of claim 39 wherein the wagering system automatically selects a wagering format on the selected race location and race event.

41. The method of claim 39 wherein the player selects a wagering format on the wagering system.

42. The method of claims 40 or 41 wherein the wagering systems selects a race contestant for a wager based at least in part upon handicapping principles.

43. The method claim of claim 42 wherein the handicapping principles include at least two factors selected from the group consisting of handicapping parameters and/or tote odds or wager odds.

44. The method of claim 39 wherein the race location and race location as automatically selected by the wagering system by considering sufficiency of time until running of the race event enabling at least a minimum amount of time within which a wager can be placed.

45. The method of claim 39 wherein the race location and race location as automatically selected by the wagering system by considering sufficiency of a range of time until running of the race event enabling at least a minimum amount of time within which a wager can be placed.

46. The method of claim 39 wherein the race location and race location as automatically selected by the wagering system by considering sufficiency of a range of time until running of the race event enabling at least a minimum amount of time within which a wager can be placed and a maximum amount of time so that wagering rates can be maintained at a frequency level.

47. The method of claim 39 wherein a user accesses the wagering system through a user betting interface.

48. The method of claim 39 wherein information concerning race track codes of selected race locations are displayed to a user.

49. The method of claim 47 wherein information concerning race track codes of selected race locations are displayed to a user.

50. The method of claim 39 wherein a user inputs partial selection information on a wager and the wagering system completes the selection information to place a wager.

51. The method of claims 39, 40, 44, 45, 46, 47, 48, 49 or 50 wherein a wager is placed through the wagering system into a parimutuel pool at the race location.

52. The method of claim 43 wherein a wager is placed through the wagering system into a parimutuel pool at the race location.

53. The method of claim 48 wherein race and track codes are combined with a race event selector and are displayed to the user.

54. The method of claim 39 wherein when an award occurs that exceeds a predetermined amount or exceeds a predetermined odds, a first bonus wager on a race event is awarded to the player, the bonus wager being automatically selected by the wagering system.

55. The method of claim 39 wherein if the player wins the first bonus wager, a second bonus wager is automatically selected by the wagering system for the player.

56. The method of claim 55 wherein if the player wins the second bonus wager a third bonus wager is automatically selected by the wagering system for the player.

57. The method of claim 55 wherein if a predetermined number of consecutive bonus wagers are won by the player, a jackpot is awarded to the player.

58. The wagering terminal of claim 9 having communication with a wager amount/bet type selector that calculates the wager amount for a particular bet type and displays the amount calculated and bet type on a user icon or button on the user interface.

59. The wagering terminal of claim 9 wherein a user interface icon or button enables selection pf a combination wager amount/bet type within a bet type selector that chooses bet type and race contestants.

60. The wagering terminal of claim 9 wherein a quick pick rotator function is in the wagering system that rotates race contestants on the basis of placing a same dollar amount on each respective race contestant.

61. The wagering terminal of claim 9 wherein a quick pick rotator function is in the wagering system that tries to even out amounts of wagering dollars wagered on each race contestant.

62. The wagering terminal of claim 9 wherein a quick pick rotator function is in the wagering system that is programmed to choose at least some less desirable race contestants which have high odds or low speed ratings.

63. The wagering terminal of claim 9 wherein a quick pick rotator function is in the wagering system that operates in a separate betting pool from the race location pool.

64. The wagering terminal of claim 9 wherein a quick pick rotator function is in the wagering system that operates in a separate betting pool that does not commingle with any third parties or commingle with any outside race providing system and operates in conjunction with the quick pick rotator.

65. A private parimutuel betting pool network that has a separate pool for each racetrack, race and bet type.

66. The paramutuel betting pool network of claim 65 that has a program to effect a quick pick rotator that attempts to have approximately equal amounts of money wagered on each race contestant.

67. The private parimutuel separate pool betting network of claim 65 that has only one minimum wagering amount.

68. The private parimutuel separate pool betting network of claim 65 that has only one standard takeout rate for each bet type.

69. The private parimutuel separate pool betting network of claim 65 that has only one simulcast menu of specific racetrack events.
